(19) United States
(12) Patent Application Publication
(10) Pub. No.: US 2014/0064053 A1
(43) Pub. Date: Mar. 6, 2014

(54) NON-RESONANT TWO-PHOTON ABSORPTION MATERIAL, NON-RESONANT TWO-PHOTON ABSORPTION RECORDING MATERIAL, RECORDING MEDIUM, RECORDING/REPRODUCING METHOD AND NON-RESONANT TWO-PHOTON ABSORPTION COMPOUND

(71) Applicant: FUJIFILM Corporation, Tokyo (JP)

(72) Inventors: Hiroaki TSUYAMA, Ashigarakami-gun (JP); Masaharu AKIBA, Ashigarakami-gun (JP); Hidehiro MOCHIZUKI, Ashigarakami-gun (JP); Toshio SASAKI, Ashigarakami-gun (JP); Tatsuo MIKAMI, Ashigarakami-gun (JP)

(73) Assignee: FUJIFILM Corporation, Tokyo (JP)

(21) Appl. No.: 14/076,635

(22) Filed: Nov. 11, 2013

Related U.S. Application Data
(63) Continuation of application No. PCT/JP2012/062111, filed on May 11, 2012.

(30) Foreign Application Priority Data
May 13, 2011 (JP) 2011-108697
Jul. 13, 2011 (JP) 2011-154898
May 10, 2012 (JP) 2012-108950

(51) Int. Cl. G11B 7/244

(52) U.S. Cl. CPC G11B 7/244
USPC 369/100; 428/64.4; 428/34.1; 568/306; 568/333

(57) ABSTRACT

A two-photon absorption material that can, thanks to a compound of, for example, the following formula (6), perform non-resonant two-photon absorption by light in the region shorter than 700 nm with high sensitivity and has sufficient recording/reproduction properties, a two-photon absorption recording material, a recording medium and a two-photon absorption compound usable therein are provided.

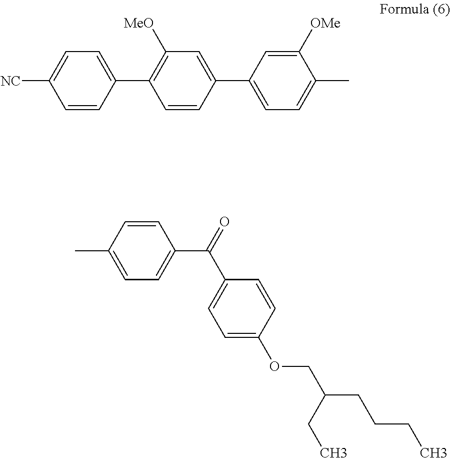

### CROSS REFERENCE TO RELATED APPLICATION

This is a continuation of International Application No. PCT/JP2012/062111 filed on May 11, 2012, and claims priority from Japanese Patent Application No. 2011-108697, filed on May 13, 2011, and Japanese Patent Application No. 2011-154898, filed on Jul. 13, 2011, and Japanese Patent Application No. 2012-108950, filed on May 10, 2012, the entire disclosures of which are incorporated therein by reference.

### TECHNICAL FIELD

The present invention relates to a non-resonant two-photon absorption material, a non-resonant two-photon absorption recording material, a recording medium, a recording/reproducing method, and a non-resonant two-photon absorption compound. More specifically, the present invention provides a material and a two-photon absorption compound, ensuring that recording pits can be three-dimensionally recorded in the inside of a recording medium by using non-resonant two-photon absorption and the recording pits recorded can be read out, and enabling non-resonant two-photon absorption recording using recording light in the wavelength region shorter than 700 nm, and a non-resonant two-photon absorption material using a two-photon absorption compound with high solubility and thereby exhibiting high sensitivity.

### BACKGROUND ART

In general, the non-linear optical effect indicates a non-linear optical response proportional to the square, cube or higher power of a photoelectric field applied. Known examples of the second-order non-linear optical effect proportional to the square of a photoelectric field applied include second harmonic generation (SHG), optical rectification, photorefractive effect, Pockels effect, parametric amplification, parametric oscillation, light sum frequency mixing, and light difference frequency mixing. Also, examples of the third-order non-linear optical effect proportional to the cube of photoelectric filed applied include third harmonic generation (THG), optical Kerr effect, self-induced refractive index change, and two-photon absorption.

As for the non-linear optical material exhibiting these non-linear optical effects, a large number of inorganic materials have been heretofore found. However, an inorganic material can be very hardly used in practice because a so-called molecular design so as to optimize the desired non-linear optical characteristics or various properties necessary for the production of a device is difficult. On the other hand, an organic compound can realize not only optimization of the desired non-linear optical characteristics by the molecular design but also control of other various properties and therefore, the probability of its practical use is high. Thus, an organic compound is attracting attention as a promising non-linear optical material.

In recent years, among non-linear optical characteristics of the organic compound, third-order non-linear optical effects, particularly, non-resonant two-photon absorption, are being taken notice of. The two-photon absorption is a phenomenon of a compound being excited by simultaneously absorbing two photons. In the case where the two-photon absorption occurs in the energy region having no (linear) absorption band of the compound, this is called non-resonant two-photon absorption. In the following, even when not particularly specified, “two-photon absorption” indicates “non-resonant two-photon absorption”. Also, “simultaneous two-photon absorption” is sometimes simply referred to as “two-photon absorption” by omitting “simultaneous”.

Meanwhile, the non-resonant two-photon absorption efficiency is proportional to the square of a photoelectric field applied (quadratic dependency of two-photon absorption). Therefore, when a two-dimensional plane is irradiated with a laser, two-photon absorption takes place only in the position having a high electric field strength in the central part of the laser spot, and absolutely no two-photon absorption occurs in the portion having a weak electric field strength in the periphery. On the other hand, in a three-dimensional space, two-photon absorption occurs only in the region having a large electric field strength at the focus where the laser rays are converged through a lens, and two-photon absorption does not take place at all in the off-focus region because the electric field strength is weak. Compared with linear absorption where excitation occurs in all positions proportionally to the strength of a photoelectric field applied, in the non-resonant two-photon absorption, excitation occurs only at one point inside the space because of the quadratic dependency and therefore, the spatial resolution is remarkably enhanced.

Usually, in the case of inducing non-resonant two-photon absorption, a short pulsed laser in the near infrared region having a wavelength longer than the wavelength region where the (linear) absorption band of a compound is present, and having no absorption is used in many cases. Thanks to use of near infrared light in a so-called transparent region, the excitation light can reach the inside of a sample without being absorbed or scattered and one point inside the sample can be excited with very high spatial resolution because of the quadratic dependency of non-resonant two-photon absorption.

The present applicant have filed various patent applications relating to a two-photon sensitization-type three-dimensional recording material using a compound capable of inducing non-resonant two-photon absorption. This recording material is a recording material containing at least (1) a two-photon absorption compound (two-photon sensitizer) and (2) a refractive index-modulating material or a fluorescence intensity-modulating material, where (1) efficiently undergoes two-photon absorption and the obtained energy is transferred to (2) by photoexcited electron transfer or energy transfer to change the refractive index or fluorescence intensity of (2), thereby performing the recording. Thanks to use of non-resonant two-photon absorption but not one-photon absorption employed in the process of light absorption of normal optical recording, a recording pit with three-dimensional spatial resolution can be written at an arbitrary position inside of a recording material.

For example, Patent Document 1 discloses a technique using, as (2) a refractive index- or fluorescence intensity-modulating material, a material capable of modulating the refractive index by the color formation of a dye, or a material capable of modulating the fluorescence from non-fluorescence to fluorescence or from fluorescence to non-fluorescence (a material capable of modulating a refractive index or fluorescence by the color formation of a dye or a fluorescent dye). Also, Patent Document 2 discloses a technique using, as (2) a refractive index- or fluorescence intensity-modulating material, a material capable of forming a seed (latent image speck) through very slight color formation of a dye or change of fluorescence and then performing recording and amplification under light irradiation or heating (a refractive index/fluorescence modulation and latent image amplification system; a material that forms a latent image capable of performing refractive index/fluorescence modulation by color formation of a dye). In addition, for example, Patent Document 3 discloses a technique using, as (2) a refractive index-modulating material, a material capable of forming a macromolecular polymer by polymerization and thereby modulating the refractive index (a material that performs refractive index modulation by polymerization). Furthermore, Patent Document 4 discloses a technique using, as a refractive index-modulating material, a material capable of forming a very fine polymerized latent image speck and then driving the polymerization (a refractive index modulation and latent image polymerization system; a material that forms a latent image capable of performing refractive index modulation by polymerization).

In all of two-photon sensitization-type three-dimensional recording materials described in Patent Documents 1 to 4, a compound that performs two-photon absorption with light of 700 nm or more is used as (1) the two-photon absorption compound (two-photon sensitizer). However, in recent years, various requirements are further demanded and among others, for obtaining a higher recording density, a compound making it possible to perform non-resonant two-photon absorption recording by using recording light in the wavelength region shorter than 700 nm so as to form a smaller pit in the recording material is required.

To meet such a requirement, Patent Document 5 discloses a two-photon absorption recording material enabling non-resonant two-photon absorption recording using recording light in the wavelength region shorter than 700 nm and having sufficient recording/reproduction properties and a polyphenyl compound being usable therein and having a high two-photon absorption ability in the shorter wavelength region above.

### PRIOR-ART DOCUMENTS

### Patent Document

Patent Document 1: JP-A-2007-87532 (the term “JP-A” as used herein means an “unexamined published Japanese patent application”)
Patent Document 2: JP-A-2005-320502
Patent Document 3: JP-A-2005-29725
Patent Document 4: JP-A-2005-97538
Patent Document 5: JP-A-2010-108588

### SUMMARY OF THE INVENTION

### Problems that the Invention is to Solve

However, the two-photon absorption recording material described in Patent Document 5 has a drawback of poor solvent solubility of the two-photon absorption compound and therefore, it is difficult to increase the concentration of the compound in the two-photon absorption recording material, as a result, the sensitivity thereof is not sufficiently satisfied.

An object of the present invention is to overcome the drawbacks of the conventional techniques above and provide a two-photon absorption material enabling it to perform non-resonant two-photon absorption with high sensitivity by light in the region shorter than 700 nm and having sufficient recording/reproduction properties, a two-photon absorption recording material, a recording medium and a two-photon absorption compound usable therein. Another object of the present invention is to provide a high-sensitivity two-photon absorption material using a two-photon absorption compound having high solubility.

### Means for Solving the Problems

As a result of intensive studies, the present inventors have found that the above-described objects can be attained by the following configurations.

1. A non-resonant two-photon absorption material containing a non-resonant two-photon absorption compound represented by the following formula (1):

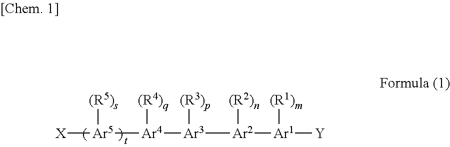

(wherein each of Ar¹ to Ar⁵ independently represents an aromatic hydrocarbon ring or an aromatic heterocyclic ring and each may be independently the same as or different from every others; each of m, n, p, q and s independently represents an integer of 0 to 4; t represents an integer of 0 or 1; each of R¹, R², R³, R⁴ and R⁵ independently represents a substituent; when each of m, n, p, q and s is independently an integer of 2 or more, each R¹, R², R³, R⁴ or R⁵ may be independently the same as or different from every other R¹, R², R³, R⁴ or R⁵; and each of X and Y represents a substituent having a Hammett sigma-para value of 0 or more and one may be the same as or different from another).

2. The non-resonant two-photon absorption material as described in 1 above, containing a non-resonant two-photon absorption compound represented by the following formula (2):

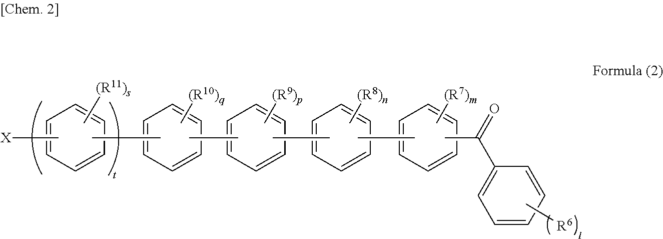

(wherein 1 represents an integer of 1 to 4; each of m, n, p, q and s independently represents an integer of 0 to 4; t represents an integer of 0 or 1; R⁶ represents a substituent containing at least one member selected from an oxygen atom, a sulfur atom and a nitrogen atom and when 1 is 2 or more, each R⁶ may be the same as or different from every other R⁶; each of R⁷, R⁸, R⁹, R¹⁰ and R¹¹ independently represents a substituent and when each of m, n, p, q and s is independently an integer of 2 or more, each R⁷, R⁸, R⁹, R¹⁰ or R¹¹ may be independently same as or different from every other R⁷, R⁸, R⁹, R¹⁰ or R¹¹; and X represents a substituent having a Hammett sigma-para value of 0 or more).

3. The non-resonant two-photon absorption material as described in 2 above, containing a non-resonant two-photon absorption compound represented by the following formula (3):

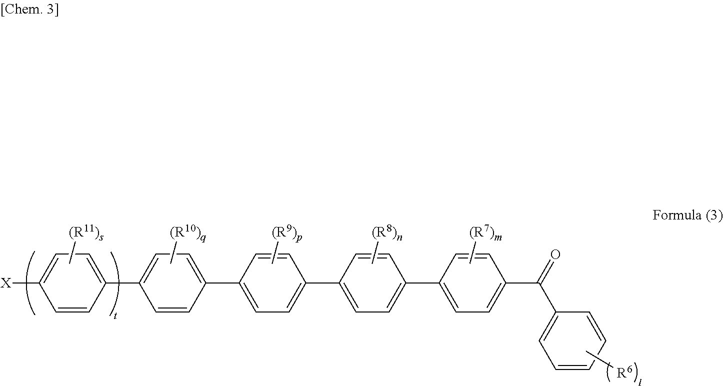

(wherein l, m, n, p, q, s, t, R⁶, R⁷, R⁸, R⁹, R¹⁰, R¹¹ and X are the same as those in formula (2)).

4. The non-resonant two-photon absorption material as described in any one of 1 to 3 above,

wherein the substituent represented by X in formulae (1) to (3) of the non-resonant two-photon absorption compounds is a trifluoromethyl group, a cyano group or a group represented by the following formula (4):

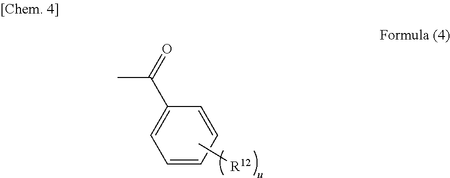

(wherein R¹² represents a substituent containing at least one member selected from an oxygen atom, a sulfur atom and a nitrogen atom, u represents an integer of 0 to 4, and when u is 2 or more, each R¹² may be the same as or different from every other R¹²).

5. The non-resonant two-photon absorption material as described in any one of 2 to 4 above,

wherein the non-resonant two-photon absorption compound represented by any one of formulae (1) to (3) is a non-resonant two-photon absorption compound represented by the following formula (5):

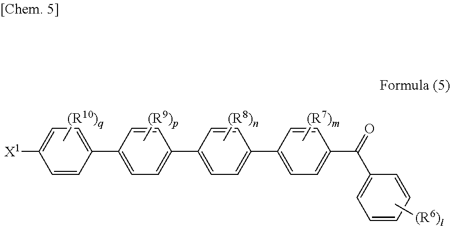

(wherein l, m, n, p, q, R⁶, R⁷, R⁸, R⁹ and R¹⁰ are the same as those in formulae (2) and (3), and X¹ represents a trifluoromethyl group, a cyano group or a substituent represented by formula (4)).

6. A non-resonant two-photon absorption recording material containing the non-resonant two-photon absorption material described in any one of 1 to 5 above.
7. The non-resonant two-photon absorption recording material as described in 6 above, containing (b) a material capable of changing the fluorescence intensity between before and after two-photon recording.
8. The non-resonant two-photon absorption recording material as described in 6 above, containing (b′) a material capable of changing the reflected light intensity between before and after two-photon recording.
9. The non-resonant two-photon absorption recording material as described in 8 above,

wherein a polymer compound having no linear absorption at the two-photon recording wavelength is used as the (b′) material capable of changing the reflected light intensity between before and after two-photon recording.

10. An optical information recording medium having a recording layer containing the non-resonant two-photon absorption recording material described in any one of 6 to 9 above.
11. A compound represented by the following formula (6):

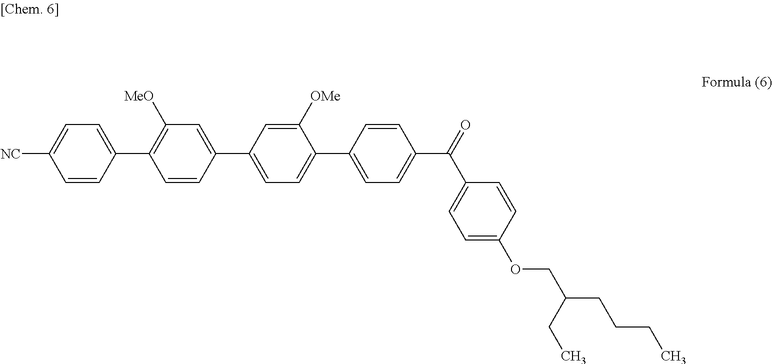 [SMILES: CCCCC(CC)COc1ccc(C(=O)c2ccc(-c3ccc(-c4ccc(-c5ccc(C#N)cc5)c(OC)c4)cc3OC)cc2)cc1]

12. A compound represented by the following formula (7):

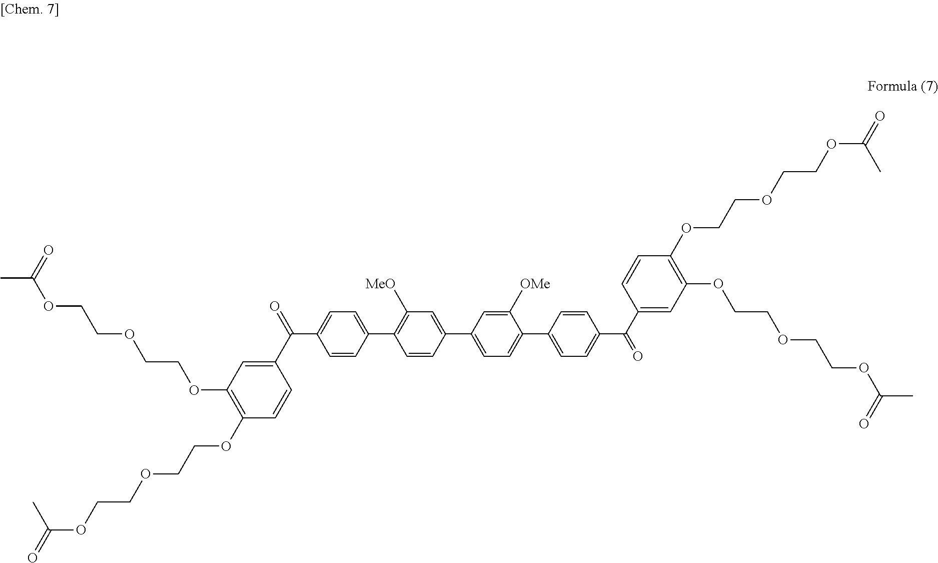 [SMILES: COc1cc(-c2ccc(-c3ccc(C(=O)c4ccc(OCCOCCOC(C)=O)c(OCCOCCOC(C)=O)c4)cc3)c(OC)c2)ccc1-c1ccc(C(=O)c2ccc(OCCOCCOC(C)=O)c(OCCOCCOC(C)=O)c2)cc1]

13. An optical information recording medium having a recording layer composed of a non-resonant two-photon absorption recording material containing a non-resonant two-photon absorption compound, and having a substrate, a guide layer, a reflecting layer, a spacer layer and a laminate structure of a recording layer sandwiched by intermediate layers, in order, from the back side relative to incident light and a cover layer and a hardcoat layer on the incident light surface side.
14. The optical information recording medium as described in 13 above,

wherein the thickness of the recording layer is from 50 nm to 2 μm.

15. The optical information recording medium as described in 13 above,

wherein the refractive index difference between the recording layer and the intermediate layer is from 0.01 to 0.5.

16. The optical information recording medium as described in 13 above,

wherein the thickness of the intermediate layer is from 2 μm to 20 μm.

17. The optical information recording medium as described in 13 above,

wherein the substrate thickness is from 0.02 mm to 2 mm.

18. The optical information recording medium as described in 13 above,

wherein the thickness of the cover layer is from 0.01 mm to 0.2 mm.

19. The optical information recording medium as described in 13 above,

wherein the thickness of the spacer layer is from 5 μm to 100 μm.

20. The optical information recording medium as described in 13 above,

wherein the optical information recording medium performs marking.

21. The optical information recording medium as described in 13 above,

wherein the optical information recording medium is housed in a cartridge.

22. The optical information recording medium as described in 10 above and as described in any one of 13 to 21 above.
23. A non-resonant two-photon absorption recording method comprising,

irradiating the optical information recording medium described in 22 above with laser light having a wavelength of 400 to 450 nm to three-dimensionally record information.

24. A recording/reproducing method on the optical information recording medium described in 22 above,

wherein the peak power of a recording laser is from 1 to 100 W on the surface of said optical information recording medium, the average power of the recording laser is 100 mW or less on the surface of the optical information recording medium, and the product of the pulse width and the oscillation cycle of the recording laser is from 0.001 to 0.1.

25. A recording/reproducing method on an optical information recording medium as described in 24 above, comprising using a confocal optical system at the time of reproducing the information.

The action mechanism of the two-photon absorption material of the present invention capable of absorbing light at a wavelength shorter than 700 nm with high sensitivity is not clearly elucidated, but it is presumed that the two-photon absorption compound (the polyphenyl compound represented by formula (1)) used for the two-photon absorption material has, at the benzoyl group terminal less affecting the two-photon absorption efficiency, a substituent containing an oxygen atom, a sulfur atom or a nitrogen atom and therefore, the solubility for a solvent is enhanced without impairing the two-photon absorption efficiency, so that the two-photon absorption compound can be contained at a high concentration in the two-photon absorption material.

### Advantage of the Invention

According to the configuration of the two-photon absorption material of the present invention, light in the wavelength region shorter than 700 nm can be absorbed with high sensitivity.

Also, the two-photon absorption compound of the present invention exhibits non-resonant two-photon absorption properties with light in the wavelength region shorter than 700 nm, so that a high two-photon absorption cross-sectional area can be obtained.

Furthermore, the two-photon absorption compound of the present invention exhibits high solubility without impairing the two-photon absorption efficiency and this compound when used can be contained at a high concentration in a two-photon absorption material, so that the two-photon absorption material can have higher two-photon absorption sensitivity.

### BRIEF DESCRIPTION OF THE DRAWINGS

FIG. 1 is a view showing the outline of one example of the recording/reproducing apparatus used for recording/reproduction of the two-photon absorption recording material of the present invention.

FIG. 2 is a view showing the outline of one example of the optical information recording medium using the two-photon absorption recording material of the present invention.

### MODE FOR CARRYING OUT THE INVENTION

The two-photon absorption material of the present invention is described in detail below.

The two-photon absorption material of the present invention is characterized by containing a non-resonant two-photon absorption compound represented by the following formula (1):

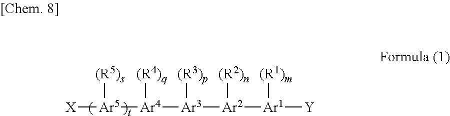

(wherein each of Ar¹ to Ar⁵ independently represents an aromatic hydrocarbon ring or an aromatic heterocyclic ring and each may be independently the same as or different from every others; each of m, n, p, q and s independently represents an integer of 0 to 4; t represents an integer of 0 or 1; each of R¹, R², R³, R⁴ and R⁵ independently represents a substituent; when each of m, n, p, q and s is independently an integer of 2 or more, each R¹, R², R³, R⁴ or R⁵ may be the same as or different from every other R¹, R², R³, R⁴ or R⁵; and each of X and Y represents a substituent having a Hammett sigma-para value of 0 or more).

### <Non-Resonant Two-Photon Absorption Compound>

The (a) non-resonant two-photon absorption compound used in the non-resonant two-photon absorption material of the present invention is described below.

The (a) non-resonant two-photon absorption compound used in the non-resonant two-photon absorption material of the present invention is a compound having a structure represented by formula (1).

In formula (1), each of Ar¹ to Ar⁵ independently represents an aromatic hydrocarbon ring or an aromatic heterocyclic ring, and the aromatic hydrocarbon ring specifically includes benzene, naphthalene, anthracene, phenanthrene and the like and is preferably benzene or naphthalene, more preferably benzene. The aromatic heterocyclic ring includes pyrrole, furan, thiophene, imidazole, pyrazole, oxazole, isoxazole, thiazole, isothiazole, pyridine, pyrimidine, pyridazine, pyrazine, triazine, quinoline, isoquinoline, quinazoline, phthalazine, pteridine, coumarin, chromone, indole, benzimidazole, benzofuran, purine, acridine, phenoxazine, phenothiazine and the like and is preferably pyrrole, furan, thiophene, imidazole, pyrazole, oxazole, isoxazole, thiazole, isothiazole, pyridine, pyrimidine, pyrazine, quinoline, indole or benzimidazole, more preferably pyrrole, thiophene or pyridine.

In formula (1), each of R¹, R², R³, R⁴ and R⁵ independently represents a substituent, and the substituent is not particularly limited except for a hydrogen atom and includes an alkyl group, an alkoxy group, an alkoxyalkyl group, an aryloxy group and the like.

In formula (1), each of m, n, p, q and s independently represents an integer of 0 to 4, but each of m, q and s is preferably 0 and both n an p are preferably 0 or 1. In the case when n and p are 1, R² and R³ are preferably the same substituent, and their substitution positions are preferably the m-(meta)position with each other in the biphenyl structure moiety on which R² and R³ are substituted.

In formula (1), t represents an integer of 0 or 1 and is preferably 0.

In formula (1) each of X and Y represents a so-called electron-withdrawing group whose σp value in the Hammett equation takes a value of 0 or more, and is preferably, for example, a trifluoromethyl group, a heterocyclic group, a halogen atom, a cyano group, a nitro group, an alkylsulfonyl group, an arylsulfonyl group, a sulfamoyl group, a carbamoyl group, an acyl group, an acyloxy group or an alkoxy carbonyl group, more preferably a trifluoromethyl group, a cyano group, an acyl group, an acyloxy group, a bromine atom or an alkoxycarbonyl group, and most preferably a trifluoromethyl group, a cyano group or a group represented by the following formula (4):

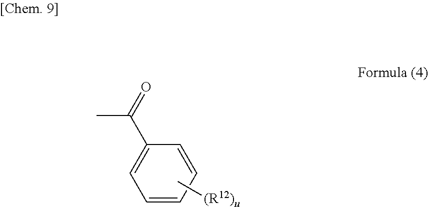

(wherein R¹² represents a substituent containing at least one member selected from an oxygen atom, a sulfur atom and a nitrogen atom, u represents an integer of 0 to 4, and when u is 2 or more, each R¹² may be the same as or different from every other R¹²).

In formula (4), R¹² represents a substituent containing at least one member selected from an oxygen atom, a sulfur atom and a nitrogen atom, and preferred matters and specific details thereof are the same as those of R⁶ in formula (2) described later.

In formula (4), u represents an integer of 0 to 4, and preferred matters and specific details thereof are the same as those of 1 in formula (2) described later.

The compound represented by formula (1) is preferably a compound represented by the following formula (2):

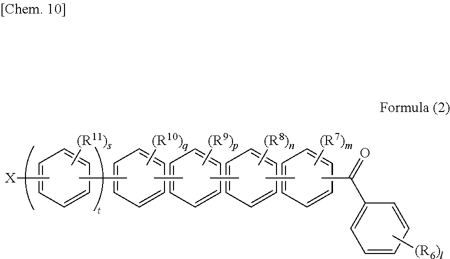

(wherein 1 represents an integer of 1 to 4; each of m, n, p, q and s independently represents an integer of 0 to 4; t represents an integer of 0 or 1; R⁶ represents a substituent containing at least one member selected from an oxygen atom, a sulfur atom and a nitrogen atom and when 1 is 2 or more, each R⁶ may be the same as or different from every other R⁶; each of R⁷, R⁸, R⁹, R¹⁰ and R¹¹ independently represents a substituent and when each of m, n, p, q and s is independently an integer of 2 or more, each R⁷, R⁸, R⁹, R¹⁰ or R¹¹ may be independently same as or different from every other R⁷, R⁸, R⁹, R¹⁰ or R¹¹; and X represents a substituent having a Hammett sigma-para value of 0 or more).

In formula (2), R⁶ represents a substituent containing at least one member selected from an oxygen atom, a sulfur atom and a nitrogen atom and is preferably a substituent composed of an oxygen atom and a carbon atom, more preferably a group bonded to the benzene ring through an oxygen atom. The group bonded to the benzene ring through an oxygen atom specifically includes a linear or branched alkyloxy group, a group containing a group formed by repeatedly bonding a plurality of oxyalkylene groups (hereinafter, sometimes referred to as a polyoxyalkylene group), and the like. The group containing a polyoxyalkylene group preferably has an acyl group at the terminal thereof. The oxyalkylene group is not particularly limited but is preferably an ethyleneoxy group. The acyl group in the group containing a polyoxyalkylene group having an acyl group at the terminal is not particularly limited but is preferably an acetyl group.

In formula (2), 1 represents an integer of 1 o 4 and is preferably an integer of 1 to 3. When 1 is 2 or more, each R⁶ may be the same as or different from every other R⁶ but these are preferably the same.

In formula (2), each of R⁷, R⁸, R⁹, R¹⁰ and R¹¹ independently represents a substituent, and examples thereof are the same as those described for R¹, R², R³, R⁴, R⁵ or R⁶ in formula (1).

In formula (2), m, n, p, q, s, t and X are the same as those in formula (1).

The reason why in the compound represented by formula (1) or (2), X or Y is preferably a so-called electron-withdrawing group whose σp value in the Hammett equation takes a value of 0 or more is recited in paragraphs 0034 to 0038 of JP-A-2010-108588.

More specifically, according to T. Kogej, et al., Chem. Phys. Lett., 298, 1 (1998), the two-photon absorption efficiency of an organic compound, that is, the two-photon absorption cross-sectional area δ, has the following relationship with the imaginary part of the third-order molecular polarizability (second-order hyperpolarizability) γ.

$$\begin{matrix}Mathematical Formula ( 1 ) & \\ δ ( ω ) = ( \frac{3 π h {v}^{2}}{{n}^{2} {c}^{2} {ɛ}_{0}} ) Im γ ( - ω ; ω , , - ω , ω ) & [ Math . 1 ]\end{matrix}$$

wherein c: light speed, ν: frequency, n: refractive index, ∈₀: dielectric constant in vacuum, ω: number of vibration of photon, and Im: imaginary part. The imaginary part (Imγ) of γ has the following relationship with Mge: dipole moment between |g> and |e>, Mge′: dipole moment between |g> and |e′>, Δμge: difference in dipole moment between |g> and |e>, Ege: transition energy, and Γ: damping factor.

$$\begin{matrix}Mathematical Formula ( 2 ) & \\ Im γ ( - ω ; ω , - ω , ω ) = Im P [ \begin{matrix}\frac{M g {e}^{2} Δ μ g {e}^{2}}{( E g e - ℏ ω - iΓ g e ) ( E g e - 2 ℏ ω - iΓ g e ) ( E g e - ℏ ω - iΓ g e )} + \\ {\sum }_{{e}^{′}} \frac{( M g {e}^{2} M e {e}^{′ 2} )}{( E g e - ℏω - i Γ g e ) ( E g {e}^{′} - 2 ℏ ω - i Γ g {e}^{′} ) ( E g e - ℏ ω - iΓ g e )} - \\ \frac{M g {e}^{4}}{( E g e - ℏ ω - iΓ g e ) ( E g e + ℏ ω + iΓ g e ) ( E g e - ℏ ω - iΓ g e )}\end{matrix} ] & [ Math . 2 ]\end{matrix}$$

wherein P represents a commutative operator.

Accordingly, when the value of mathematical formula (2) is computed, the two-photon absorption cross-sectional area of a compound can be predicted. For this reason, the most stable structure of the ground state is computed by a DFT method using a B3LYP functional with a 6-31G* basis function, and Mge, Mee′ and Ege are computed based on the result, whereby the value of Imγ can be computed. For example, assuming that the maximum Imγ value obtained by the computation of a quaterphenyl compound that is a compound having a structure represented by formula (1) where a methoxy group as an electron-donating substituent is substituted on X is 1, the relative value of the maximum Imγ value of a molecule having, as other substituents, a so-called electron-withdrawing group whose up value in the Hammett equation takes a positive value becomes large.

As regards the compound having a structure represented by formula (1) or (2), Imγ is small in the case of a quaterphenyl compound where a methoxy group as an electron-donating group is substituted on X or Y, and Imγ greatly increases in general in the case of a molecule where an electron-withdrawing substituent is substituted on both X and Y. As described above, the two-photon absorption cross-sectional area δ is theoretically proportional to the imaginary part of the third-order hyperpolarizability γ, that is, Imγ, and judging from the computation thereof, a structure where an electron-withdrawing substituent is substituted on both X and Y is preferred.

The compound represented by formula (2) is preferably a compound represented by the following formula (3):

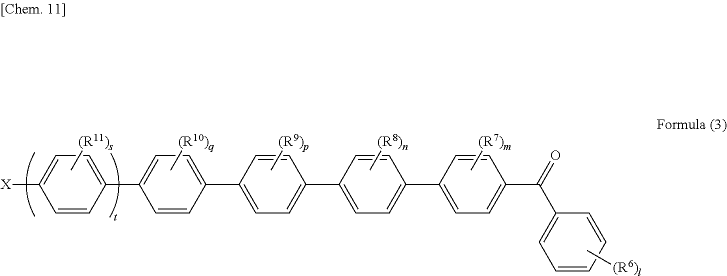

(wherein l, m, n, p, q, s, t, R⁶, R⁷, R⁸, R⁹, R¹⁰, R¹¹ and X are the same as those in formula (2)).

Also, the compound represented by formula (2) or (3) is preferably a compound represented by the following formula (5):

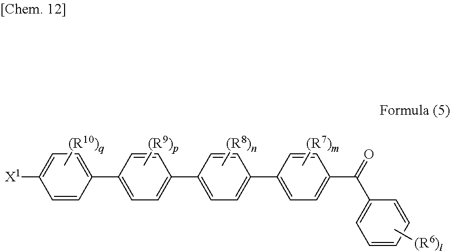

(wherein l, m, n, p, q, R⁶, R⁷, R⁸, R⁹ and R¹⁰ are the same as those in formulae (2) and (3), and X¹ represents a trifluoromethyl group, a cyano group or a substituent represented by formula (4)).

Specific examples of the compound represented by formula (2), (3) or (5) are not particularly limited but include the followings.

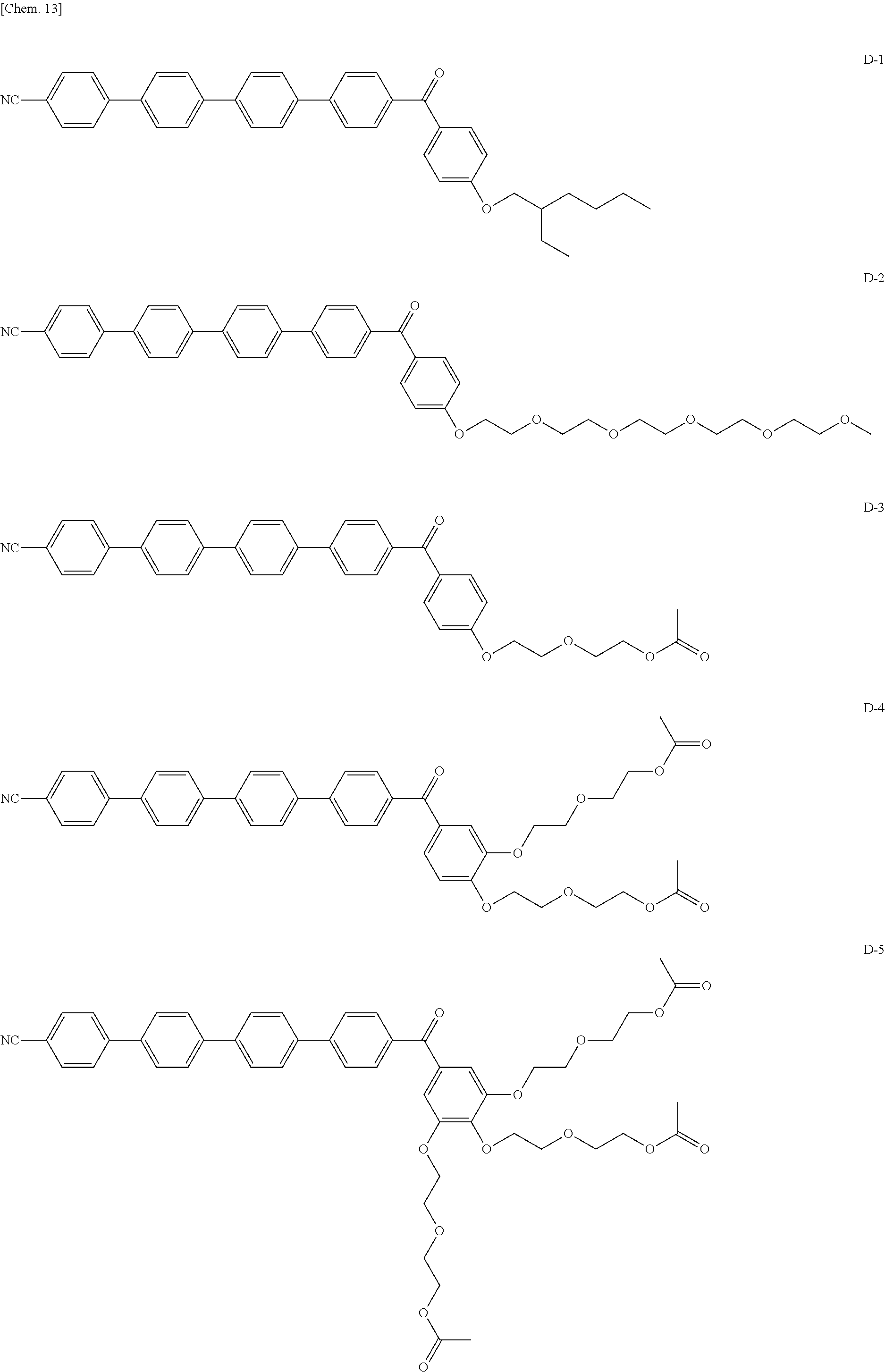 [SMILES: CCCCC(CC)COc1ccc(C(=O)c2ccc(-c3ccc(-c4ccc(-c5ccc(C#N)cc5)cc4)cc3)cc2)cc1 ; COCCOCCOCCOCCOCCOc1ccc(C(=O)c2ccc(-c3ccc(-c4ccc(-c5ccc(C#N)cc5)cc4)cc3)cc2)cc1 ; CC(=O)OCCOCCOc1ccc(C(=O)c2ccc(-c3ccc(-c4ccc(-c5ccc(C#N)cc5)cc4)cc3)cc2)cc1 ; CC(=O)OCCOCCOc1ccc(C(=O)c2ccc(-c3ccc(-c4ccc(-c5ccc(C#N)cc5)cc4)cc3)cc2)cc1OCCOCCOC(C)=O ; CC(=O)OCCOCCOc1cc(C(=O)c2ccc(-c3ccc(-c4ccc(-c5ccc(C#N)cc5)cc4)cc3)cc2)cc(OCCOCCOC(C)=O)c1OCCOCCOC(C)=O]

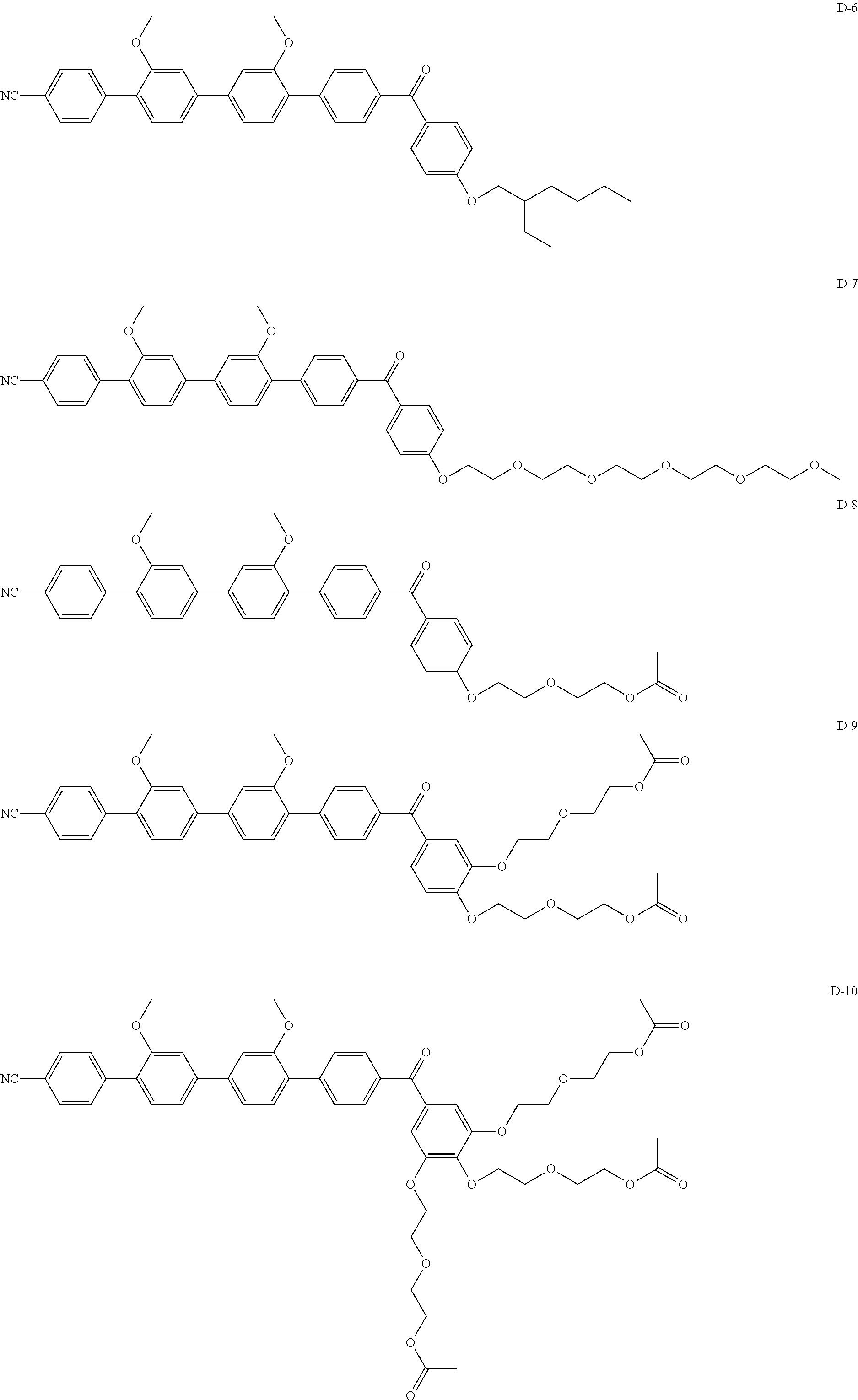

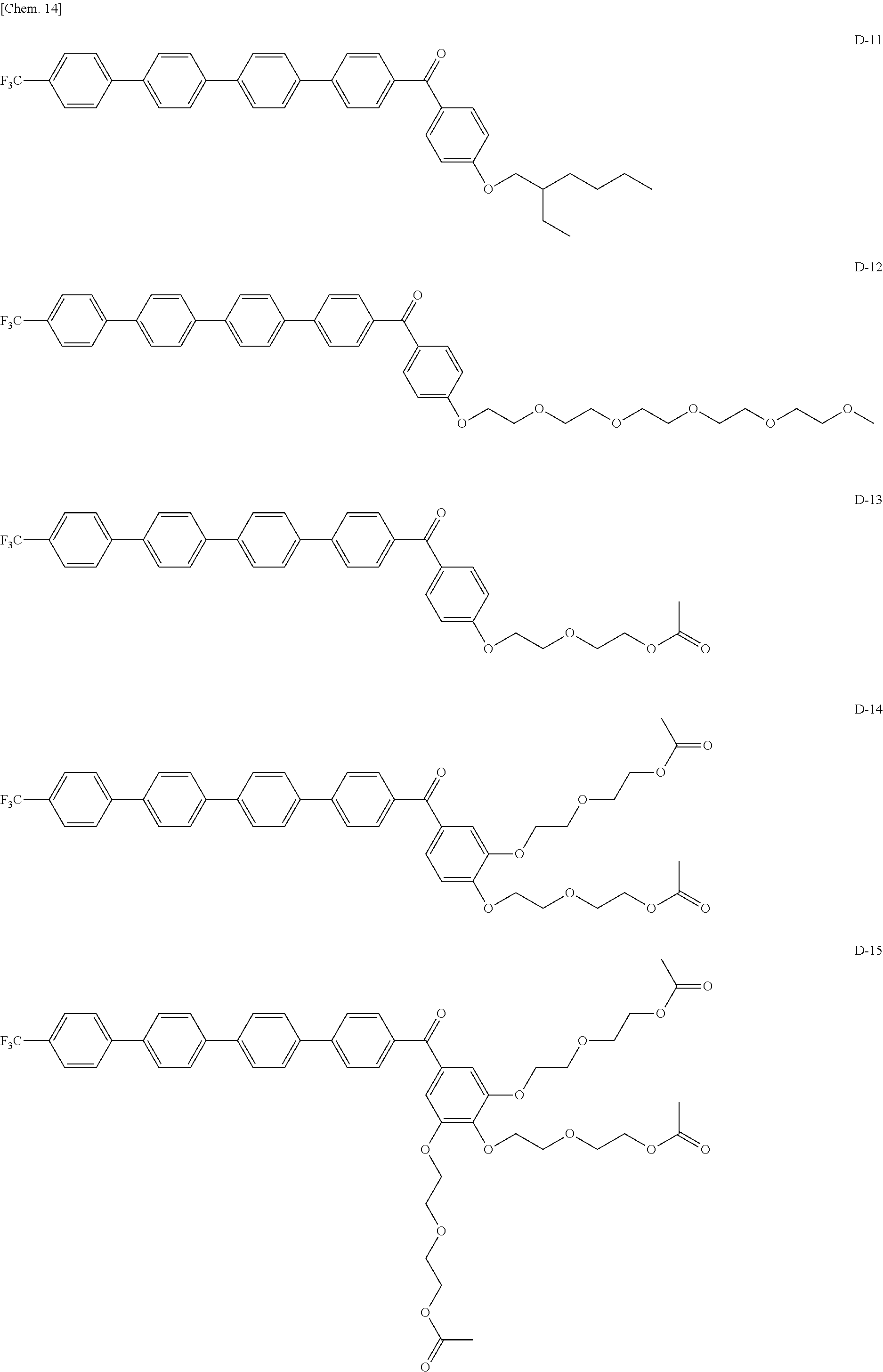 [SMILES: CCCCC(CC)COc1ccc(C(=O)c2ccc(-c3ccc(-c4ccc(-c5ccc(C(F)(F)F)cc5)cc4)cc3)cc2)cc1 ; COCCOCCOCCOCCOCCOc1ccc(C(=O)c2ccc(-c3ccc(-c4ccc(-c5ccc(C(F)(F)F)cc5)cc4)cc3)cc2)cc1 ; CC(=O)OCCOCCOc1ccc(C(=O)c2ccc(-c3ccc(-c4ccc(-c5ccc(C(F)(F)F)cc5)cc4)cc3)cc2)cc1 ; CC(=O)OCCOCCOc1ccc(C(=O)c2ccc(-c3ccc(-c4ccc(-c5ccc(C(F)(F)F)cc5)cc4)cc3)cc2)cc1OCCOCCOC(C)=O ; CC(=O)OCCOCCOc1cc(C(=O)c2ccc(-c3ccc(-c4ccc(-c5ccc(C(F)(F)F)cc5)cc4)cc3)cc2)cc(OCCOCCOC(C)=O)c1OCCOCCOC(C)=O]

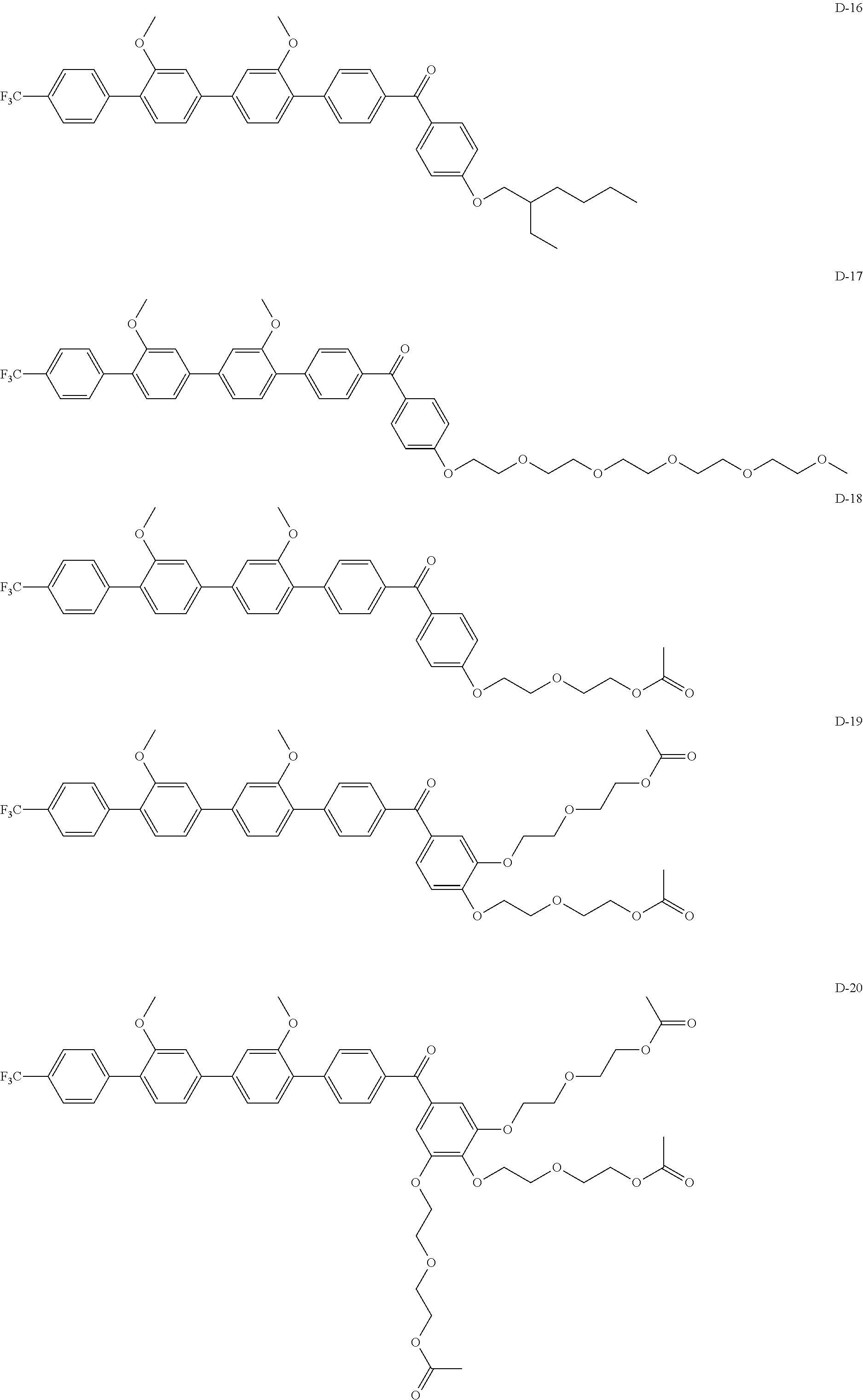

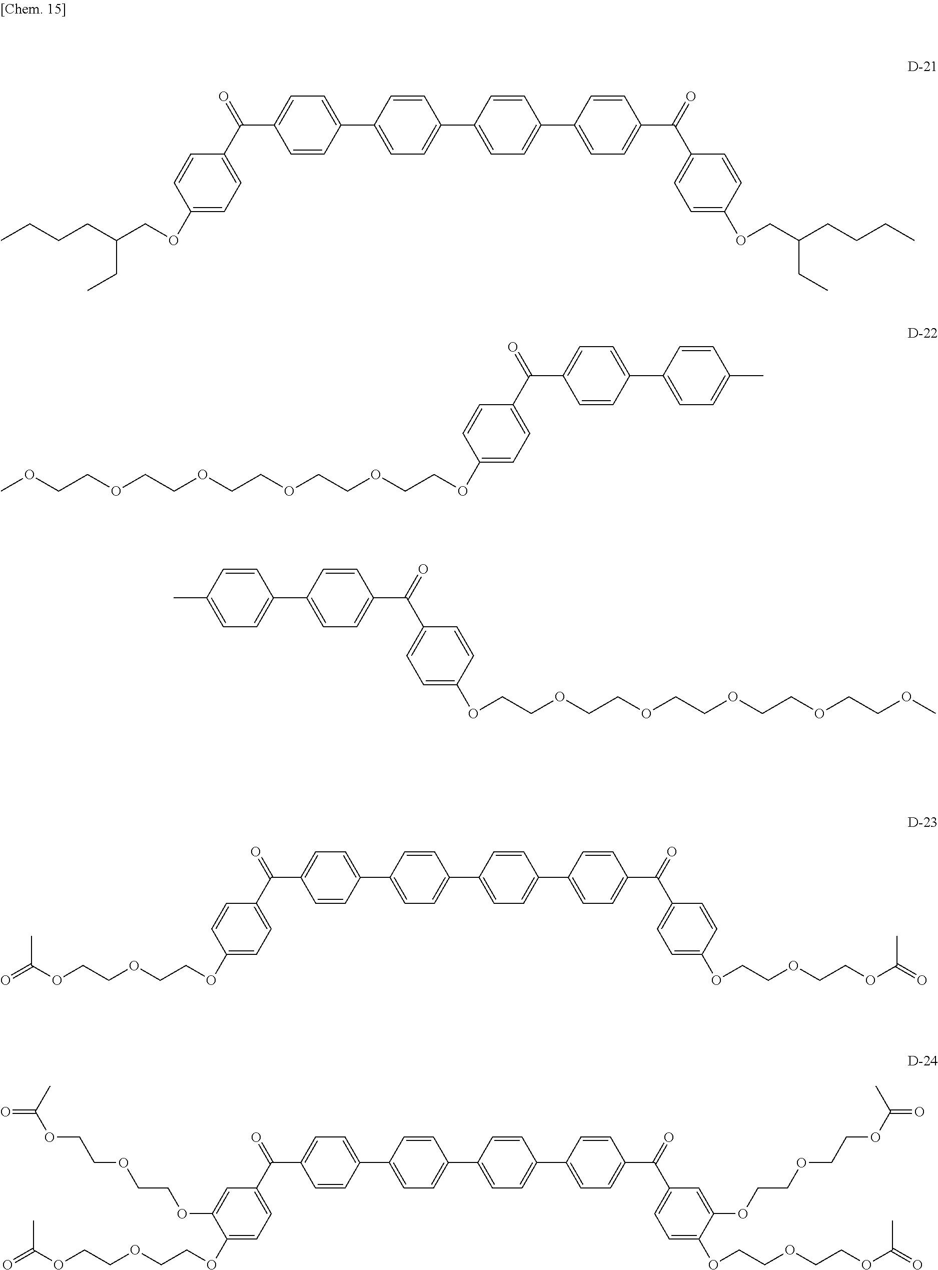

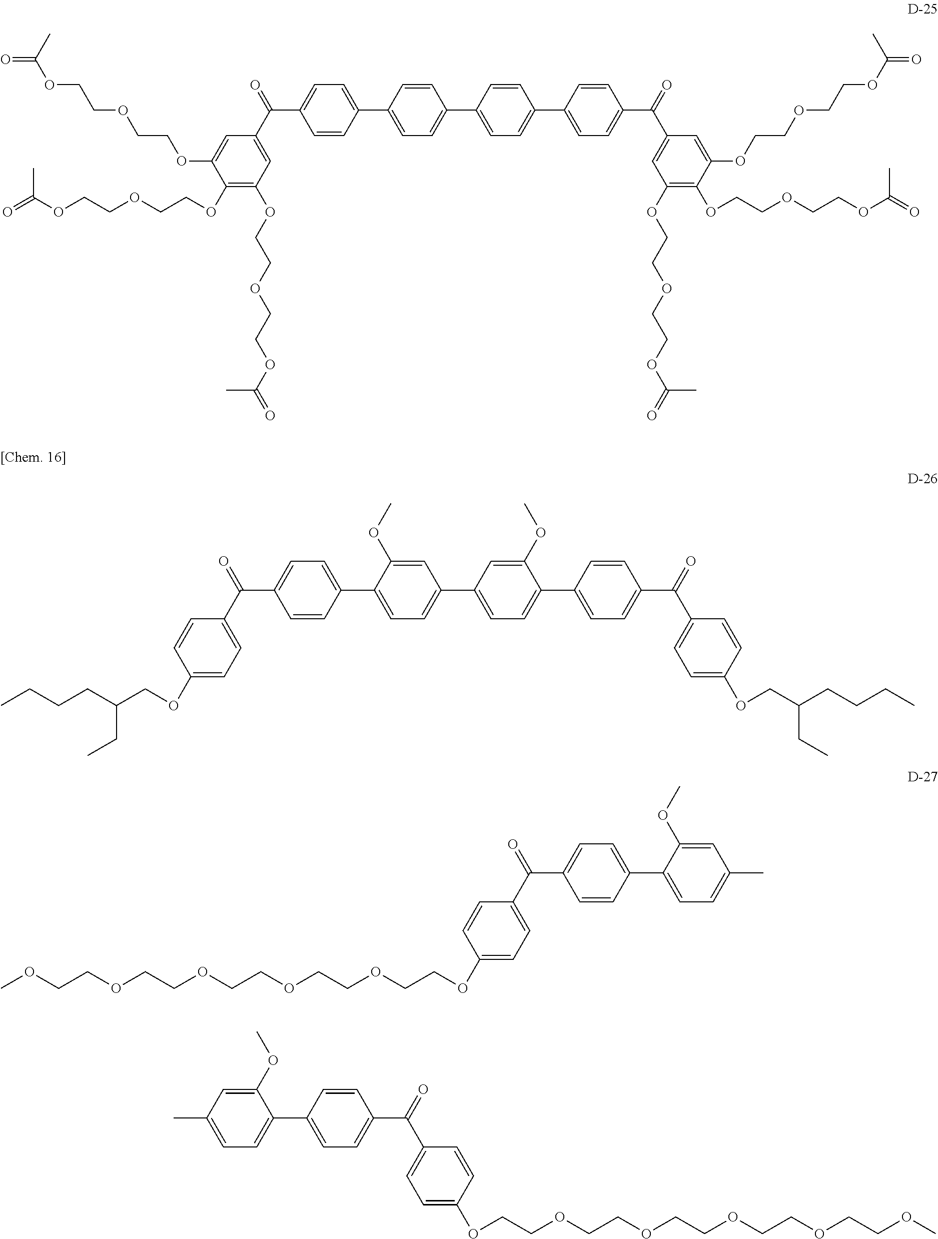

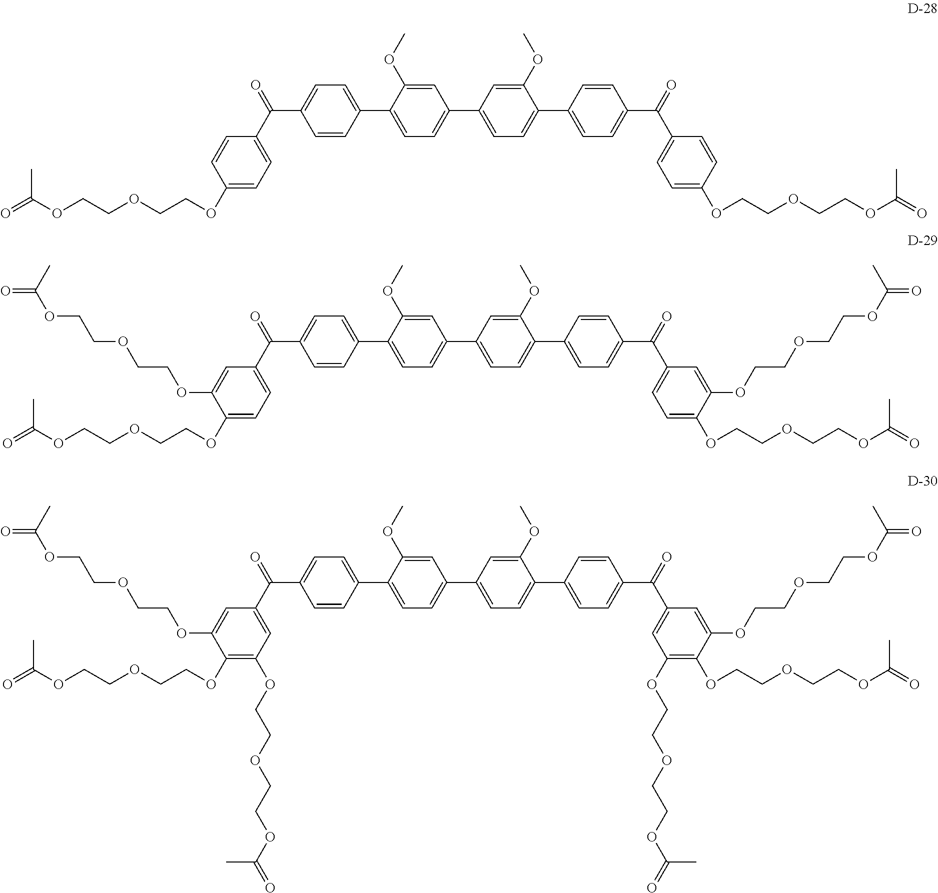 [SMILES: COc1cc(-c2ccc(-c3ccc(C(=O)c4ccc(OCCOCCOC(C)=O)cc4)cc3)c(OC)c2)ccc1-c1ccc(C(=O)c2ccc(OCCOCCOC(C)=O)cc2)cc1 ; COc1cc(-c2ccc(-c3ccc(C(=O)c4ccc(OCCOCCOC(C)=O)c(OCCOCCOC(C)=O)c4)cc3)c(OC)c2)ccc1-c1ccc(C(=O)c2ccc(OCCOCCOC(C)=O)c(OCCOCCOC(C)=O)c2)cc1 ; COc1cc(-c2ccc(-c3ccc(C(=O)c4cc(OCCOCCOC(C)=O)c(OCCOCCOC(C)=O)c(OCCOCCOC(C)=O)c4)cc3)c(OC)c2)ccc1-c1ccc(C(=O)c2cc(OCCOCCOC(C)=O)c(OCCOCCOC(C)=O)c(OCCOCCOC(C)=O)c2)cc1]

[Chem. 17]

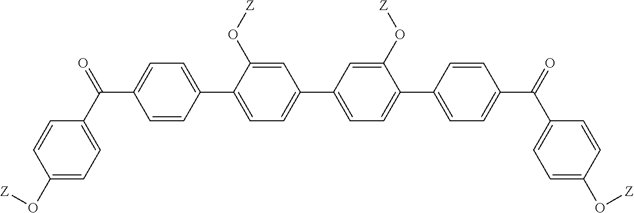

| | Z |
|---|---|
| D-31 | 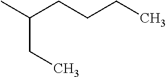 |
| D-32 | 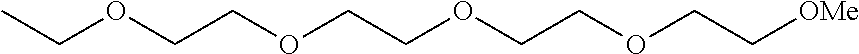 |
| D-33 | 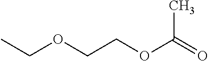 |

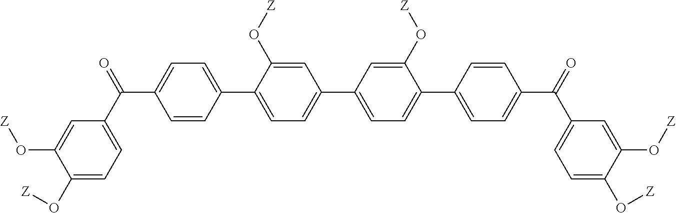

| | |
|---|---|
| D-34 | 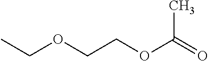 |

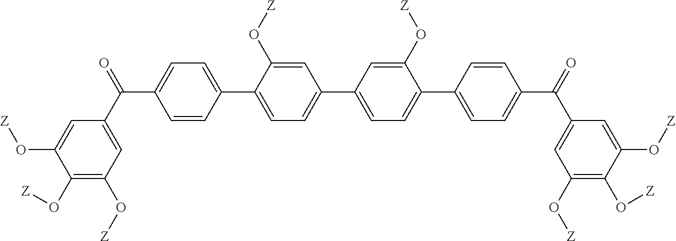

| | |
|---|---|
| D-35 | 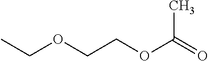 |

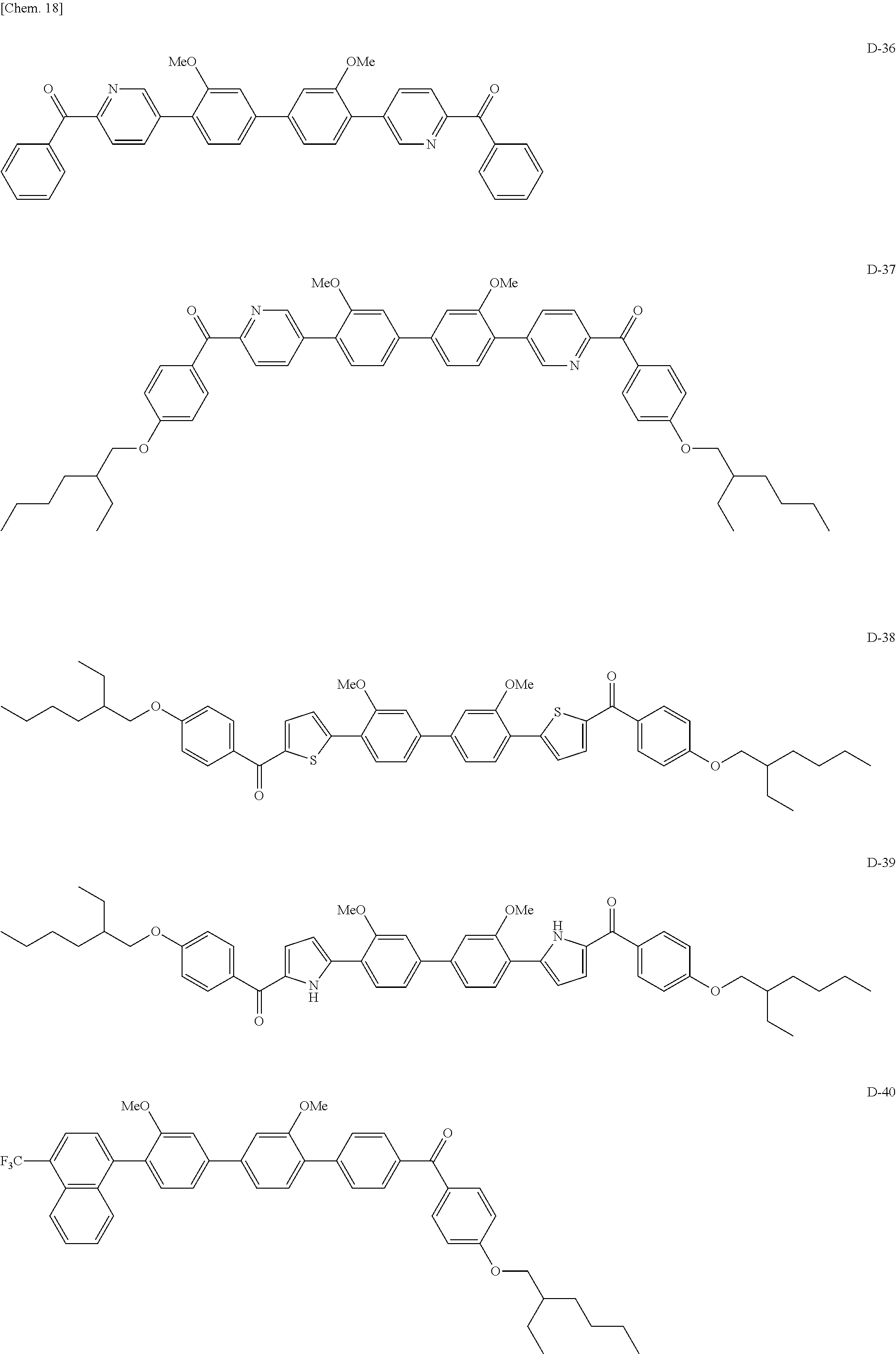

Among these compounds, D-6 and D-29 are novel compounds.

The non-resonant two-photon absorption material of the present invention can be formed into a non-resonant two-photon absorption recording material. Specifically, a non-resonant two-photon absorption recording material containing the non-resonant two-photon absorption material of the present invention can be made up.

The non-resonant two-photon absorption recording material of the present invention is not particularly limited as long as it contains the non-resonant two-photon absorption material of the present invention, but there are two modes of, for example, [A] a recording material containing (b) a material capable of changing the fluorescence intensity between before and after two-photon recording and [B] a recording material containing (b′) a material capable of changing the reflected light intensity between before and after two-photon recording. These two modes are described in sequence below.

[A] “Two-photon absorption recording material containing (b) a material capable of changing the fluorescence intensity between before and after two-photon recording” (hereinafter, sometimes referred to as a two-photon absorption recording material [A] or a recording material [A])

The two-photon absorption recording material [A] and a two-photon absorption recording medium or the like using the recording material [A] are described below.

<(b) Material Capable of Changing the Fluorescence Intensity Between Before and after Two-Photon Recording>

The (b) material capable of changing the fluorescence intensity between before and after two-photon recording, which is used in the non-resonant two-photon absorption recording material [A] of the present invention, includes, for example:

(I) a material capable of modulating fluorescence by color formation of a fluorescent dye,
(II) a material that forms a latent image capable of modulating fluorescence by color formation of a dye, and
(III) a material that forms a latent image capable of modulating fluorescence by polymerization.

These materials are described blow.

### [Material Capable of Modulating Fluorescence by Color Formation of a Fluorescent Dye]

The material capable of modulating fluorescence by color formation of a fluorescent dye preferably contains at least one kind or more of, for example:

(A) a dye precursor whose absorption band is caused to appear in the visible region by an acid,
(B) a dye precursor whose absorption band is caused to appear in the visible region by a base,
(C) a dye precursor whose absorption band is caused to appear in the visible region by oxidation, and
(D) a dye precursor whose absorption is caused to appear in the visible region by reduction.

These dye precursors are described below.

### (A) Dye Precursor Whose Absorption Band is Caused to Appear in the Visible Region by an Acid

This dye precursor is a dye precursor capable of becoming a color former whose absorption is changed from the original state by an acid generated from an acid generator. The acid-induced color formation-type precursor is preferably a compound whose absorption is shifted to the longer wavelength side by an acid, more preferably a compound which is colorless but is caused to develop color by an acid.

Preferred acid-induced color formation-type dye precursors include a triphenylmethane-based compound, a phthalide-based compound (including a indolylphthalide-based compound, an azaphthalide-based compound, and a triphenylmethanephthalide-based compound), a phenothiazine-based compound, a phenoxazine-based compound, a fluoran-based compound, a thiofluoran-based compound, a xanthene-based compound, a diphenylmethane-based compound, a chromenopyrazole-based compound, a leucoauramine-based compound, a methine-based compound, an azomethine-based compound, a rhodamine lactam-based compound, a quinazoline-based compound, a diazaxanthene-based compound, a fluorene-based compound, and a spiropyran-based compound. Specific examples of these compounds are disclosed in JP-A-2002-156454 and patents cited therein, JP-A-2000-281920, JP-A-11-279328 and JP-A-8-240908.

More preferred acid-induced color formation-type dye precursors include a leuco dye having a partial structure such as lactone, lactam, oxazine or spiropyran, a fluoran-based compound, a thiofluoran-based compound, a phthalide-based compound, a rhodamine lactam-based compound, and a spiropyran-based compound, and the acid-induced color formation-type dye precursor is still more preferably a xanthene (fluoran) dye or a triphenylmethane dye. Two or more of these acid-induced color formation-type dye precursors may be used as a mixture in an arbitrary ratio, if desired.

Specific preferred examples of the acid-induced color formation-type dye precursor which can be used include compounds of formulae (21) to (23) disclosed in JP-A-2007-87532, compounds recited in ibid., paragraph 0122 (phthalide-based dye precursors (including an indolylphthalide-based dye precursor and an azaphthalide-based dye precursor)), compounds of ibid., formula (24), compounds recited in ibid., paragraph 0126 (triphenylmethanephthalide-based dye precursors), compounds of ibid., formula (25), compounds recited in ibid., paragraph 0130 (fluoran-based dye precursors), compounds recited in ibid., paragraph 0131 (rhodamine lactam-based dye precursors), and compounds recited in ibid., paragraph 0132 (spiropyran-based dye precursors).

In addition, as the acid-induced color formation-type dye precursor, BLD compounds represented by formula (6) disclosed in JP-A-2008-284475, leuco dyes disclosed in JP-A-2000-144004, and leuco dyes having a structure of [Chem. 38] disclosed in JP-A-2007-87532 may be also preferably used.

Furthermore, compounds of formula (26) disclosed in JP-A-2007-87532 and compounds represented by ibid., [Chem. 40], which develop color by the addition of an acid (proton), can be used as the dye precursor above.

Specific preferred examples of the acid-induced color formation-type dye precursor for use in the present invention include compounds described in JP-A-2007-87532 above but the present invention is not limited thereto.

### (B) Dye Precursor Whose Absorption Band is Caused to Appear in the Visible Region by a Base

This dye precursor is a dye precursor capable of becoming a color former whose absorption is changed from the original state by a base generated from a base generator.

The base-induced color formation-type precursor is preferably a compound whose absorption is shifted to the longer wavelength side by a base, more preferably a compound capable of greatly increasing in the molar extinction coefficient by the action of a base.

The base-induced color formation-type dye precursor for use in the present invention is preferably a non-dissociated form of a dissociation-type dye. Incidentally, the dissociation-type dye is a compound having, on the dye chromophore, a dissociative group having a pKa of 12 or less, preferably a pKa of 10 or less, and being prone to dissociate and release a proton, where when the compound is changed from the non-dissociated form to the dissociated form, the absorption is shifted to the longer wavelength side or the colorless state turns into a colored state. Preferred examples of the dissociative groups include an OH group, an SH group, a COOH group, a PO₃H₂ group, an SO₃H group, an NR⁹¹R⁹²H⁺ group, an NHSO₂R⁹³ group, a CHR⁹⁴R⁹⁵ group, and an NHR⁹⁶ group.

Here, each of R⁹¹, R⁹² and R⁹⁶ independently represents a hydrogen atom, an alkyl group (preferably having a C number of 1 to 20, e.g., methyl, ethyl, n-propyl, isopropyl, n-butyl, n-pentyl, benzyl, 3-sulfopropyl, 4-sulfobutyl, carboxymethyl, 5-carboxypentyl), an alkenyl group (preferably having a C number of 2 to 20, e.g., vinyl, allyl, 2-butenyl, 1,3-butadienyl), a cycloalkyl group (preferably having a C number of 3 to 20, e.g., cyclopentyl, cyclohexyl), an aryl group (preferably having a C number of 6 to 20, e.g., phenyl, 2-chlorophenyl, 4-methoxyphenyl, 3-methylphenyl, 1-naphthyl), or a heterocyclic group (preferably having a C number of 1 to 20, e.g., pyridyl, thienyl, furyl, thiazolyl, imidazolyl, pyrazolyl, pyrrolidino, piperidino, morpholino), and preferably a hydrogen atom or an alkyl group. R⁹³ represents an alkyl group, an alkenyl group, a cycloalkyl group, an aryl group, or a heterocyclic group (preferred substituents are the same as examples recited for the substituent in R⁹¹, R⁹² and R⁹⁶) and is preferably an alkyl group which may be substituted, or an aryl group which may be substituted, more preferably an alkyl group which may be substituted, and the substituent here is preferably an electron-withdrawing group and is preferably fluorine.

Each of R⁹⁴ and R⁹⁵ independently represents a substituent (preferred substituents are the same as examples recited for the substituent in R⁹¹, R⁹² and R⁹⁶). An electron-withdrawing substituent is preferred, and the substituent is preferably a cyano group, an alkoxycarbonyl group, a carbamoyl group, an acyl group, an alkylsulfonyl group or an arylsulfonyl group.

The dissociative group of the dissociation-type dye for use in the invention is more preferably an OH group, an SH group, a COOH group, a PO₃H₂ group, an SO₃H group, an NR⁹¹R⁹²H⁺ group, an NHSO₂R⁹³ group or a CHR⁹⁴R⁹⁵ group, still more preferably an OH group or a CHR⁹⁴R⁹⁵ group, and most preferably an OH group.

The non-dissociated form of the dissociation-type dye as the base-induced color formation-type dye precursor for use in the invention is preferably a non-dissociated form of a dissociation-type azo dye, a dissociation-type azomethine dye, a dissociation-type oxonol dye, a dissociation-type arylidene dye, a dissociation-type xanthene (fluoran) dye or a dissociation-type triphenylamine dye, more preferably a non-dissociated form of a dissociation-type azo dye, a dissociation-type azomethine dye, a dissociation-type oxonol dye or a dissociation-type arylidene dye.

Specific preferred examples of the base-induced color formation-type dye precursor include compounds disclosed in paragraphs 0144 to 0146 of JP-A-2007-87532, but the present invention is not limited thereto.

### (C) Dye Precursor Whose Absorption Band is Caused to Appear in the Visible Region by Oxidation

This dye precursor is not particularly limited as long as it is a compound capable of increasing in the absorbancy by oxidation reaction, but it is preferred to contain at least any one or more kinds of compounds selected from leucoquinone compounds, thiazineleuco compounds, oxazineleuco compounds, phenazineleuco compounds and leucotriarylmethane compounds.

As the leucoquinone compound, compounds having a partial structure represented by formulae (6) to (10) of JP-A-2007-87532 and recited in ibid., paragraphs 0149 to 0150 may be used.

As the thiazineleuco compounds, oxazineleuco compounds and phenoxazineleuco compounds, compounds represented by formula (11) or (12) of JP-A-2007-87532 and recited in ibid., paragraphs 0156 to 0160 may be used.

As the leucotriarylmethane compounds, compounds having a partial structure represented by formula (13) of JP-A-2007-87532 and recited in ibid., paragraphs 0166 and 0167 are preferred.

Specific preferred examples of the dye precursor for use in the present invention, whose absorption band is caused to appear in the visible region by oxidation, include compounds recited in paragraph 0152 of JP-A-2007-87532 (leucoquinone compounds), compounds recited in ibid., paragraphs 0162 to 0164 (thiazineleuco compounds, oxazineleuco compounds, phenazineleuco compounds), and compounds recited in ibid., paragraphs 0169 to 0170 (leucotriarylmethane compounds), but the present invention is not limited thereto.

### (D) Dye Precursor Whose Absorption is Caused to Appear in the Visible Region by Reduction

As this dye precursor, a compound represented by formula (A) disclosed in JP-A-2007-87532 can be used and specifically, compounds recited in ibid., paragraphs 0172 to 0195 may be used.

Here, in the case where the “material capable of changing the fluorescence intensity between before and after two-photon recording” (hereinafter, sometimes referred to as a recording component) contains the above-described dye precursor, it is also preferred that the two-photon absorption recording material [A] of the present invention further contains a base as needed for the purpose of dissociating the produced dissociation-type dye. The base may be either an organic base or an inorganic base, and preferred examples thereof include alkylamines, anilines, imidazoles, pyridines, carbonates, hydroxide salts, carboxylates and metal alkoxide. A polymer containing such a base is also preferably used.

Incidentally, the dye precursor for use in the present invention may be a commercially available product or may be synthesized by a known method.

In the two-photon recording process, the spectral change due to color formation of a dye precursor in the moiety where recording by two-photon absorption recording is performed preferably appears in the wavelength region longer than the maximum wavelength in the linear absorption spectrum of the two-photon absorption dye. Alternatively, it is preferred that the absorption spectral change appears in the wavelength region shorter than the readout wavelength and at the same time, the absorption spectral change at the readout wavelength is not present.

In the two-photon recording process, it is preferred that the spectral change due to decoloring of a dye in the moiety where recording by two-photon absorption recording is performed appears at the readout wavelength or in the wavelength region shorter than the readout wavelength and the dye absorption at the readout wavelength is not present.

The recording material [A] of the present invention may contain, as the component other than the above-described components, an electron-donating compound capable of donating an electron to the two-photon absorption compound and/or a compound constituting the recording component, an acid generator and a base generator, if desired. Compounds recited in paragraphs 0199 to 0217 of JP-A-2007-87532 may be used as the electron-donating compound; compounds recited in ibid., paragraphs 0218 to 0245 may be used as the acid generator; and compounds recited in ibid., paragraphs 0246 to 0267 may be used as the base generator.

The material capable of modulating fluorescence by color formation of a dye or color formation of a fluorescent dye is described in more detail in JP-A-2007-87532.

[Material that Forms a Latent Image Capable of Modulating Fluorescence by Color Formation of a Dye]

The material that forms a latent image capable of modulating fluorescence by color formation of a dye includes those containing a dye precursor that develops color by oxidation reaction.

The dye precursor that develops color by oxidation reaction are not particularly limited as long as it is a compound capable of increasing in the absorbance by oxidation reaction, but it is preferred to contain at least any one or more kinds of compounds selected from leucoquinone compounds, thiazineleuco compounds, oxazineleuco compounds, phenazineleuco compounds and leucotriarylmethane compounds.

Preferred examples of the leucoquinone compounds, thiazineleuco compounds, oxazineleuco compounds, phenazineleuco compounds and leucotriarylmethane compounds include the above-described compounds, and these compounds may be used.

The material that forms a latent image capable of modulating fluorescence by color formation of a dye is described in more detail in JP-A-2005-320502.

[Material that Forms a Latent Image Capable of Modulating Fluorescence by Polymerization]

The material that forms a latent image capable of modulating fluorescence by polymerization is composed of:

1) a dye precursor whose absorption is shifted from the original state to the longer wavelength side due to electron transfer or energy transfer from the excited state of the two-photon absorption compound and which can become a color former having absorption in the wavelength region where the molar extinction coefficient of linear absorption of the two-photon absorption compound is 5,000 or less (hereinafter, sometimes simply referred to as a dye precursor),
2) a polymerization initiator capable of initiating polymerization of a polymerizable compound as a result of electron transfer or energy transfer from the excited state of the two-photon absorption compound (hereinafter, sometimes simply referred to as a polymerization initiator),
3) a polymerizable compound, and
4) a binder.

### (Dye Precursor)

The dye precursor in this item is preferably a dye precursor capable of becoming a color former whose absorption is shifted from the original state to the longer wavelength side as a result of direct electron transfer or energy transfer from the excited state of the two-photon absorption compound or color former, or by the action of an acid or base generated as a result of electron transfer or energy transfer from the excited state of the two-photon absorption compound or color former to an acid generator or a base generator.

In the two-photon absorption recording material [A] using the dye precursor of this item, the color former preferably has no or substantially no absorption at the readout light wavelength during reproduction.

Accordingly, the dye precursor preferably becomes a color former having no absorption at the readout light wavelength and having absorption on the wavelength side shorter than the readout light wavelength.

On the other hand, even in the case of having absorption at the readout light wavelength, the color former preferably decomposes in the process of causing polymerization by exciting the latent image or in the subsequent fixing process and loses its absorbing and sensitizing function.

The dye precursor in this item includes preferably the following combinations:

A) a combination containing at least an acid-induced color formation-type dye precursor as the dye precursor and further an acid generator and, if desired, additionally containing an acid-increasing agent,
B) a combination containing at least a base-induced color formation-type dye precursor as the dye precursor and further a base generator and, if desired, additionally containing a base-increasing agent,
C) a case of containing a compound where an organic compound moiety having a function of breaking a covalent bond by electron transfer or energy transfer with the excited state of the two-photon absorption compound or color former and an organic compound moiety having a property of becoming a color former when covalently bonded and when released, are bonded by a covalent bond, or a combination further containing a base,
D) a case of containing a compound capable of undergoing a reaction by electron transfer with the excited state of the two-photon absorption compound or color former and thereby changing the absorption form.

In all cases, when an energy transfer mechanism from the excited state of the two-photon absorption compound or color former is utilized, the mechanism may be either the Foerster mechanism where energy transfer takes place from the singlet excited state of the two-photon absorption compound or color former, or the Dexter mechanism where energy transfer takes place from the triplet excited state.

At this time, for causing efficient energy transfer, the excitation energy of the two-photon absorption compound or color former is preferably larger than the excitation energy of the dye precursor.

On the other hand, in the case of the electron transfer mechanism from the excited state of the two-photon absorption compound or color former, the mechanism may either a mechanism where electron transfer takes place from the singlet excited state of the two-photon absorption compound or color former, or a mechanism where electron transfer takes place from the triplet excited state.

Also, the excited state of the two-photon absorption compound or color former may donate an electron to or receive an electron from the dye precursor, acid generator or base generator. In the case of donating an electron from the excited state of the two-photon absorption compound or color former, for causing efficient electron transfer, the energy of the orbital where an excited electron in the excited state of the two-photon absorption compound or color former is present (LUMO) is preferably higher than the energy of LUMO orbital of the dye precursor, acid generator or base generator.

In the case of an electron being received by the excited state of the two-photon absorption compound or color former, for causing efficient electron transfer, the energy of the orbital where a hole in the excited state of the two-photon absorption compound or color former is present (HOMO) is preferably lower than the energy of HOMO orbital of the dye precursor, acid generator or base generator.

Preferred combinations of the dye precursor are described in detail below.

First, a case where the dye precursor is an acid-induced color formation-type dye precursor and an acid generator is further contained is described.

At this time, the acid generator is a compound capable of generating an acid by energy transfer or electron transfer from the excited state of the two-photon absorption compound or color former. The acid generator is preferably stable in a dark place. The acid generator in this item is preferably a compound capable of generating an acid by electron transfer from the excited state of the two-photon absorption compound or color former.

The acid generator in the dye precursor of this item includes preferably the following six systems, and preferred examples are the same as those of the cationic polymerization initiator described later.

That is, 1) a trihalomethyl-substituted triazine-based acid generator, 2) a diazonium salt-based acid generator, 3) a diaryl iodonium salt-based acid generator, 4) a sulfonium salt-based acid generator, 5) a metal arene complex-based acid generator, and 6) a sulfonic acid ester-based acid generator are preferred, and 3) a diaryl iodonium salt-based acid generator, 4) a sulfonium salt-based acid generator and 6) a sulfonic acid ester-based acid generator are more preferred.

Incidentally, in the case of using a cationic polymerization initiator and an acid-induced color formation-type dye precursor at the same time, the same compound preferably fulfils the functions of the cationic polymerization initiator and the acid generator. Here, two or more of these acid generators may be used as a mixture in an arbitrary ration, if desired.

The acid-induced color formation-type dye precursor in the case where the dye precursor of this item is an acid-induced color formation-type dye precursor and the dye precursor further contains an acid generator is described.

The acid-induced color formation-type dye precursor in this item is a dye precursor capable of becoming a color former whose the absorption is changed from the original state by an acid generated from the acid generator. The acid-induced color formation-type dye precursor in this item is preferably a compound whose absorption is shifted to the longer wavelength side by an acid, more preferably a compound that is caused to develop color from the colorless state by an acid.

The acid-induced color formation-type dye precursor includes preferably a triphenylmethane-based compound, a phthalide-based compound (including a indolylphthalide-based compound, an azaphthalide-based compound, and a triphenylmethanephthali de-based compound), a phenothiazine-based compound, a phenoxazine-based compound, a fluoran-based compound, a thiofluoran-based compound, a xanthene-based compound, a diphenylmethane-based compound, a chromenopyrazole-based compound, a leucoauramine-based compound, a methine-based compound, an azomethine-based compound, a rhodamine lactam-based compound, a quinazoline-based compound, a diazaxanthene-based compound, a fluorene-based compound, and a spiropyran-based compound. The dye precursor is more preferably a leuco dye having a partial structure such as lactone, lactam, oxazine or spiropyran, and this leuco dye includes a fluoran-based compound, a thiofluoran-based compound, a phthalide-based compound, a rhodamine lactam-based compound, and a spiropyran-based compound. Specific examples of these compounds are disclosed in JP-A-2002-156454 and patents cited therein, JP-A-2000-281920, JP-A-11-279328 and JP-A-8-240908.

The dye generated from the acid-induced color formation-type dye precursor of this item is preferably a xanthenes dye, a fluoran dye or a triphenylmethane dye.

Incidentally, two or more of these acid-induced color formation-type dye precursors may be used as a mixture in an arbitrary ratio, if desired.

Specific preferred examples of the acid-induced color formation-type dye precursor for use in the present invention include the above-described compounds, and these compounds may be used.

When the dye precursor group in this item contains at least the acid-induced color formation-type dye precursor as the dye precursor and an acid generator, the dye precursor may further contain an acid-increasing agent.

The acid-increasing agent is a compound that is stable in the absence of an acid but decomposes in the presence of an acid to release an acid and increases an acid by using, as a trigger, a small amount of an acid generated from an acid generator such that the released acid decomposes another acid-increasing agent to release an acid again.

Preferred examples of the acid-increasing agent include compounds having a structure represented by formulae (34-1) to (34-6) of JP-A-2005-97538. More preferred specific examples include compounds recited in ibid., paragraphs 0299 to 0301.

The system is preferably heated during the acid-increasing process and therefore, a heat treatment is preferably applied in the process of initiating polymerization by exciting a latent image or in the fixing process different therefrom.

Next, a case where the dye precursor is a base-induced color formation-type dye precursor and further contains a base generator is described.

At this time, the base generator is a compound capable of generating a base by energy transfer or electron transfer from the excited state of the two-photon absorption compound or color former. The base generator is preferably stable in a dark place. The base generator in this item is preferably a compound capable of generating a base by electron transfer from the excited state of the two-photon absorption compound or color former.

The base generator of this item preferably generates a Bronsted base by light, more preferably generates an organic base, still more preferably generates amines as the organic base.

Incidentally, in the case of using an anionic polymerization and a base-induced color formation-type dye precursor at the same time, the same compound preferably fulfills the functions of the anionic polymerization initiator and the base generator.

Incidentally, two or more base generators may be used as a mixture in an arbitrary ratio, if desired.

The base-induced color formation-type dye precursor in the case where the dye precursor in this item is a base-induced color formation-type dye precursor and further contains a base generator is described below.

The base-induced color formation-type dye precursor in this item is a dye precursor capable of becoming a color former whose absorption is changed from the original state by a base generated from the base generator.

The base-induced color formation-type dye precursor in this item is preferably a compound whose absorption is shifted to the longer wavelength side by a base, more preferably a compound that is caused to develop color from the colorless state by a base.

Specific preferred examples of the base-induced color formation-type dye precursors in this item include the above-described compounds, and these compounds may be used.

In the case where the dye precursor in this item is a base-induced color formation-type dye precursor, the dye precursor may further contain a base-increasing agent, in addition to a base generator.

The base-increasing agent in this item is a compound that is stable in the absence of a base but decomposes in the presence of a base to release a base and increases a base by using, as a trigger, a small amount of a base generated from the base-increasing agent such that the released base decomposes another base-increasing agent to release a base again.

The base-increasing agent includes compounds having a structure represented by formulae (34-1) to (34-6) of JP-A-2005-97538 and recited in ibid., paragraph 0287. More preferred specific examples include compounds recited in ibid., paragraphs 0299 to 0301.

The system is preferably heated during the base-increasing process and therefore, in the case of using a base-increasing agent, a heat treatment is preferably applied in the process of initiating polymerization by exciting a latent image or in the fixing process different therefrom.

A case of the dye precursor in this item being a compound where an organic compound moiety having a function of breaking a covalent bond by electron transfer or energy transfer with the excited state of the two-photon absorption compound or color former and an organic compound moiety having a property of becoming a color former when covalently bonded and when released, are bonded by a covalent bond is described below.

The compound that can be used in this item includes a compound represented by formula (32) of JP-A-2005-97538, more specifically, compounds having a structure recited in ibid., paragraphs 0326 to 0348.

It is also preferred that the two-photon absorption recording material [A] of the invention further contains a base, if desired, for the purpose of dissociating the produced dissociation-type dye. The base may be either an organic base or an inorganic base, and preferred examples thereof include alkylamines, anilines, imidazoles, pyridines, carbonates, hydroxide salts, carboxylates, and metal alkoxides. A polymer containing such a base is also preferred.

A case where the dye precursor in this item is a compound capable of undergoing a reaction by electron transfer with the excited state of the two-photon absorption compound or color former and thereby changing the absorption form is described below. The compounds capable of causing the above change are collectively termed a so-called “electrochromic compound”.

The electrochromic compound used as the dye precursor in this item is preferably polypyrroles (preferably, for example, polypyrrole, poly(N-methylpyrrole), poly(N-methylindole) or polypyrrolopyrrole), polythiophenes (preferably, for example, polythiophene, poly(3-hexylthiophene), polyisothianaphthene, polydithienothiophene or poly(3,4-ethylenedioxy)thiophene), polyaniline (preferably, for example, polyaniline, poly(N-naphthylaniline), poly(o-phenylenediamine), poly(aniline-m-sulfonic acid), poly(2-methoxyaniline), poly(o-aminophenol)), poly(diarylamine) or poly(N-vinylcarbazole), a Co-pyridinoporphyrazine complex, an Ni phenanthroline complex, or an Fe basophenanthroline complex.

In addition, an electrochromic material such as viologens, polyviologens, lanthanoid diphthalocyanines, styryl dyes, TNFs, TCNQ/TTF complexes, and Ru trisbipyridyl complexes is also preferred.

Also, in the case where the dye precursor is a compound capable of undergoing a reaction by electron transfer with the excited state of the two-photon absorption compound or color former and thereby changing the absorption form, the dye precursor in this item is preferably at least a compound having a structure represented by formula (37) of JPA-2005-97538, more specifically, a compound having a structure recited in ibid., paragraphs 0352 to 0352. Specific preferred examples include compounds recited in ibid., paragraph 0354.

The dye precursor in this item may be a commercially available produce or may be synthesized by a known method.

### (Polymerization Initiator)

The polymerization initiator is described below. The polymerization initiator for use in the present invention is a compound capable of undergoing energy transfer or electron transfer (donating an electron or receiving an electron) from the excited state of the two-photon absorption compound, which is produced by non-resonant two-photon absorption, and thereby generating a radical or an acid (Bronsted acid or Lewis acid) to initiate the polymerization of a polymerizable compound.

The polymerization initiator for use in the present invention is preferably any one of a radical polymerization initiator capable of generating a radical to initiate the radical polymerization of a polymerizable compound, a cationic polymerization initiator capable of generating only an acid without generating a radical, to initiate only the cationic polymerization of a polymerizable compound, and a polymerization initiator capable of generating both a radical and an acid to initiate both the radical polymerization and the cationic polymerization.

The preferred polymerization initiator includes the following 13 systems. Incidentally, two or more of these polymerization initiators may be used as a mixture in an arbitrary ratio, if desired.

1) A ketone-based polymerization initiator
2) An organic peroxide-based polymerization initiator
3) A bisimidazole-based polymerization initiator
4) A trihalomethyl-substituted triazine-based polymerization initiator
5) A diazonium salt-based polymerization initiator
6) A diaryl iodonium salt-based polymerization initiator
7) A sulfonium salt-based polymerization initiator
8) A borate-based polymerization initiator
9) A diaryl iodonium-organic boron complex-based polymerization initiator
10) A sulfonium-organic boron complex-based polymerization initiator
11) A metal arene complex-based polymerization initiator
12) A sulfonic acid ester-based polymerization initiator

Preferred examples of the polymerization initiators above include compounds recited in paragraphs 0117 to 0120 of JP-A-2005-29725 (ketone-based polymerization initiators), ibid., paragraph 0122 (organic peroxide-based polymerization initiators), ibid., paragraphs 0124 to 0125 (bisimidazole-based polymerization initiators), ibid., paragraphs 0127 to 0130 (trihalomethyl-substituted triazine-based polymerization initiators), ibid., paragraphs 0132 to 0135 (diazonium salt-based polymerization initiators), ibid., paragraphs 0137 to 0140 (diaryl iodonium salt-based polymerization initiators), ibid., paragraphs 0142 to 0145 (sulfonium salt-based polymerization initiators), ibid., paragraphs 0147 to 0150 (borate-based polymerization initiators), ibid., paragraphs 0153 to 0157 (diaryl iodonium-organic boron complex-based polymerization initiators), ibid., paragraphs 0159 to 0164 (sulfonium-organic boron complex-based polymerization initiators), ibid., paragraph 0179 (metal arene-based polymerization initiators), and ibid., paragraphs 1081 to 0182 (sulfonic acid ester-based polymerization initiators).

13) Other polymerization initiators

Polymerization initiators other than 1) to 12) above include an organic azide compound such as 4,4′-diazidochalcone, an aromatic carboxylic acid such as N-phenylglycine, a polyhalogen compound (Cl₄, CHI₃, CBrCI₃), a phenylisoxazolone, a silanol-aluminum complex, an aluminate complex described in JP-A-3-209477, and the like.

Here, the polymerization initiators for use in the present invention can be classified into the followings:

a) a polymerization initiator capable of activating radical polymerization,
b) a polymerization initiator capable of activating only cationic polymerization, and
c) a polymerization initiator capable of activating radical polymerization and cationic polymerization simultaneously.

The a) polymerization initiator capable of activating radical polymerization indicates a polymerization initiator capable of generating a radical by performing energy transfer or electron transfer (donating an electron to a two-photon absorption compound or receiving an electron from a two-photon absorption compound) from the excited state of a two-photon absorption compound produced by non-resonant two-photon absorption, and thereby initiating radical polymerization of a polymerizable compound.

Out of those described above, the following systems are a polymerization initiator system capable of activating radical polymerization: 1) a ketone-based polymerization initiator, 2) an organic peroxide-based polymerization initiator, 3) a bisimidazole-based polymerization initiator, 4) a trihalomethyl-substituted triazine-based polymerization initiator, 5) a diazonium salt-based polymerization initiator, 6) a diaryl iodonium salt-based polymerization initiator, 7) a sulfonium salt-based polymerization initiator, 8) a borate-based polymerization initiator, 9) a diaryl iodonium-organic boron complex-based polymerization initiator, 10) a sulfonium-organic boron complex-based polymerization initiator, and 11) a metal arene complex-based polymerization initiator.

Among the polymerization initiators capable of activating radical polymerization, 1) a ketone-based polymerization initiator, 3) a bisimidazole-based polymerization initiator, 4) a trihalomethyl-substituted triazine-based polymerization initiator, 6) a diaryl iodonium salt-based polymerization initiator and 7) a sulfonium salt-based polymerization initiator are preferred, and 3) a bisimidazole-based polymerization initiator, 6) a diaryl iodonium salt-based polymerization initiator, and 7) a sulfonium salt-based polymerization initiator are more preferred.

The polymerization initiator capable of activating only cationic polymerization indicates a polymerization initiator capable of generating an acid (a Bronsted acid or a Lewis acid) without generating a radical by performing energy transfer or electron transfer from the excited state of a two-photon absorption compound produced by non-resonant two-photon absorption, and initiating cationic polymerization of a polymerizable compound by the acid.

Out of the systems above, the following system is a polymerization initiator system capable of activating only cationic polymerization: 12) a sulfonic acid ester-based polymerization initiator.

Incidentally, compounds described, for example, in S. PETERPAPPAS (compiler), UV CURING; SCIENCE AND TECHNOLOGY, pp. 23-76, A TECHNOLOGY MARKETING PUBLICATION; and B. KLINGERT, M. RIEDIKER and A. ROLOFF, Comments Inorg. Chem., Vol. 7, No. 3, pp. 109-138 (1988) can be also be used as the cationic polymerization initiator.

The polymerization initiator capable of activating radical polymerization and cationic polymerization simultaneously is a polymerization initiator capable of generating a radical and an acid (a Bronsted acid or a Lewis acid) at the same time by performing energy transfer or electron transfer from the excited state of a two-photon absorption compound produced by non-resonant two-photon absorption, and initiating radical polymerization of a polymerizable compound by the radical generated and cationic polymerization of a polymerizable compound by the acid generated.

Out of the systems above, the following systems are the polymerization initiator system capable of activating radical polymerization and cationic polymerization simultaneously: 4) a trihalomethyl-substituted triazine-based polymerization initiator, 5) a diazonium salt-based polymerization initiator, 6) a diaryl iodonium salt-based polymerization initiator, 7) a sulfonium salt-based polymerization initiator, and 11) a metal arene complex-based polymerization initiator.

Among the polymerization initiators capable of activating radical polymerization and cationic polymerization simultaneously, 6) a diaryl iodonium salt-based polymerization initiator and 7) a sulfonium salt-based polymerization initiator are preferred.

### (Polymerizable Compound)

The polymerizable compound is a compound capable of causing addition polymerization by a radical or an acid (a Bronsted acid or a Lewis acid) and thereby undertaking oligomerization or polymerization.

The polymerizable compound may be either monofunctional or polyfunctional, may be composed of either one component or multiple components, or may be any of a monomer, a prepolymer (e.g., dimer, oligomer) and a mixture thereof. Also, its form may be either a liquid or a solid.

The polymerizable compounds are roughly classified into a polymerizable compound capable of radical polymerization and a polymerizable compound capable of cationic polymerization.

The radical polymerizable compound is preferably a compound having at least one ethylenically unsaturated double bone within the molecule and specifically includes the following polymerizable monomers and prepolymers (e.g., dimer, oligomer) composed of such a polymerizable monomer. These may be either a monofunctional type or a polyfunctional type. Examples thereof include an ethylenically unsaturated acid compound, an aliphatic or aromatic functional group-containing (meth)acrylate, and an amide monomer of an unsaturated carboxylic acid with an aliphatic polyvalent amine compound. As for specific examples, compounds recited in paragraphs 0019 to 0026 of JP-A-2005-29725 may be used.

Furthermore, as for the radical polymerizable compound, compounds recited in paragraph 0027 of JP-A-2005-29725 (polyisocyanate compounds), ibid., paragraph 0028 (urethane acrylates), and ibid., paragraph 0030 (phosphorus-containing monomers), and described as commercial products in ibid., paragraphs 0031 to 0032 may be used.

In addition, those described as a photocurable monomer or an oligomer in Journal of the Adhesion Society of Japan, Vol. 20, No. 7, pp. 300-330 may be also used.

The cationic polymerizable compound is a compound capable of initiating the polymerization by an acid generated using the two-photon absorption compound and the cationic polymerization initiator and includes, for example, compounds described in J. V. Crivello, Chemtech. Oct., page 624 (1980); JP-A-62-149784; and Journal of the Adhesion Society of Japan, Vol. 26, No. 5, pp. 179-187 (1990).

The cationic polymerizable compound is preferably a compound having at least one oxirane ring, oxetane ring or vinyl ether moiety within the molecule, more preferably a compound having an oxirane ring. Specifically, the cationic polymerizable compound includes the following cationic polymerizable monomers and prepolymers (e.g., dimer, oligomer) composed of such a cationic polymerizable monomer.

Specific examples of the cationic polymerizable monomer having an oxirane ring include compounds recited in paragraphs 0035 to 0036 of JP-A-2005-29725.

Specific examples of the cationic polymerizable monomer having an oxetane ring include compounds described above as specific examples of the cationic polymerizable monomers having an oxirane ring, where oxirane is replaced by an oxetane ring. Specifically, the monomer includes compounds recited in paragraph 0038 of JP-A-2005-29725.

### (Binder)

The binder is usually used for the purpose of enhancing the film-forming property of the composition before polymerization, the uniformity of film thickness, or the stability during storage. The binder preferably has good compatibility with the polymerizable compound, polymerization initiator and two-photon absorption compound.

The binder is preferably a solvent-soluble thermoplastic polymer, and one of these polymers may be used alone or several kinds thereof may be used in combination.

Specific preferred examples of the binder include an acrylate, an α-alkyl acrylate ester, an acidic polymer, an interpolymer (for example, polymethyl methacrylate, polyethyl methacrylate, and a copolymer of methyl methacrylate and another alkyl (meth)acrylate ester), a polyvinyl ester (e.g., polyvinyl acetate, polyvinyl acetate/acrylate, polyvinyl acetate/methacrylate, hydrolyzable polyvinyl acetate), an ethylene/vinyl acetate copolymer, a saturated or unsaturated polyurethane, a butadiene or isoprene polymer or copolymer, a high molecular weight polyethylene oxide of polygycol having an average molecular weight of substantially from 4,000 to 1,000,000, an epoxidized product (for example, an epoxidized product having an acrylate or methacrylate group), a polyamide (e.g., N-methoxymethylpolyhexamethylene adipamide), a cellulose ester (e.g., cellulose acetate, cellulose acetate succinate, cellulose acetate butyrate), a cellulose ether (e.g., methyl cellulose, ethyl cellulose, ethylbenzyl cellulose), a polycarbonate, a polyvinylacetal (e.g., polyvinylbutyral, polyvinylformal), a polyvinyl alcohol, a polyvinylpyrrolidone, acid-containing polymers and copolymers disclosed in U.S. Pat. Nos. 3,458,311 and 4,273,857, and amphoteric polymer binders disclosed in U.S. Pat. No. 4,293,635. More preferred examples include a cellulose acetate butyrate polymer, a cellulose acetate lactate polymer, an acrylic polymer or interpolymer containing polymethyl methacrylate and copolymers of methyl methacrylate/methacrylic acid and methyl methacrylate/acrylic acid, a terpolymer of methyl methacrylate/C2-C4 alkyl acrylate or methacrylate/acrylic or methacrylic acid, a polyvinyl acetate, a polyvinylacetal, a polyvinylbutyral, a polyvinylformal, and a mixture thereof

A fluorine atom-containing polymer is also preferred as the binder. The fluorine atom-containing polymer is preferably an organic solvent-soluble polymer containing a fluoroolefin as the essential component and containing, as the copolymerization component, one unsaturated monomer or two or more unsaturated monomers selected from an alkyl vinyl ether, an alicyclic vinyl ether, a hydroxy vinyl ether, an olefin, a haloolefin, an unsaturated carboxylic acid or an ester thereof, and a vinyl carboxylate. This polymer preferably has a mass average molecular weight of 5,000 to 200,000 and a fluorine atom content of 5 to 70 mass %.

Examples of the fluoroolefin used in the fluorine atom-containing polymer include tetrafluoroethylene, chlorotrifluoroethylene, vinyl fluoride and vinylidene fluoride. Examples of the alkyl vinyl ether as the other copolymerization component include ethyl vinyl ether, isobutyl vinyl ether and n-butyl vinyl ether. Examples of the alicyclic vinyl ether include cyclohexyl vinyl ether and its derivatives. Examples of the hydroxy vinyl ether include hydroxybutyl vinyl ether. Examples of the olefin and haloolefin include ethylene, propylene, isobutylene, vinyl chloride and vinylidene chloride. Examples of the vinyl carboxylate include vinyl acetate and n-vinyl butyrate. Examples of the unsaturated carboxylic acid or an ester thereof include an unsaturated carboxylic acid such as (meth)acrylic acid and crotonic acid; C1-C18 alkyl esters of a (meth)acrylic acid, such as methyl (meth)acrylate, ethyl (meth)acrylate, propyl (meth)acrylate, isopropyl (meth)acrylate, butyl (meth)acrylate, hexyl (meth)acrylate, octyl (meth)acrylate and lauryl (meth)acrylate; C2-C8 hydroxyalkyl esters of a (meth)acrylic acid, such as hydroxyethyl (meth)acrylate and hydroxypropyl (meth)-acrylate; an N,N-dimethylaminoethyl (meth)acrylate; and an N,N-diethylaminoethyl (meth)acrylate. One of these radical polymerizable monomers may be used alone, or two or more kinds thereof may be used in combination. Furthermore, if desired, a part of the monomer may be replaced by another radical polymerizable monomer, for example, a vinyl compound such as styrene, α-methylstyrene, vinyltoluene and (meth)acrylonitrile. Also, other monomer derivatives such as carboxylic acid group-containing fluoroolefin and glycidyl group-containing vinyl ether may be used.

Specific examples of the above-described fluorine atom-containing polymer include “Lumifron” series having a hydroxyl group and being soluble in an organic solvent (for example, Lumifron LF200, weight average molecular weight: about 50,000, produced by Asahi Glass Company, Ltd.). In addition, organic solvent-soluble fluorine atom-containing polymers are commercially available from Daikin Kogyo Co., Ltd., Central Glass Co., Ltd., Penwalt and the like, and these can also be used.

Many of these binders form a non-three-dimensional crosslinked structure. The binder having a structure that forms a three-dimensional crosslinked structure is described below.

(Binder that Forms Three-Dimensional Crosslinked Structure)

Many of the above-described binders form a non-three-dimensional crosslinked structure, but in the optical recording material of the present invention, a binder that forms a three-dimensional crosslinked structure may be also used. The binder that forms a three-dimensional crosslinked structure is preferred in terms of enhancing the coatability, film strength and recording performance. Incidentally, the “binder that forms a three-dimensional crosslinked structure” is referred to as “matrix”.

The matrix contains a component for forming the three-dimensional crosslinked structure, and this component for use in the present invention may contain a thermal crosslinking compound. As the crosslinking compound, a thermal crosslinking compound and a photocurable compound that is cured by using a catalyst or the like and irradiating the compound with light, may be used, and a thermal crosslinking compound is preferred.

The thermal crosslinking matrix for use in the present invention is not particularly limited and may be appropriately selected according to the purpose, but examples thereof include a urethane resin formed from an isocyanate compound and an alcohol compound, an epoxy compound formed from an oxirane compound, and a polymer obtained by polymerizing a melamine compound, a formalin compound, an ester compound of an unsaturated acid, such as (meth)acrylic acid or itaconic acid, or an amide compound. Above all, a polyurethane matrix formed from an isocyanate compound and an alcohol compound is preferred and in consideration of recording preservability, a polyurethane matrix formed from a polyfunctional isocyanate and a polyfunctional alcohol is most preferred.

Specific examples of the polyfunctional isocyanate and polyfunctional alcohol which can form a polyurethane matrix are described below.

Specific examples of the polyfunctional isocyanate include biscyclohexylmethane diisocyanate, hexamethylene diisocyanate, phenylene-1,3-diisocyanate, phenylene-1,4-diisocyanate, 1-methoxyphenylene-2,4-diisocyanate, 1-methylphenylene-2,4-diisocyanate, 2,4-tolylene diisocyanate, 2,6-tolylene diisocyanate, 1,3-xylylene diisocyanate, 1,4-xylylene diisocyanate, biphenylene-4,4′-diisocyanate, 3,3′-dimethoxybiphenylene-4,4′-diisocyanate, 3,3′-dimethylbiphenylene-4,4′-diisocyanate, diphenylmethane-2,4′-diisocyanate, diphenylmethane-4,4′-diisocyanate, 3,3′-dimethoxydiphenylmethane-4,4′-diisocyanate, 3,3′-dimethyldiphenylmethane-4,4′-diisocyanate, naphthylene-1,5-diisocyanate, cyclobutylene-1,3-diisocyanate, cyclopentylene-1,3-diisocyanate, cyclohexylene-1,3-diisocyanate, cyclohexylene-1,4-diisocyanate, 1-methylcyclohexylene-2,4-diisocyanate, 1-methylcyclohexylene-2,6-diisocyanate, 1-isocyanate-3,3,5-trimethyl-5-isocyanatomethylcyclohexane, cyclohexane-1,3-bis(methylisocyanate), cyclohexane-1,4-bis(methylisocyanate), isophorone diisocyanate, dicyclohexylmethane-2,4′-diisocyanate, dicyclohexylmethane-4,4′-diisocyanate, ethylene diisocyanate, tetramethylene-1,4-diisocyanate, hexamethylene-1,6-diisocyanate, dodecamethylene-1,12-diisocyanate, phenyl-1,3,5-triisocyanate, diphenylmethane-2,4,4′-triisocyanate, diphenylmethane-2,5,4′-triisocyanate, triphenylmethane-2,4′,4″-triisocyanate, triphenylmethane-4,4′,4″-triisocyanate, diphenylmethane-2,4,2′,4′-tetraisocyanate, diphenylmethane-2,5,2′,5′-tetraisocyanate, cyclohexane-1,3,5-triisocyanate, cyclohexane-1,3,5-tris(methylisocyanate), 3,5-dimethylcyclohexane-1,3,5-tris(methylisocyanate), 1,3,5-trimethylcyclohexane-1,3,5-tris(methylisocyanate), dicyclohexylmethane-2,4,2′-triisocyanate, dicyclohexylmethane-2,4,4′-triisocyanatelysine diisocyanate methyl ester, and a prepolymer with isocyanate at both ends obtained by reacting such an organic isocyanate compound in excess of the stoichiometric amount with a polyfunctional active hydrogen-containing compound. Among these, biscyclohexylmethane diisocyanate and hexamethylene diisocyanate are preferred. One of these may be used alone, or two or more kinds thereof may be used in combination.

The polyfunctional alcohol may be a polyfunctional alcohol alone or a mixture with other polyfunctional alcohols. Examples of the polyfunctional alcohol include glycols such as ethylene glycol, triethylene glycol, diethylene glycol, polyethylene glycol, propylene glycol, polypropylene glycol and neopentyl glycol; diols such as butanediol, pentanediol, hexanediol, heptanediol and tetramethylene glycol; bisphenols or compounds obtained by modifying such a polyfunctional alcohol with a polyethyleneoxy or polypropyleneoxy chain; glycerin; trimethylolpropane; and triols such as butanetriol, pentanetriol, hexanetriol and decanetriol or compounds obtained by modifying such a polyfunctional alcohol with a polyethyleneoxy or polypropyleneoxy chain.

In the above-described two-photon absorption recording material, an electron-donating compound having an ability of reducing the radical cation of the two-photon absorption compound or color former, or an electron-accepting compound having an ability of oxidizing the radical anion of the two-photon absorption compound or color former can be preferably used. In particular, use of an electron-donating compound is more preferred in view of enhancing the coloring speed.

Preferred examples of the electron-donating compound for use in the present invention include compounds recited in paragraph 0357 of JP-A-2005-97538, and compounds recited above as examples of the compound usable in [Material capable of modulating fluorescence by color formation of a fluorescent dye]. On the other hand, preferred examples of the electron-accepting compound for use in the present invention include compounds recited in ibid., paragraph 0358 and compounds recited in paragraphs 2022 to 0212 of JP-A-2007-87532.

The oxidation potential of the electron-donating compound is preferably baser (on the minus side) than the oxidation potential of the two-photon absorption compound or color former or than the reduction potential of the excited state of the two-photon absorption compound or color former, and the reduction potential of the electron-accepting compound is preferably nobler (on the plus side) than the reduction potential of the two-photon absorption compound or color former or than the oxidation potential of the excited state of the two-photon absorption compound or color former.

The material that forms a latent image capable of modulating fluorescence by polymerization is described in more detail in JP-A-2005-97538.

### [Other Components]

In the two-photon absorption recording material [A] of the present invention, a binder may be further used. The binder for use in the two-photon absorption recording material [A] is not particularly limited and may be an organic polymer compound or an inorganic polymer compound. The organic polymer compound is preferably a solvent-soluble thermoplastic polymer, and one polymer may be used alone or some polymers may be used in combination. A compound well compatible with various components dispersed in the two-photon absorption recording material [A] is preferred.

As for the binder used in the recording material [A] of the present invention, all of the compounds recited as preferred examples of the usable binder in the item of [Material that forms a latent image capable of modulating fluorescence by polymerization] can be used. Other specific examples include compounds recited in paragraph 0022 of JP-A-2005-320502 (e.g., acrylate, alpha-alkyl acrylate ester, acidic polymer, interpolymer, polyvinyl ester, ethylene/vinyl acetate copolymer, saturated or unsaturated polyurethane, butadiene or isoprene polymer or copolymer, high molecular weight polyethylene oxide of polyglycol, epoxy compound, cellulose ester, cellulose ether, polycarbonate, norbornene-based polymer, polyvinyl acetal, polyvinyl alcohol, polyvinylpyrrolidone); and a polystyrene polymer or copolymer, a polymer produced from a reaction product of a copolyester polymethylene glycol and an aromatic acid compound or a mixture thereof, a poly-N-vinyl carbazole or a copolymer thereof, and a carbazole-containing polymer recited in the same paragraph. Furthermore, specific preferred examples include fluorine atom-containing polymers recited in ibid., paragraphs 0023 to 0024.

The binder for use in the present invention is preferably an acrylate, an alpha-alkyl acrylate ester, a polystyrene, a polyalkylsytrene or a polystyrene copolymer, and in view of enhancing the detection sensitivity, more preferably an acrylate, an alpha-alkyl acrylate, a polystyrene or a polystyrene copolymer. As for specific examples thereof, examples of the acrylate and alpha-alkyl acrylate ester include methyl (meth)acrylate, ethyl (meth)acrylate, propyl (meth)acrylate, butyl (meth)acrylate, isobutyl (meth)acrylate, pentyl (meth)acrylate, hexyl (meth)acrylate, octyl (meth)acrylate, 2-ethylhexyl (meth)acrylate, lauryl (meth)acrylate, stearyl (meth)acrylate, and cyclohexyl (meth)acrylate; and examples of the (meth)acrylate having a benzene ring include benzyl (meth)acrylate, phenoxyethyl (meth)acrylate, phenoxypolyethylene glycol (meth)acrylate, and nonylphenol ethylene oxide adduct (meth)acrylate. In particular, benzyl (meth)acrylate and phenoxyethyl (meth)acrylate are preferred as the (meth)acrylate having a benzene ring. Only one kind of such a monomer may be used, or two or more kinds thereof may be used in combination. In the (meth)acrylate-based copolymer, other copolymerizable monomers copolymerizable with an alkyl (meth)acrylate, a benzene ring-containing (meth)acrylate or a nitrogen-containing radical polymerizable monomer may be copolymerized, and examples of the other copolymerizable monomers include alkyl vinyl ethers such as allyl glycidyl ether, methyl vinyl ether, ethyl vinyl ether, isobutyl vinyl ether, n-butyl vinyl ether, 2-ethylhexyl vinyl ether, n-octyl vinyl ether, lauryl vinyl ether, cetyl vinyl ether and stearyl vinyl ether; alkoxyalkyl (meth)acrylates such as methoxyethyl (meth)acrylate and butoxyethyl (meth)acrylate; glycidyl (meth)acrylate; vinyl acetate; vinyl propionate; (anhydrous) maleic acid; acrylonitrile; and vinylidene chloride. A compound having a hydrophilic polar group may be also copolymerized, and examples of the polar group include —SO₃M, —PO(OM)₂, and —COOM (wherein M represents a hydrogen atom, an alkali metal or ammonium).

Examples of the polyalkylstyrene compound include polymethylstyrene, polyethylstyrene, polypropylstyrene, polybutylstyrene, polyisobutylstyrene, polypentylstyrene, hexylpolystyrene, polyoctylstyrene, poly-2-ethylhexylstyrene, polylaurylstyrene, polystearylstyrene, and polycyclohexylstyrene; and examples of the (meth)acrylate having a benzene ring include polybenzylstyrene, polyphenoxyethylstyrene, polyphenoxy polyethylene glycol styrene, and polynonylphenolstyrene. The position of the alkyl is preferably the α- or para-position. Only one kind of such a monomer may be used, or two or more kinds thereof may be used in combination. In the polystyrene copolymer, other copolymerizable monomers copolymerizable with a conjugated diene compound, an alkylstyrene, a benzene ring-containing styrene or a nitrogen-containing radical polymerizable monomer may be copolymerized, and examples of the other copolymerizable monomers include acetylene, butadiene, acrylonitrile, vinylidene chloride, polyethylene, allyl glycidyl ether, methyl vinyl ether, ethyl vinyl ether, isobutyl vinyl ether, n-butyl vinyl ether, 2-ethylhexyl vinyl ether, n-octyl vinyl ether, lauryl vinyl ether, cetyl vinyl ether, and stearyl vinyl ether.

In the two-photon absorption recording material [A] of the present invention, a heat stabilizer may be added for the purpose of enhancing the storability during storage.

Examples of the useful heat stabilizer include hydroquinone, phenidone, p-methoxyphenol, alkyl- or aryl-substituted hydroquinone or quinone, catechol, tert-butyl catechol, pyrogallol, 2-naphthol, 2,6-di-tert-butyl-p-cresol, phenothiazine, and chloranil. Dinitroso dimers described in U.S. Pat. No. 4,168,982 by Pazos are also useful.

In the two-photon absorption recording material [A] of the present invention, a plasticizer may be used for varying the adhesiveness, flexibility, hardness and other various mechanical properties of the recording material. Examples of the plasticizer include triethylene glycol dicaprylate, triethylene glycol bis(2-ethylhexanoate), tetraethylene glycol diheptanoate, diethyl sebacate, dibutyl suberate, tris(2-ethylhexyl)phosphate, tricresyl phosphate, and dibutyl phthalate.

The two-photon absorption recording material [A] of the present invention may be prepared by an ordinary method, for example, by adding the above-described essential components and optional components with or without a solvent as needed.

Examples of the solvent include a ketone-based solvent such as methyl ethyl ketone, methyl isobutyl ketone, acetone and cyclohexanone, an ester-based solvent such as ethyl acetate, butyl acetate, ethylene glycol diacetate, ethyl lactate and cellosolve acetate, a hydrocarbon-based solvent such as cyclohexane, toluene and xylene, an ether-based solvent such as tetrahydrofuran, dioxane and diethyl ether, a cellosolve-based solvent such as methyl cellosolve, ethyl cellosolve, butyl cellosolve and dimethyl cellosolve, an alcohol-based solvent such as methanol, ethanol, n-propanol, 2-propanol, n-butanol and diacetone alcohol, a fluorine-based solvent such as 2,2,3,3-tetrafluoropropanol, a halogenated hydrocarbon-based solvent such as dichloromethane, chloroform and 1,2-dichloroethane, an amide-based solvent such as N,N-dimethylformamide, and a nitrile-based solvent such as acetonitrile and propionitrile.

The two-photon absorption recording material [A] of the present invention may be directly coated on a substrate by using a spin coater, a roll coater, a bar coater or the like or may be cast as a film and then laminated on a substrate by an ordinary method, whereby a two-photon absorption recording material can be obtained.

The term “substrate” as used herein means an arbitrary natural or synthetic support, suitably a material which can be present in the form of a soft or rigid film, sheet or plate.

Preferred examples of the substrate include polyethylene terephthalate, resin-undercoated polyethylene terephthalate, polyethylene terephthalate subjected to flame or electrostatic discharge treatment, cellulose acetate, polycarbonate, polymethyl methacrylate, polyester, polyvinyl alcohol and glass.

The solvent used can be removed by evaporation at the drying. For the removal by evaporation, heating or reduced pressure may be used.

Furthermore, a protective layer for blocking oxygen may be formed on the two-photon absorption recording material. The protective layer may be laminated, for example, by stacking a plastic-made film or sheet such as polyolefin (e.g., polypropylene, polyethylene), polyvinyl chloride, polyvinylidene chloride, polyvinyl alcohol, polyethylene terephthalate or cellophane film, by means of electrostatic adhesion or an extruder or may be formed by coating a solution of the polymer above. Also, a glass sheet may be laminated. In addition, a pressure-sensitive adhesive or a liquid substance may be allowed to be present between the protective layer and the photosensitive film and/or between the base material and the photosensitive film so as to increase the air tightness.

Furthermore, the two-photon absorption optical recording medium of the present invention may have a multilayer structure where a recording layer containing recording components and a non-recording layer containing no recording component are alternately stacked. By virtue of having a structure where a recording layer and a non-recording layer are alternately stacked, a non-recording layer intervenes between recording layers and blocks expansion of the recording region in a direction perpendicular to the recording layer surface. Accordingly, even when the recording layer is restricted to a thickness on the order of irradiation light wavelength, crosstalk can be reduced. As a result, not only the thickness of the recording layer itself can be made thin but also the interlayer distance of recording layers including a non-recording layer can be shortened.

The thickness of the recording layer is preferably from 50 nm to 5,000 nm, more preferably from 100 nm to 1,000 nm, still more preferably from 100 nm to 500 nm, according to the amount of refractive index change of the recording layer material used, because the amount of refractive index change of the recording layer during recording and the interference conditions by reflected light on the front and back surfaces of each recording layer with respect to the incident direction of light need to be satisfied.

The non-recording layer is a layer formed in a thin-film shape from a material that causes no change in the absorption spectrum or light emission spectrum when irradiated with recording light.

In view of ease of production in the formation of a multilayer structure, the material used for the non-recording layer is preferably a material dissolvable in a solvent incapable of dissolving the material used for the recording layer. Among these materials, a transparent polymer material not having absorption in the visible region is preferred. A water-soluble polymer is suitably used as such a material.

Specific examples of the water-soluble polymer include polyvinyl alcohol (PVA), polyvinylpyridine, polyethyleneimine, polyethylene oxide, polypropylene oxide, polyvinylpyrrolidone, polyacrylamide, polyacrylic acid, sodium polyacrylate, carboxymethyl cellulose, hydroxyethyl cellulose, and gelatin. Among these, PVA, polyvinylpyridine, polyacrylic acid, polyvinylpyrrolidone, carboxymethyl cellulose and gelatin are preferred, and PVA is most preferred.

In the case of using a water-soluble polymer as the material for the non-recording layer, a coating solution obtained by dissolving the water-soluble polymer in water is, for example, coated by a coating method such as spin coating, whereby the non-recording layer can be formed.

In view of wavelength of recording or readout light, recording power, readout power, NA of lens and recording sensitivity of the recording layer material, the thickness of the non-recording layer is preferably from 1 to 50 μm, more preferably from 1 to 20 μm, still more preferably from 1 to 10 μm, so as to reduce the crosstalk between recording layers sandwiching the non-recording layer.

The number of pairs of a recording layer and a non-recording layer stacked alternately is preferably from 9 to 200, more preferably from 10 to 100, still more preferably from 10 to 30, in view of recording capacity required of the two-photon absorption recording medium and aberration determined by the optical system used.

[B] “Two-photon absorption recording material containing (b′) a material capable of changing the reflected light intensity between before and after two-photon recording” (hereinafter, referred to as two-photon absorption recording material [B] or recording material [B])

The two-photon absorption recording material [B] and the two-photon absorption recording medium and the like using the recording material [B] are described below.

The two-photon absorption recording material [B] of the present invention is provided as a recording layer on a supporting substrate or is utilized as a recording medium having a layer structure located adjacent to a layer having a refractive index different from that of the recording layer.

The mechanism of recording/reproduction of the recording medium using the two-photon absorption recording material [B] of the invention as a recording layer is not clearly known but is presumed as follows.

In a recording layer using the recording material [B] composed of a two-photon absorption compound and “(b′) a material capable of changing the reflected light intensity between before and after two-photon recording”, heat is generated in the two-photon absorption portion to change the refractive index of the recording layer, or the recording layer surface or the interface with an adjacent layer having a refractive index different from that of the supporting substrate or the recording layer is changed to change the reflectance, whereby recording is performed, and the reflectance difference between the portion where reflectance is changed by the recording and the unrecorded portion where the reflectance is not changed is compared, whereby reproduction is performed.

Also, in the recording layer, a refractive index change is caused in a wide range in the progressing direction of recording light (hereinafter, simply referred to as “depth direction”) and a recording spot is recorded. At this time, a refractive index change occurs according to the intensity distribution of recording light and therefore, when the recording spot is irradiated with reading light for readout during reproduction, the recording spot acts as a lens. This action as a lens causes the reading light to diverge from the recording spot or converge in the recording spot. Accordingly, when reading light for readout is radiated in accordance with the interface at the time of reproducing the information, the light returned from the recording spot may be weakened (in the case where the refractive index becomes small) or strengthened (in the case where the refractive index becomes large), producing a difference from the intensity of light returned from the interface in the non-recorded portion, and modulation of this intensity difference enables readout of the information.

<(b′) Material Capable of Changing the Reflected Light Intensity Between Before and after Two-Photon Recording>

The (b′) material capable of changing the reflected light intensity between before and after two-photon recording, which is used in the non-resonant two-photon absorption recording material [B] of the present invention, includes, for example, a polymer compound.

The polymer compound preferably has no linear absorption at the two-photon recording wavelength.

As the polymer compound, the same compounds as those recited above as the binder in the two-photon absorption recording material [A] may be appropriately used.

The two-photon absorption recording material [B] of the present invention does not contain (b) a material capable of changing the fluorescence intensity between before and after two-photon recording, which is used in the two-photon absorption recording material [A].

The two-photon absorption recording material [B] of the present invention contains a higher percentage of a polymer binder and the like than the two-photon absorption recording material [A], and the recording sensitivity of a recording medium using the recording material [B] is as high as 10 times or more as compared with the case where a recording medium using the two-photon absorption recording material [A] is recorded by the fluorescence modulation system.

Also, in the case where the two-photon absorption recording material [B] of the present invention uses, as the two-photon absorption compound, a compound having no linear absorption for visible light, the recording material [B] and a recording medium using the recording material [B] can make light blocking unnecessary.

An optical information recording medium using a recording layer containing the two-photon absorption recording material [B] of the present invention and a manufacturing method therefor are described in detail below by referring to each element constituting the optical information recording medium.

### [Substrate]

As the substrate for use in the recording medium of the present invention, a substrate made of various materials employed as the substrate material of the conventional optical information recording medium may be arbitrarily selected and used. A disk-shaped substrate is preferably used as the substrate.

Specific examples of the substrate material include glass, polycarbonate, an acrylic resin such as polymethyl methacrylate, a vinyl chloride-based resin such as polyvinyl chloride and vinyl chloride copolymer, an epoxy resin, an amorphous polyolefin, a polyester, and a metal such as aluminum. These may be used in combination, if desired.

Among these materials, in view of humidity resistance, dimensional stability, low cost and the like, a thermoplastic resin such as amorphous polyolefin and polycarbonate is preferred, and a polycarbonate is more preferred.

In the case of using such a resin, the substrate can be produced by using injection molding. Also, the substrate may be produced by forming the resin in a film shape and punching out the film in a disc shape.

The thickness of the substrate is in general from 0.02 to 2 mm, preferably from 0.6 to 2 mm, more preferably from 0.7 to 1.5 mm, still more preferably from 0.9 to 1.2 mm. Also, two recording mediums may be laminated together to make up a double-side recordable medium. In this case, the thickness of one substrate is from 0.2 to 0.7 mm, preferably from 0.3 to 0.6 mm, more preferably from 0.4 to 0.5 mm.

Furthermore, in order to enable high-speed recording/reproduction and increase the recording capacity per volume, the thickness of the substrate may be more greatly reduced than in a general optical disc, thereby imparting flexibility. In this case, the thickness of the substrate is from 0.02 to 0.4 mm, preferably from 0.05 to 0.35 mm, more preferably from 0.01 to 0.3 mm.

In the center of the substrate, a hole for chucking is generally provided. Also, a hub may be provided in place of a hole.

### [Guide Layer]

A concentric or spiral guide layer may be provided so as to perform the radial position control by a tracking servo during recording of the optical medium. The guide layer is generally has a continuous or intermittent concavo-convex structure and in the conventional optical disc, one groove is continuously formed to run spirally from the inner circumference to the outer circumference of a disc-shaped medium. A preferred range of the groove depth is determined by the laser wavelength used for tracking. In the case of employing a push-pull system for the tracking, assuming that the laser wavelength used for tracking is λ, and the refractive index in the groove is n, the tracking signal obtained from the groove becomes maximum when the groove thickness is λ/(8n), and becomes 0 when the groove depth is 0 and λ/(4n). Therefore, the groove depth d is in the range of 0<d<λ/(4n). The groove depth d is preferably in the range of λ/(12n)<d<λ/(6n), more preferably d=λ/(8n).

The width of the guide groove may be set according to the track pitch, and in general, a high-intensity push-pull signal can be obtained by setting the width to about half of the track pitch.

In the guide layer, a structure capable of producing a clock signal for rotation synchronization during recording can be provided. In general, a wobble groove system of causing the groove to meander with an arbitrary frequency is employed. The recording apparatus can be controlled to a specified recording linear velocity by referring to the periodic signal fluctuation obtained from the wobble groove. Also, address information may be provided in the guide layer. In the case of a wobble groove system, a frequency modulation system of combining large and small frequencies with respect to the carrying frequency, thereby imparting arbitrary address information, a phase modulation system of imparting address information by changing the wobble phase, a system of superimposing the address information, and the like can be used. Also, a so-called land pre-pit system of providing a mark aside the groove and forming address information by its position may be used.

In addition, information necessary for recording/reproduction control, such as calibration of recording power, corresponding linear velocity and signal polarity, may be also previously recorded in the guide information by using the same method as that for the address information.

The position in the depth direction at which the guide layer is provided may be any position as long as it is a position reproducible by the tracking laser, and in the case of providing the guide layer on the substrate surface, the substrate molding and the guide layer formation can be performed simultaneously by pressing a metal stamper having engraved therein a guide layer geometry at the molding of the substrate. Also, the guide layer may be formed by coating an ultraviolet-curable resin or the like on the molded substrate, pressing the stamper and then curing the resin. The guide layer can be formed in the same manner also in the case where the guide layer is provided adjacent each recording layer, provided as an intermediate layer between recording layers, or provided adjacent a cover layer. It is also possible that the metal stamper is heated to a temperature not lower than the softening point of the resin layer for providing the guide layer and then pressed to transfer the pattern.

### [Reflecting Layer]

A reflecting layer can be provided adjacent the guide layer or recording layer so as to increase the reflected signal intensity.

The material for the reflecting layer may be selected from material species capable of providing for the required reflectance at the readout wavelength and, for example, a metal such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi, and a semimetal may be used. Among these, Ag, Au and Al are preferred, because a high reflectance is obtained. One of these materials may be used alone, or a plurality thereof may be mixed and used. Also, a small amount of an additive element may be added for reforming.

The reflected light can be also produced by using a high refractive index or low refractive index material as the reflecting layer and thereby creating a refractive index difference from the adjacent layer. Examples of the high refractive index material include titanium oxide (TiO₂), cerium oxide (CeO₂), zirconium oxide (ZrO₂), niobium oxide (Nb₂O₅), tantalum oxide (Ta₂O₅), tungsten oxide (WO₃), zinc oxide (ZnO), and indium oxide (In₂O₃). Examples of the low refractive index material include aluminum fluoride (AlF₃), calcium fluoride (CaF₂), lithium fluoride (LiF), magnesium fluoride (MgF₂), and sodium fluoride (NaF). One of these materials may be used alone, or a plurality thereof may be mixed and used. Such an inorganic compound is film-formed by sputtering, deposition, ion plating, molecular beam epitaxy or other methods, whereby the reflecting layer can be formed.

In the case where the wavelength differs between the recording/readout laser and the tracking laser, it is also possible to establish a high reflectance for the tracking laser and a low reflectance for the recording/readout laser by using a wavelength-selective reflecting layer material and thereby reduce unnecessary reflected light. Specifically, in the case of using light at the 405 nm wavelength as the recording/readout laser and light at the 660 nm wavelength as the tracking laser, when Au exhibiting a high reflectance at a wavelength longer than 500 nm and abruptly decreasing in the reflectance at a wavelength shorter than 500 nm is used as the reflecting layer, the light of the tracking laser is strongly reflected to reduce the reflectance of the recording/readout light, whereby stray light due to reflection of the recording/readout light can be reduced.

### [Intermediate Layer]

An intermediate layer for physically separating the recording layer and producing an interface capable of forming a recording mark by expansion is provided between adjacent recording layers.

The interface reflection between the recording layer and the intermediate layer occurs mainly due to the refractive index different between those two layers and therefore, a refractive index difference needs to be created between the recording layer and the intermediate layer. In the case where the intermediate layer is located on both sides of the recording layer in a multilayer structure, the recording layer may be formed to create the same refractive index difference from both intermediate layers and bring about occurrence of interface reflection from top and bottom of the recording layer or may be formed such that out of the intermediate layers located on both sides of the recording layer, the refractive index of the intermediate layer on one side is the same as that of the recording layer and the refractive index of the intermediate layer on another side is different from that of the recording layer, thereby bringing about occurrence of reflected light only from the interface on one side of the recording layer. In this case, the reflectance of the recording layer can be reduced in the fluctuation due to light interference as compared with the case of producing reflected light form the interfaces on both sides of the recording layer. Also, in this case, the intermediate layers on the top and bottom of the recording layer may be formed of different materials.

The refractive index difference between the recording layer and the intermediate layer is generally preferably from 0.01 to 0.5, more preferably from 0.04 to 0.4, still more preferably from 0.08 to 0.25. If the refractive index difference is too small, necessary reflected light is not obtained, whereas if it is too large, the material used is limited.

If the thickness of the intermediate layer is too small, there is a problem that optical separation of adjacent recording layers from each other is difficult or so-called crosstalk between layers occurs, for example, by receiving a thermal effect, whereas if the thickness is too large, the number of recording layers can be hardly increased. For this reason, the thickness of the intermediate layer is preferably from 2 μm to 20 μm, more preferably from 4 μm to 15 μm, still more preferably from 6 μm to 10 μm.

The intermediate layer is preferably transparent to light at the recording/readout wavelength and the tracking wavelength. The “transparent” means that the transmittance for light used in the recording and readout is 80% or more.

Respective intermediate layers may have the same film thickness or may be different in the film thickness. Considering that a smaller distance from the incident surface leads to a lower aberration of the optical system, it is also effective to make the intermediate layer close to the incident side thinner.

As the material for the intermediate layer, a thermoplastic resin, a thermosetting resin, an ultraviolet-curable resin, an electron beam-curable resin, a self-adhesive agent and the like can be used. The ultraviolet-curable resin is composed of a urethane resin, an acrylic resin, a urethane acrylate resin, an epoxy resin, a fluoropolymer such as perfluoropolyether, a silicon-based polymer such as polydimethylsiloxane, or a mixture with a photopolymerization initiator or the like.

As the photopolymerization initiator, a known initiator can be used, and out of the photopolymerization initiators, examples of the radical photoinitiator include Darocur 1173, Irgacure 651, Irgacure 184 and Irgacure 907 (all produced by Ciba Specialty Chemicals Corporation). The content of the photopolymerization initiator is, for example, approximately from 0.5 to 5 mass % in an ultraviolet-curable resin agent composition (as solid content).

Also, the composition may contain, if desired, a non-polymerizable diluting solvent, a photopolymerization initiation aid, an organic filler, a polymerization inhibitor, an antioxidant, an ultraviolet absorber, a light stabilizer, a defoaming agent, a leveling agent, a pigment, a silicon compound and the like. Examples of the non-polymerizable diluting solvent include isopropyl alcohol, n-butyl alcohol, methyl ethyl ketone, methyl isobutyl ketone, isopropyl acetate, n-butyl acetate, ethyl cellosolve, and toluene. Examples of the ultraviolet absorber include benzotriazole-based, benzophenone-based, oxalic acid anilide-based and cyano acrylate-based compounds.

The ultraviolet-curable resin layer can be formed by a known film-forming method. For example, air doctor coating, blade coating, rod coating, knife coating, squeeze coating, impregnation coating, reverse roll coating, transfer roll coating, gravure coating, kiss roll coating, cast coating, curtain coating, calender coating, extrusion coating, spray coating, spin coating, hot-melt coating, vapor deposition or extrusion may be used.

As the self-adhesive agent used for the self-adhesive layer, for example, an acrylic, rubber-based or silicon-based self-adhesive agent can be used. In view of transparency and durability, an acrylic self-adhesive agent is preferred.

An acrylic copolymer obtained by copolymerizing, as a main monomer, a low Tg monomer such as butyl acrylate, ethyl acrylate and 2-ethylhexyl acrylate with a polyfunctional group monomer such as acrylic acid, methacrylic acid, hydroxyethyl methacrylate, hydroxyethyl acrylate, acrylamide and acrylonitrile is crosslinked, for example, by an isocyanate-based, melamine-based, epoxy-based or urethane-based crosslinking agent, whereby the acrylic self-adhesive agent can be obtained. Other photocurable oligomers.monomers, polymerization initiators, diluting solvents, tackifiers, antioxidants, sensitizers, crosslinking agents, ultraviolet absorbers, polymerization inhibitors, fillers, thermoplastic resins.dyes.pigments, and the like can be cured or added. Such a self-adhesive composition is coated on a separator.

As the separator, a release-treated plastic film or paper having a thickness of 25 to 100 μm, such as polyester film, polypropylene film, polyethylene film, polycarbonate film, polystyrene film and triacetyl cellulose film, can be used. Among these, a biaxially stretched polyester film is preferred, because a smoother surface is readily obtained and the productivity is excellent. The separator surface coming into contact with the self-adhesive agent layer is subjected to a treatment with a release agent. Examples of the release agent include a simple substance, a modification product, a mixture and the like of a silicone resin, a fluororesin, a polyvinyl alcohol resin and an alkyl group-containing resin. Among these, a silicone resin making it easy to lightly separate the adhesive layer may be preferably used, and in particular, a silicone resin cured with heat, ultraviolet ray, electron beam or the like may be more preferably used, because the silicone resin is less likely to transfer and adhere to the adhesive layer.

The self-adhesive layer can be coated on the separator by a known film-forming method. For example, air doctor coating, blade coating, rod coating, knife coating, squeeze coating, impregnation coating, reverse roll coating, transfer roll coating, gravure coating, kiss roll coating, cast coating, curtain coating, calender coating, extrusion coating, spray coating, spin coating, or hot-melt coating may be used. The composition coated is dried and cured, for example, by irradiation with an active energy ray, whereby an intermediate layer of a self-adhesive agent is formed. It is also possible that the coating is stacked on the medium in the state of not completely finishing the curing and after stacking, curing is completed by heating, irradiation with an ultraviolet ray, or other methods.

The intermediate layer may be film-formed directly on the medium or may be stacked on the medium after previously preparing a laminate structure with the recording layer. In the case of using a self-adhesive layer for the intermediate layer, the recording layer and the intermediate layer are press-bonded by a known method described, for example, in JP-A-209328 and JP-A-2011-81860, whereby the laminate can be formed. Furthermore, a laminate containing two or more recording layers and two or more intermediate layers can be also formed by stacking the laminates one on another. This laminate can be stacked on the medium by arranging the self-adhesive layer to face the substrate, guide layer, reflecting layer, cover sheet, spacer layer, or the already formed recording layer or intermediate layer and pressure-contacting it by a roller or the like.

### [Recording Layer]

In the recording layer of the present invention, when irradiated with recording light, the dye moiety absorbs recording light to generate heat and the polymer moiety deforms due to the heat to form a convex geometry on the interface with the adjacent layer, whereby information is recorded.

The geometry change for obtaining a signal intensity necessary for recording/readout requires a recording layer having a certain extent of thickness to achieve expansion, and the thickness is from 50 nm to 5 μm, preferably from 100 nm to 3 μm, more preferably from 200 nm to 2 μm.

In the recording layer, an additive such as binder, antifading agent, exothermic agent, plasticizer and refractive index adjusting agent may be added, if desired.

Examples of the binder include a natural organic polymer substance such as gelatin, cellulose derivative, dextran, rosin and rubber; and a synthetic organic polymer including a hydrocarbon-based resin such as polyethylene, polypropylene, polystyrene and polyisobutylene, a vinyl-based resin such as polyvinyl chloride, polyvinylidene chloride and polyvinyl chloride.polyvinyl acetate copolymer, an acrylic resin such as polymethyl acrylate and polymethyl methacrylate, a polyvinyl alcohol, a chlorinated polyethylene, an epoxy resin, a butyral resin, a rubber derivative, and an initial condensate of a thermosetting resin, such as phenol.formaldehyde resin.

The antifading agent includes an organic oxidant and a singlet oxygen quencher. As the organic oxidant used as the antifading agent, the compounds described in JP-A-10-151861 are preferred. As the singlet oxygen quencher, those described in publications such as already known patent specifications can be utilized. Specific examples thereof include JP-A-58-175693, JP-A-59-81194, JP-A-60-18387, JP-A-60-19586, JP-A-60-19587, JP-A-60-35054, JP-A-60-36190, JP-A-60-36191, JP-A-60-44554, JP-A-60-44555, JP-A-60-44389, JP-A-60-44390, JP-A-60-54892, JP-A-60-47069, JP-A-63-209995, JP-A-4-25492, JP-B-1-38680, JP-B-6-26028, German Patent No. 350399, and Bulletin of the Chemical Society of Japan, page 1141, October 1992.

Examples of the plasticizer include triethylene glycol dicaprylate, triethylene glycol bis(2-ethylhexanoate), tetraethylene glycol diheptanoate, diethyl sebacate, dibutyl suberate, tris(2-ethylhexyl) phosphate, tricresyl phosphate, and dibutyl phthalate. As the refractive index adjusting agent, for example, various polymer materials or a fine particle of a transparent inorganic material such as SiO₂ and TiO₂ can be used.

The recording layer can be formed by a known film-forming method. For example, air doctor coating, blade coating, rod coating, knife coating, squeeze coating, impregnation coating, reverse roll coating, transfer roll coating, gravure coating, kiss roll coating, cast coating, curtain coating, calender coating, extrusion coating, spray coating, spin coating, hot-melt coating, vapor deposition or extrusion may be used.

In the case of using solvent coating, the components of the recording layer are dissolved or dispersed in a coating solvent. The coating solvent may be selected by taking into consideration the solubility, decomposability, coating suitability and the like of the components of the recording layer, and, for example, one member or a mixture of a plurality of members selected from an alcohol-based solvent such as methyl alcohol, ethyl alcohol, propyl alcohol, butyl alcohol, allyl alcohol, furfuryl alcohol, methyl cellosolve, ethyl cellosolve and tetrafluoropropanol; an aliphatic or alicyclic hydrocarbon-based solvent such as hexane, heptane, octane, decane, cyclohexane, methyl cyclohexane, dimethyl cyclohexane, trimethyl cyclohexane and propyl cyclohexane; an aromatic hydrocarbon-based solvent such as toluene, xylene and benzene; a halogenated hydrocarbon-based solvent such as carbon tetrachloride and chloroform; an ether-based solvent such as diethyl ether, dibutyl ether, diisopropyl ether, dioxane and tetrahydrofuran; a ketone-based solvent such as acetone; an ester-based solvent such as ethyl acetate; and water, is used. Such a solvent and the components of the recording layer are mixed and then, for example, stirred, treated with an ultrasonic wave or heated, whereby the coating solvent is prepared. The solvent used can be removed by evaporation at the drying. Heating or pressurization may be used for the removal by evaporation.

The recording layer may be formed directly on the substrate or may be stacked on the substrate after previously preparing a laminate structure with the intermediate layer. In the case of using a self-adhesive layer for the intermediate layer, the recording layer is formed by coating on the separator or a release adding layer and then laminated with the intermediate layer by a known method described, for example, in JP-A-2005-209328 and JP-A-2011-81860, whereby a laminate of the recording layer and the intermediate layer can be formed.

The number of recording layers may be one or more, and the number of layers may be increased by stacking the recording layers with the intervention of the intermediate layer.

### [Spacer Layer]

A concavo-convex geometry is provided in the guide layer and in turn, the reflected light on the guide layer has a frequency component and affects the recording/reproduction signal. Therefore, a spacer layer for spatially separating the guide layer from a recording layer closest to the guide layer and reducing the effect of reflected light on the guide layer can be provided.

The thickness of the spacer layer is preferably from 5 μm to 100 μm, more preferably from 10 μm to 50 μm, still more preferably from 20 μm to 40 μm.

As the material for the spacer layer, a thermoplastic resin, a thermosetting resin, an ultraviolet-curable resin, an electron beam-curable resin, a self-adhesive agent and the like can be used. Also, the material may be the same material as the intermediate layer.

### [Cover Layer]

From the standpoint of protecting the recording layer, a cover layer may be provided on the light incident surface side relative to the recording layer. If the cover layer is too thin, a scratch or contamination on the surface of the cover layer is detected with a good contrast. On the other hand, as the distance from the incident surface to the recording layer is increased, the aberration of the optical system becomes higher. Therefore, the thickness of the cover layer has a suitable range. Specifically, the thickness of the cover layer is generally from 0.01 mm to 0.2 mm, preferably from 0.02 mm to 0.1 mm, more preferably from 0.03 mm to 0.07 mm.

As the method to form the cover layer, for example, a method of forming an ultraviolet-curable resin composition on the surface and curing the composition, and a method of attaching the film through an adhesive, a self-adhesive agent or the like may be used.

The ultraviolet-curable resin is composed of a urethane resin, an acrylic resin, a urethane acrylate resin, an epoxy resin, a fluoropolymer such as perfluoropolyether, a silicon-based polymer such as polydimethylsiloxane, or a mixture with a photopolymerization initiator or the like.

As the photopolymerization initiator, a known initiator can be used, and out of the photopolymerization initiators, examples of the radical photoinitiator include Darocur 1173, Irgacure 651, Irgacure 184 and Irgacure 907 (all produced by Ciba Specialty Chemicals Corporation). The content of the photopolymerization initiator is, for example, approximately from 0.5 to 5 mass % in an ultraviolet-curable resin agent composition (as solid content).

Also, the composition may contain, if desired, a non-polymerizable diluting solvent, a photopolymerization initiation aid, an organic filler, a polymerization inhibitor, an antioxidant, an ultraviolet absorber, a light stabilizer, a defoaming agent, a leveling agent, a pigment, a silicon compound and the like. Examples of the non-polymerizable diluting solvent include isopropyl alcohol, n-butyl alcohol, methyl ethyl ketone, methyl isobutyl ketone, isopropyl acetate, n-butyl acetate, ethyl cellosolve, and toluene. Examples of the ultraviolet absorber include benzotriazole-based, benzophenone-based, oxalic acid anilide-based and cyano acrylate-based compounds.

Also, in the ultraviolet-curable composition, a thermal polymerization inhibitor, an antioxidant typified by hindered phenol, hindered amine and phosphite, a plasticizer, a silane coupling agent typified by epoxy silane, mercapto silane and (meth)acryl silane, and the like may be blended, if desired, as other additives for the purpose of improving various properties. For such an additive, those having excellent solubility for the curable component and not inhibiting the ultraviolet transmission are preferably selected and used.

This ultraviolet-curable resin may be used as an adhesive in the case of laminating a film.

As the self-adhesive agent used for the self-adhesive layer, for example, an acrylic, rubber-based or silicone-based self-adhesive agent can be used. In view of transparency and durability, an acrylic self-adhesive agent is preferred.

An acrylic copolymer obtained by copolymerizing, as a main monomer, a low Tg monomer such as butyl acrylate, ethyl acrylate and 2-ethylhexyl acrylate with a polyfunctional group monomer such as acrylic acid, methacrylic acid, hydroxyethyl methacrylate, hydroxyethyl acrylate, acrylamide and acrylonitrile is crosslinked, for example, by an isocyanate-based, melamine-based, epoxy-based or urethane-based crosslinking agent, whereby the acrylic self-adhesive agent can be obtained. Other photocurable oligomers.monomers, polymerization initiators, diluting solvents, tackifiers, antioxidants, sensitizers, crosslinking agents, ultraviolet absorbers, polymerization inhibitors, fillers, thermoplastic resins.dyes.pigments, and the like can be cured or added. Such a self-adhesive composition is coated on a separator.

As the separator, a release-treated plastic film or paper having a thickness of 25 to 100 μm, such as polyester film, polypropylene film, polyethylene film, polycarbonate film, polystyrene film and triacetyl cellulose film, can be used. Among these, a biaxially stretched polyester film is preferred, because a smoother surface is readily obtained and the productivity is excellent. The separator surface coming into contact with the self-adhesive agent layer is subjected to a treatment with a release agent. Examples of the release agent include a simple substance, a modification product, a mixture and the like of a silicone resin, a fluororesin, a polyvinyl alcohol resin and an alkyl group-containing resin. Among these, a silicone resin making it easy to lightly separate the adhesive layer may be preferably used, and in particular, a silicone resin cured with heat, ultraviolet ray, electron beam or the like may be more preferably used, because the silicone resin is less likely to transfer and adhere to the adhesive layer.

The self-adhesive layer can be coated on the separator by a known film-forming method. For example, air doctor coating, blade coating, rod coating, knife coating, squeeze coating, impregnation coating, reverse roll coating, transfer roll coating, gravure coating, kiss roll coating, cast coating, curtain coating, calender coating, extrusion coating, spray coating, spin coating, or hot-melt coating may be used. The composition coated is dried and cured, for example, by irradiation with an active energy ray to form a self-adhesive layer. Thereafter, a film material may be stacked on the self-adhesive layer by a laminator, whereby a cover layer with a self-adhesive layer can be formed.

In the case of laminating a film, the film used is not particularly limited as long as it is a transparent material, but a polycarbonate, an acrylic resin such as polymethyl methacrylate, a vinyl chloride-based resin such as polyvinyl chloride and vinyl chloride copolymer, an epoxy resin, an amorphous polyolefin, a polyester, and a cellulose triacetate are preferably used. Among these, a polycarbonate, an amorphous polyolefin or a cellulose triacetate are preferably used.

Here, the “transparent” means that the transmittance for light used in the recording and readout is 80% or more.

### [Hardcoat Layer]

In order to prevent contact with an objective lens of the recording/reproducing apparatus, scratch due to handling, or contamination such as fingerprint, a hardcoat layer may be provided on the light incident surface. The hardcoat layer may be previously formed on the cover layer surface, or the layer may be prepared in the form of an ultraviolet-curable resin composition and, in the process of producing a disc, formed by coating the composition on the surface by spin coating or the like and then curing it.

The hardcoat layer is generally composed of a urethane resin, an acrylic resin, a urethane acrylate resin, an epoxy resin, a fluoropolymer such as perfluoropolyether, a silicon-based polymer such as polydimethylsiloxane, or a mixture with an SiO₂ fine particle, a photopolymerization initiator or the like. As the photopolymerization initiator, a known initiator can be used, and out of the photopolymerization initiators, examples of the radical photoinitiator include Darocur 1173, Irgacure 651, Irgacure 184 and Irgacure 907 (all produced by Ciba Specialty Chemicals Corporation). The content of the photopolymerization initiator is, for example, approximately from 0.5 to 5 mass % in a hardcoat agent composition (as solid content).

Also, the hard coat agent composition may further contain, if desired, a non-polymerizable diluting solvent, a photopolymerization initiation aid, an organic filler, a polymerization inhibitor, an antioxidant, an ultraviolet absorber, a light stabilizer, a defoaming agent, a leveling agent, a pigment, a silicon compound and the like. Examples of the non-polymerizable diluting solvent include isopropyl alcohol, n-butyl alcohol, methyl ethyl ketone, methyl isobutyl ketone, isopropyl acetate, n-butyl acetate, ethyl cellosolve, and toluene. Examples of the ultraviolet absorber include benzotriazole-based, benzophenone-based, oxalic acid anilide-based and cyano acrylate-based compounds.

As the hardcoat material, specifically, the compounds described in JPA-2004-292430 and JP-A-2005-112900, and commercially available products, for example, HC-3 (produced by DIC Corporation), may be also used.

The hardcoat layer may serve also as the above-described cover layer, and in this case, the layer can be formed by forming the hardcoat layer to a thickness necessary as the cover layer.

### [Preparation of Recording Medium]

Respective constituent elements described above are combined as desired and sequentially stacked, whereby the optical information recording medium of the present invention can be manufactured.

The optical information recording medium of the present invention preferably has a recording layer composed of a non-resonant two-photon absorption recording material containing a non-resonant two-photon absorption compound and is preferably an optical recording medium having a substrate, a guide layer, a reflecting layer, a spacer layer and a laminate structure consisting of a recording layer sandwiched by intermediate layers, in order, from the back side relative to incident light and a cover layer and a hardcoat layer on the incident light surface side.

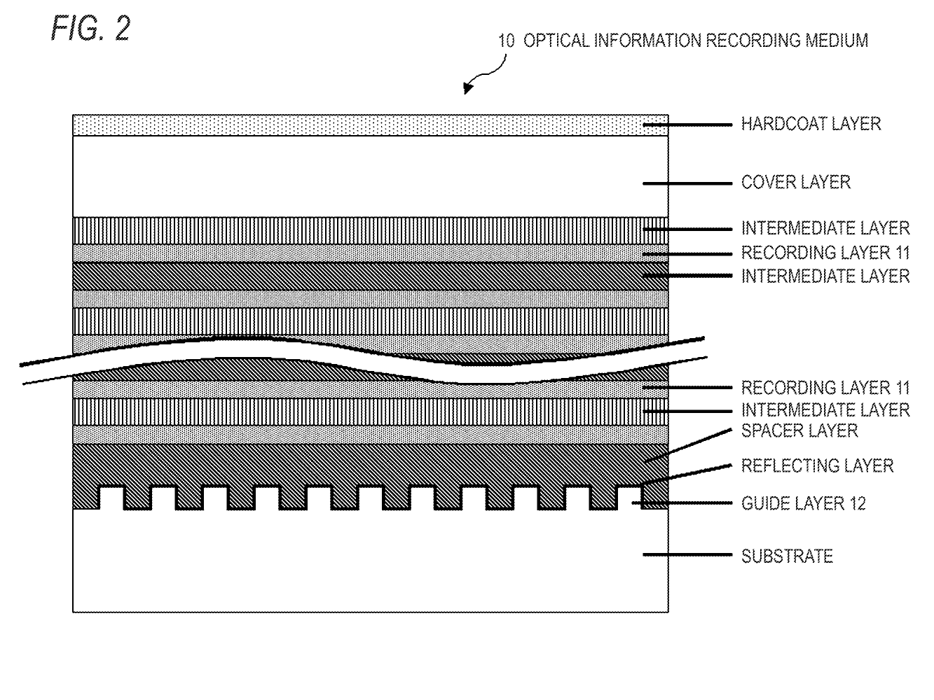

FIG. 2 shows one example of the optical information recording medium of the present invention. The optical information recording medium 10 shown in FIG. 2 has a guide layer 12, a reflecting layer, a spacer layer, an intermediate layer and a recording layer 11 in this order on a substrate. The recording layer has a configuration of being sandwiched by intermediate layers. Also, the medium has a cover layer and a hardcoat layer on the incident light surface side.

### [Formation of Identification Information]

Marking by barcode or the like can be applied to a part of the medium for the purpose of providing identification information and the like on each recording medium.

As for the marking method, a method involving thermal fracture by delivering a laser beam into the reflecting layer used in the conventional optical disc described in Japanese Patent No. 3,143,454 and 3,385,285, and a method such as laser irradiation or printing of the recording layer may be used.

### [Cartridge]

The recording medium may be housed in a cartridge for the purpose of protecting the recording medium from a scratch due to falling or handling or imparting light resistance. In this case, a cartridge used for the conventional optical disc can be utilized.

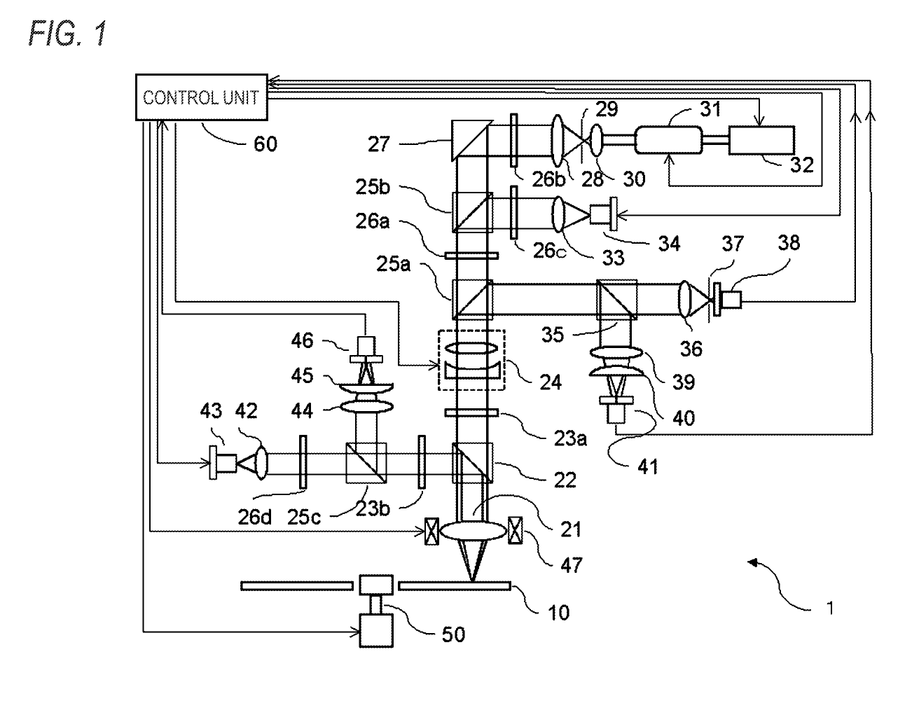

The configuration of the recording/reproducing apparatus is described below. As shown in FIG. 1, the recording/reproducing apparatus 1 is an apparatus performing recording.reproduction of information in an optical information recording medium 10 held by a spindle 50.

The recording/reproducing apparatus 1 has an objective lens 21 facing the optical information recording medium 10 and has, on the optical axis of the objective lens 21, DBS (dichroic beam splitter) 22, a λ/4 plate 23a, a beam expander 24 for correcting aberration, PBS (polarizing beam splitter) 25a, a λ/2 plate 26a, PBS 25b and a mirror 27 in order from the objective lens 21.

In the direction passing the mirror 27 and intersecting with the optical axis direction of the objective lens 21, a λ/2 plate 26b, a collimating lens 28, a pinhole 29, a condensing lens 30, a modulator 31, and a recording laser 32 are arranged in order.

Also, in the reflection direction of PBS25b, a λ/2 plate 26c, a collimating lens 33, and a readout laser 34 are arranged in order, and in the reflection direction of PBS 25a, a beam splitter 35 is arranged. In one direction split by the beam splitter 35, a condensing lens 36, a pinhole 37, and a readout light receiving element 38 are arranged, and in another direction, a condensing lens 39, a cylindrical lens 40, and a readout focus light receiving element 41 are arranged.

In the direction passing DBS 22 and intersecting with the optical axis direction of the objective lens 21, a λ/14 plate 23b and PBS 25c are arranged. In the direction orthogonal to the optical axis direction of the objective lens 21 on one side of PBS25c, a λ/2 plate 26 d, a collimating lens 42, and a laser light source 43 for the guide layer are arranged in order, and in the direction parallel to the optical axis direction of the objective lens 21 on another side of PBC 25c, a condensing lens 44, a cylindrical lens 45, and a light receiving element 46 for guide light are arranged in order.

The objective lens 21 is a lens converging the guide light on the guide layer and converging the recording light and the readout light on one of a plurality of recording layers 11. The objective lens 21 is moved in the optical axis direction by a lens actuator 47 that is driven by a control unit 60, to focus the guide light on the guide layer 12 and focus the recording light and the readout light on an arbitrary recording layer 11. Also, the objective lens 21 is moved in the direction parallel to the optical axis by the lens actuator 47, whereby the tracking position of the recording light and the reading light can be controlled.

The beam expander 24 is an optical element caused to change the converged or diverged state of light incident on the objective lens 21 by the control unit 60 and fulfills a function of correcting the depth and spherical aberration of the recording layer 11 undertaking the recording and reproduction.

The λ/4 plates 23a and 23b are an optical element for converting linearly polarized light into circularly polarized light and converting circularly polarized light into linearly polarized light in accordance with the rotational direction thereof and fulfills a function of making the direction of the linearly polarized light of light incident on the optical information recording medium 10 and the direction of the linearly polarized light of reflected light to differ by 90°.

Each of the λ/2 plates 26a, 26b, 26c and 26d is an optical element for rotating the polarizing direction of the linearly polarized light incident on the plate and can control the transmittance on passing the PBS by controlling the polarizing direction to the predetermined direction.

Each of PBS 25a and 25b is an optical element for reflecting and separating particular polarized light and fulfills a function of allowing the recording light emitted from the recording laser 32 and the reading light emitted from the readout laser 38 to pass through and travel toward the optical information recording medium 10 and at the same time, reflecting the readout light returned from the optical information recording medium 10 to cause its traveling toward the beam splitter 35.

Similarly, PBS 25c allows light from the laser light source 43 for the guide layer to pass through and travel toward the optical information recording medium 10 and reflects the reflected light to allow its travel toward the light receiving element 46 for guide light.

The beam splitter 35 is an optical element for splitting light in a predetermined splitting ratio irrespective of the polarization state of light and fulfills a function of distributing the readout light guided by the PBS25a to the readout focus light receiving element 41 and the readout light receiving element 38.

DBS 22 is an optical element for reflecting light in a specific wavelength region and transmitting light in other wavelength regions, and a splitter capable of transmitting the recording light and readout light and reflecting the laser light for the guide layer is used. In this embodiment, this splitter is disposed to direct the laser light for the guide layer entering from the side toward the optical information recording medium 10.

The readout laser 34 is a 405 nm-CW (Continuous Wave) laser. The beam of the readout laser 34 is preferably narrowed to be equal to or smaller than the recording spot and therefore, it is preferred to use a laser capable of emitting light having a wavelength the same as or shorter than that of the recording laser 32. The output of the readout laser 34 is controlled by the control unit 60.

The laser 43 for the guide layer is a 650 nm-CW laser. The light from the laser 43 for the guide layer is collected by the objective lens 21 and concentrated on the guide layer 12 of the optical information recording medium 10. The laser light for the guide layer can be split by DBS 22 by making the recording light and the readout light to differ from each other. The output of the laser 43 for the guide layer is controlled by the control unit 60.

The recording laser 32 is a 405 nm-pulsed laser. To efficiently cause a multi-photon absorption reaction in the recording layer 11, a pulsed laser having a peak power greater than that of the CW laser is preferably used as the recording laser 32. The output of the recording laser 32 is controlled by the control unit 60. The peak power preferred as the recording laser is preferably from 1 to 100 W on the surface of the optical information recording medium 10. If the peak power is less than 1 W, the photon density in the recording spot is reduced to cause a problem that an efficient multi-photon absorption reaction does not occur, whereas if the peak power exceeds 100 W e, the average output of the recording layer becomes high and there arises a problem that the recording pulsed laser used for recording becomes large-sized. Therefore, the average output of the recording laser is preferably 100 mW or less on the optical information recording medium. The average output of the pulsed laser is determined by the product of the peak power, the pulse width and the oscillation cycle. The preferred peak power is from 1 to 100 W and therefore, for achieving an average power of 100 mW or less, the product of the pulse width and the oscillation cycle is preferably from 0.001 to 0.1. The pulse oscillation cycle preferred as the recording laser is preferably 50 MHz or more so as to ensure a sufficient recording speed. When a more preferred oscillation cycle of 500 MHz is selected as the sufficient oscillation cycle, the pulse width at a peak power of 1 W to 100 W may be selected in the range of 200 psec to 2 psec or less, respectively, so as to give an average power of 100 mW or less.

The non-resonant two-photon absorption recording method is preferably a method of three-dimensionally recording information by irradiating the optical information recording medium of the present invention with laser light having a wavelength of 400 to 450 nm.

The modulator 31 is a device for removing a part of the pulsed light out of the pulsed laser light emitted from the recording laser 32 to temporally modulate the pulsed laser light and encode the information. As the modulator 42, an acousto-optic modulator (AOM), a Mach-Zehnder (MZ) optical modulator, and other electro-optic modulators (EOM) may be used. When such an acousto-optic modulator or electro-optic modulator is used as the modulator 31, ON.OFF of light can be performed at an extremely high speed as compared with using a mechanical shutter. The control unit 60 outputs, to the modulator 31, the signal encoded in accordance with the information to be recorded, whereby the operation of the modulator 31 is controlled.

Each of the light receiving elements 46 and 41 for guide light utilizes a quadrant photodetector or the like and is an element for obtaining a focus controlling signal by an astigmatic method or the like. Specifically, the control unit 60 controls the beam expander 24 or the lens actuator 47 to minimize astigmatism generated by passing through the condensing lenses 39 and 44 and the cylindrical lenses 40 and 45, whereby focusing can be performed

The readout light receiving element 38 is an element for receiving the readout light including the reproduced information, and the signal detected by the readout light receiving element 38 is output to the control unit 60 and then demodulated into the information in the control unit 60. The light received by the readout focus light receiving element 41 has passed through the cylindrical lens 40, so that when the light quantity distribution is output to the control unit 60, the control amount for the focusing servo of the recording light and the readout light can be obtained by an astigmatic method in the control unit 60.

The pinhole plate 37 is arranged in the vicinity of the focal point of light condensed by the condensing lens 36 and constitutes a confocal optical system, whereby unnecessary light can be cut by passing only the reflected light from a predetermined depth position of the optical information recording medium 10.

The control unit 60 controls the lens actuator 47 by the astigmatism of laser light for the guide layer detected by the guide light receiving element 46 and controls the position in the optical axis direction of the objective lens 21 to adjust the focal position of the guide light to a position on the guide layer. Also, the unit controls the lens actuator 21 by a push-pull method (DPP method) using a differential signal detected by the guide light receiving element 46 or a differential phase detection (DPD Method) using a differential phase signal to control the position in the direction orthogonal to the optical axis of the objective lens 21 and adjust the tracking position. Furthermore, the unit controls the beam expander 24 by astigmatism of the readout light detected by the readout focus light receiving element 38 and thereby controls the focal position of the recording/readout light to focus on a predetermined recording layer 11.

The recording/reproducing apparatus 1 has the same configuration of the conventionally known optical recording/regenerating apparatus, in addition to the above-described configuration. For example, the apparatus has an actuator for moving the recording light, the readout light and the optical information recording medium 10 relatively to each other in the planar direction of the recording layer 11 so as to record many recording spots in the plane of the recording layer 11 of the optical information recording medium 10.

The recording/reproducing method by the thus-configured recording/reproducing apparatus 1 is described below.

At the recording of information, in the recording/reproducing apparatus 1, pulsed laser light is emitted from the recording laser 32, and information is encoded on the pulsed laser light by removing a part of the pulsed light by the modulator 31. The information-encoded light passes PBS25b, the λ/2 plate 26a and PBS25a, converged by the beam expander 24 to control the diverged state, then passes the λ/4 plate 23a and DBS 22, and converged on a predetermined recording layer 11 by the objective lens 21. At the same time with irradiation with the pulsed laser light, the readout laser 34 emits CW laser light, and the CW laser light is reflected by PBS25b and then converged by the objective lens 21, similarly to the recording laser light. The CW laser light returned from the optical information recording medium 10 passes the objective lens 21, DBS22, the λ/4 plate 23a and the beam expander 24, is reflected by PBS25a, and enters the readout light receiving element 38 through the condensing lens 36 and the pinhole plate 37.

The control unit 60 calculates focal positions of the guide light, the recording beam and the readout light based on the signal received from the guide light receiving element 46 and the readout focus light receiving element 41 and drives the lens actuator 21 and the beam expander 24, thereby controlling the position of the objective lens and controlling the recording light and readout light to focus on a predetermined recording layer 11.

As a result, according to the intensity of light (in the case of a two-photon absorption reaction, in proportion to the square of the intensity of light), a light absorption reaction occurs more frequently in the closer vicinity to the focal point where the intensity of the light is strong, and the recording layer is changed in accordance with this reaction.

At the readout of information, the apparatus stops the recording laser 32 and drives the readout laser 34 to irradiate the optical information recording medium 10 with CW laser light. At this time, similarly to the recording of information, the CW laser light (readout light) returned from the optical information recording medium 10 is reflected by the PBS 25a and enters the readout light receiving element 38 and the readout focus light receiving element

In this way, the control unit 60 can demodulate the information from the modulation obtained by the difference between the intensity of reflected light in the recorded portion and the intensity of reflected light in the non-recorded portion. That is, the information can be read out.

In the foregoing pages, the embodiment of the present invention is described, but the present invention is not limited to the embodiment described above and can be implemented by making appropriate modification therein.

### EXAMPLES

Specific Examples of the present invention are described below based on the experimental results. Of course, the present invention is not limited to these Examples.

Synthesis methods of Compounds D-6 and D-29 of the present invention are described below.

### Synthesis Method of Compound D-6

Compound D-6 was synthesized by the method shown below.

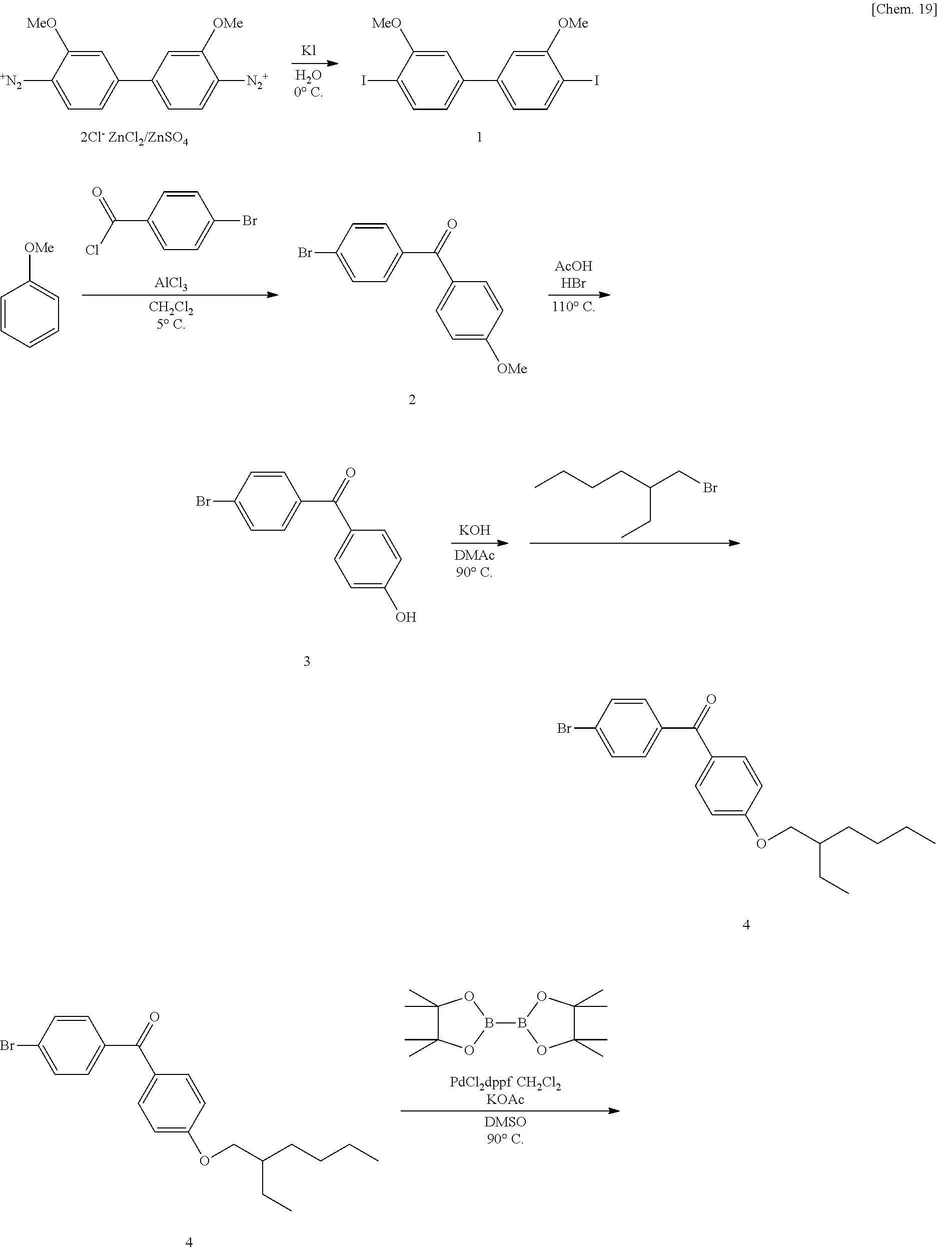

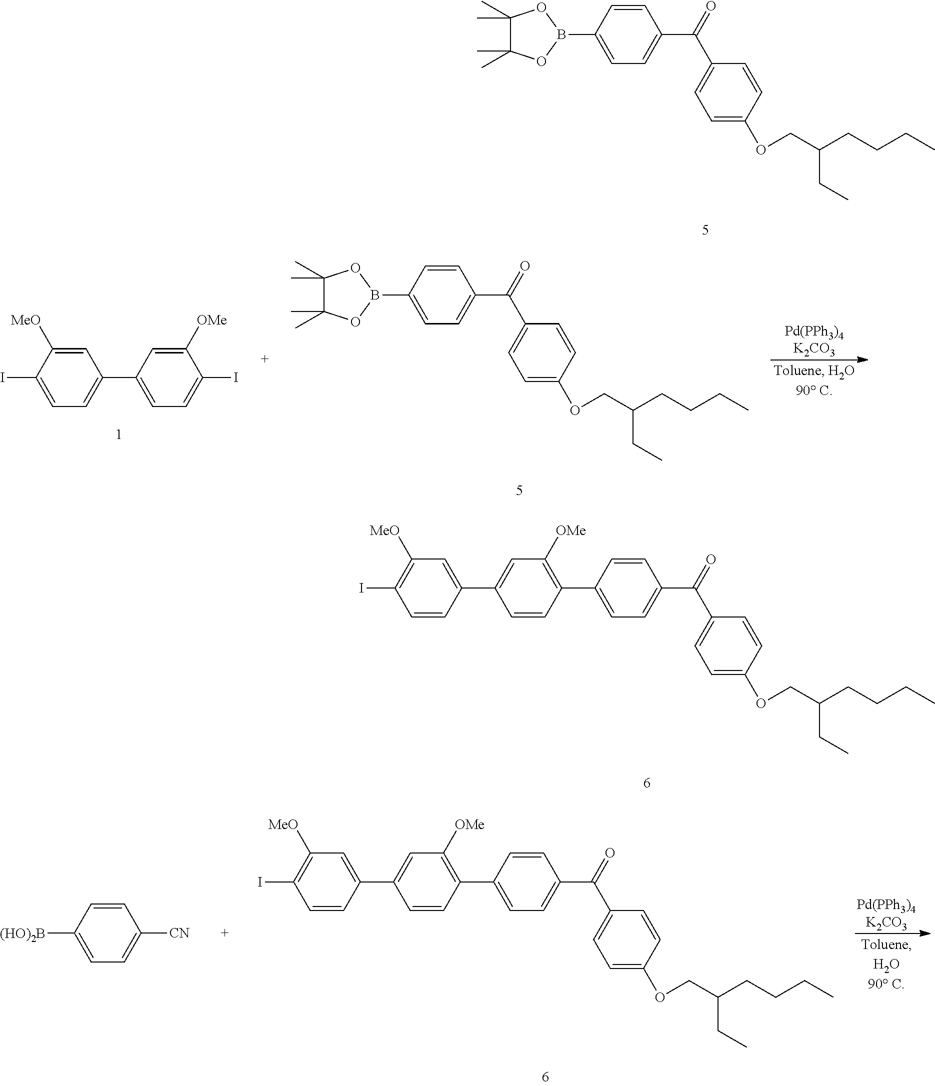 [SMILES: CCCCC(CC)COc1ccc(C(=O)c2ccc(B3OC(C)(C)C(C)(C)O3)cc2)cc1 ; COc1cc(-c2ccc(I)c(OC)c2)ccc1I ; CCCCC(CC)COc1ccc(C(=O)c2ccc(B3OC(C)(C)C(C)(C)O3)cc2)cc1 ; CCCCC(CC)COc1ccc(C(=O)c2ccc(-c3ccc(-c4ccc(I)c(OC)c4)cc3OC)cc2)cc1 ; N#Cc1ccc(B(O)O)cc1 ; CCCCC(CC)COc1ccc(C(=O)c2ccc(-c3ccc(-c4ccc(I)c(OC)c4)cc3OC)cc2)cc1]

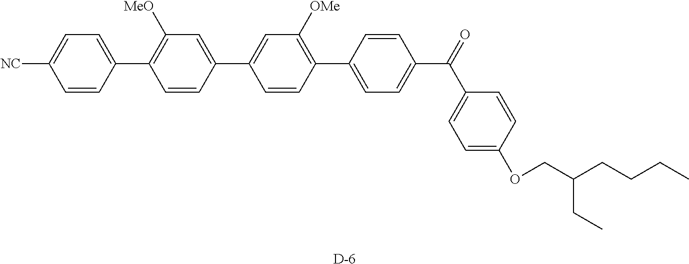

### Synthesis of Raw Material Compound 1

33.2 g (200 mmol) of potassium iodide was dissolved in 150 ml of pure water and after cooling to an internal temperature of 0° C., 10.0 g (15.7 mmol) of Azoic Diazo Component 48 was added in 3 parts, followed by stirring for 5 hours. The reaction solution was extracted by adding ethyl acetate, then washed in sequence with an aqueous 10 mass % sodium hydroxide solution, saturated saline, an aqueous 5 mass % sodium hydrogensulfite solution and saturated saline, and dried over magnesium sulfate. The filtrate separated by filtration was concentrated in a rotary evaporator and purified on a silica gel column (toluene) to obtain 5.4 g (yield: 74%) of white Compound 1. Compound 1 obtained was confirmed to be the target product by ¹H NMR.

### Synthesis of Raw Material Compound 2

27.0 g (250 mmol) of anisole and 42.9 g (200 mmol) of 4-bromobenzoyl chloride were dissolved in 500 ml of methylene chloride and after cooling to an internal temperature of 5° C., 33.4 g (250 mmol) of aluminum chloride was added in 6 parts, followed by stirring for 8 hours in a nitrogen atmosphere. The reaction solution was poured in water, then extracted with methylene chloride, and evaporated to dryness in a rotary evaporator to quantitatively obtain white Compound 2. Compound 2 obtained was confirmed to be the target product by ¹H NMR.

### Synthesis of Raw Material Compound 3

140 ml of hydrobromic acid and 220 ml of acetic acid were added to 35.0 g (120 mmol) of Raw Material Compound 2, and the mixture was stirred at an internal temperature of 110° C. for 12 hours. After allowing to cool to room temperature, the reaction solution was poured in water and stirred at room temperature for 20 minutes. The precipitate was filtered, then washed with pure water and hexane:ethyl acetate=5:1 and dried under reduced pressure to quantitatively obtain white Compound 3. Compound 3 obtained was confirmed to be the target product by ¹H NMR.

### Synthesis of Raw Material Compound 4

240 ml of dimethylacetamide was added to 10.0 g (36.1 mmol) of Raw Material Compound 3 and 2.43 g (43.3 mmol) of potassium hydroxide, and the mixture was stirred at an external temperature of 90° C. for 2 hours in a nitrogen atmosphere. Thereafter, 8.36 g (43.3 mmol) of 2-ethylhexyl bromide was added, and the mixture was further stirred for 5 hours. After allowing to cool to room temperature, the reaction solution was poured in water, and the precipitate deposited was filtered and purified on a silica gel column (hexane:ethyl acetate=5:1) to obtain 6.2 g (yield: 44%) of white Compound 4. Compound 4 obtained was confirmed to be the target product by ¹H NMR.

### Synthesis of Raw Material Compound 5

80 ml of dimethylsulfoxide was added to 6.00 g (15.4 mmol) of Raw Material Compound 4, 4.30 g (16.9 mmol) of bispinacolatodiboron, 628 mg (0.77 mmol) of [1,1′-bis(diphenylphosphino)ferrocene]palladium(II) dichloride dichloromethane adduct and 4.53 g (46.2 mmol) of potassium acetate, and the mixture was stirred at an internal temperature of 90° C. for 5 hours in a nitrogen atmosphere. After allowing to cool to room temperature, the reaction solution was extracted with methylene chloride, concentrated in a rotary evaporator and then purified on a silica gel column (hexane:ethyl acetate=5:2) to obtain 6.32 g (yield: 94%) of white Compound 5. Compound 5 obtained was confirmed to be the target product by ¹H NMR.

### Synthesis of Raw Material Compound 6

50 ml of toluene and 10 ml of water were added to 19.6 g (42.0 mmol) of Raw Material Compound 1, 6.10 g (14.0 mmol) of Raw Material Compound 5, 808 mg (0.70 mmol) of tetrakistriphenylphosphine palladium and 5.80 g (42.0 mmol) of potassium carbonate, and the mixture was stirred at an external temperature of 90° C. for 7 hours in a nitrogen atmosphere. After allowing to cool to room temperature, the reaction solution was extracted with methylene chloride, concentrated in a rotary evaporator and then purified on a silica gel column (toluene) to obtain 1.4 g (yield: 15%) of white Compound 6. Compound 6 obtained was confirmed to be the target product by ¹H NMR.

### Synthesis of Compound D-6

12 ml of toluene and 2.5 ml of water were added to 1.40 g (2.16 mmol) of Raw Material Compound 6, 952 mg (6.48 mmol) of 4-cyanophenylboronic acid, 125 mg (0.108 mmol) of tetrakistriphenylphosphine palladium and 1.19 g (8.64 mmol) of potassium carbonate, and the mixture was stirred at an external temperature of 90° C. for 4 hours in a nitrogen atmosphere. After allowing to cool to room temperature, the reaction solution was extracted with methylene chloride, concentrated in a rotary evaporator and then purified on a silica gel column (toluene) to obtain 850 mg (yield: 63%) of white Compound D-6.

¹H NMR (CDCl₃) 7.91-7.83 (m, 4H), 7.73-7.68 (m, 6H), 7.48 (d, 1H), 7.41 (d, 1H), 7.37-7.31 (m, 2H), 7.25 (d, 2H), 6.99 (d, 2H), 3.96 (m, 8H), 1.78 (m, 1H), 1.59-1.33 (m, 8H), 0.98-0.90 (m, 6H).

### Synthesis Method of Compound D-29

Compound D-29 was synthesized by the method shown below.

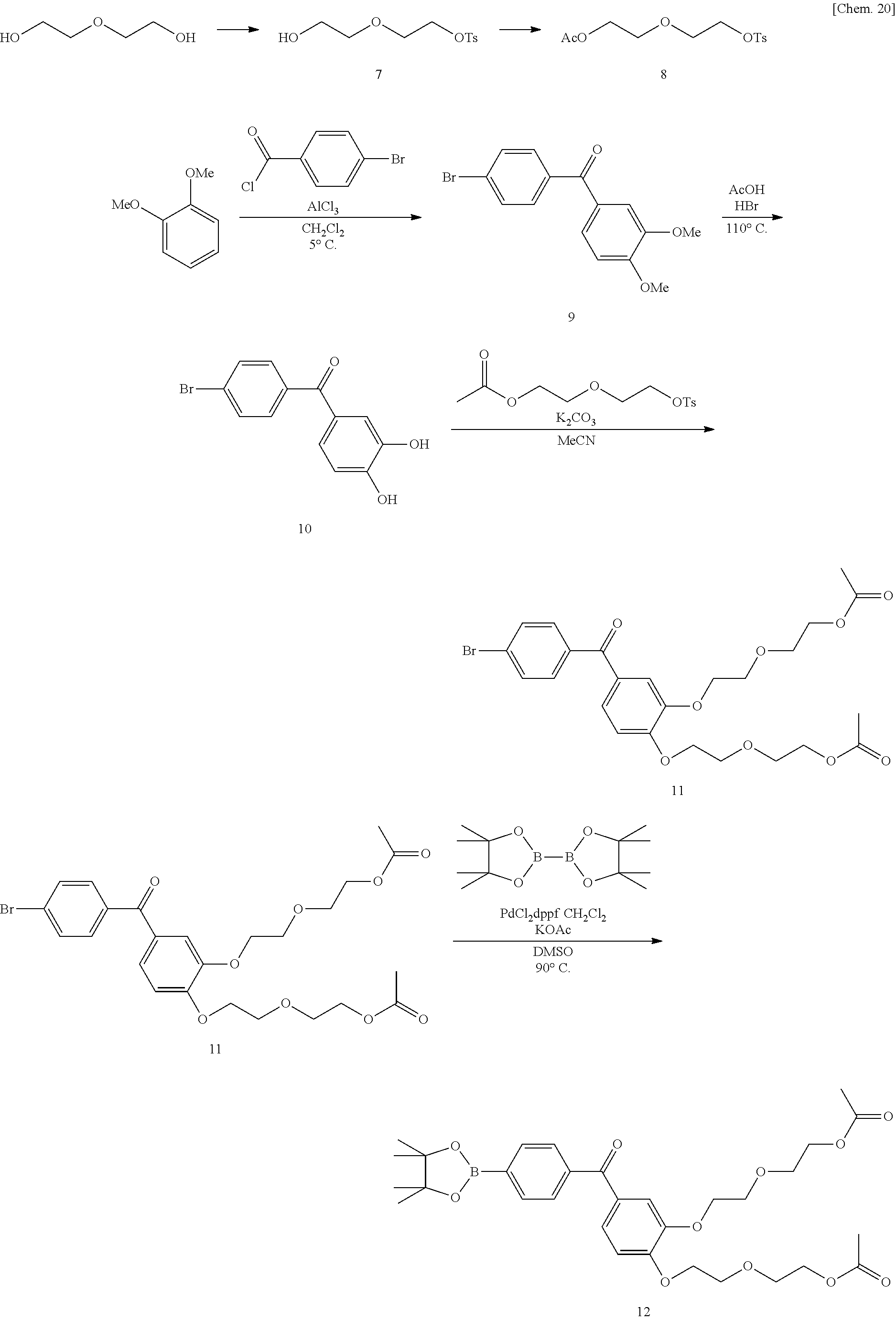

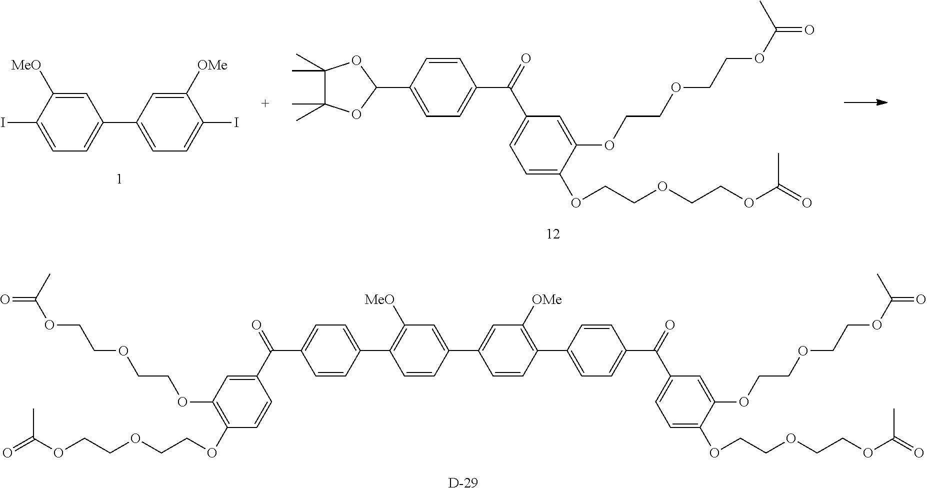

### Synthesis of Raw Material Compound 7

36.7 g (360 mmol) of triethylamine was added to a solution containing 105.1 g (990 mmol) of diethylene glycol and 200 ml of acetonitrile, and the mixture was cooled to an internal temperature of 5° C. and thereafter stirred for 5 hours in a nitrogen atmosphere while adding dropwise 62.9 g (362 mmol) of tosyl chloride dissolved in 200 ml of acetonitrile. The reaction solution was extracted with ethyl acetate-water, washed with saturated saline and dried over magnesium sulfate. After separating magnesium sulfate by filtration, the filtrate was concentrated in a rotary evaporator and then purified on a silica gel column (hexane:ethyl acetate=1:2) to obtain 59.7 g (yield: 69%) of colorless Compound 7. Compound 7 obtained was confirmed to be the target product by ¹H NMR.

### Synthesis of Raw Material Compound 8

23.8 g (235 mmol) of triethylamine was added to a solution containing 55.7 g (214 mmol) of Raw Material Compound 7 and 100 ml of acetonitrile, and the mixture was cooled to an internal temperature of 5° C. and thereafter stirred for 3 hours in a nitrogen atmosphere while adding dropwise 18.4 g (235 mmol) of acetyl chloride dissolved in 100 ml of acetonitrile. The reaction solution was extracted with ethyl acetate-water, washed with saturated saline and dried over magnesium sulfate. After separating magnesium sulfate by filtration, the filtrate was concentrated in a rotary evaporator and then purified on a silica gel column (hexane:ethyl acetate=1:1) to obtain 46.4 g (yield: 72%) of colorless Compound 8. Compound 7 obtained was confirmed to be the target product by ¹H NMR.

### Synthesis of Raw Material Compound 9

50.0 g (362 mmol) of 1,2-dimethoxybenzene and 63.6 g (290 mmol) of 4-bromobenzoyl chloride were dissolved in 1,200 ml of methylene chloride and after cooling to an internal temperature of 5° C., 48.3 g (362 mmol) of aluminum chloride was added in 6 parts, followed by stirring for 6 hours in a nitrogen atmosphere. The reaction solution was poured in water, then extracted with methylene chloride, and evaporated to dryness in a rotary evaporator to obtain 89.9 g (yield: 97%) of white Compound 9. Compound 9 obtained was confirmed to be the target product by ¹H NMR.

### Synthesis of Raw Material Compound 10

120 ml of hydrobromic acid and 210 ml of acetic acid were added to 32.3 g (100 mmol) of Raw Material Compound 9, and the mixture was stirred at an internal temperature of 110° C. for 60 hours. After allowing to cool to room temperature, the reaction solution was poured in water and stirred at room temperature for 20 minutes. The precipitate was filtered, then washed with pure water and hexane:ethyl acetate=5:1 and dried under reduced pressure to quantitatively obtain white Compound 10. Compound 10 obtained was confirmed to be the target product by ¹H NMR.

### Synthesis of Raw Material Compound 11

250 ml of acetonitrile was added to 15.8 g (54.0 mmol) of Raw Material Compound 10, 34.3 g (113 mmol) of Raw Material Compound 8 and 18.0 g (130 mmol) of potassium carbonate, and the mixture was stirred at an external temperature of 70° C. for 6 hours in a nitrogen atmosphere. The reaction solution was extracted with ethyl acetate-water, washed with saturated saline and dried over magnesium sulfate. After separating magnesium sulfate by filtration, the filtrate was concentrated in a rotary evaporator and then purified on a silica gel column (hexane:ethyl acetate=1:1) to obtain 21.2 g (yield: 71%) of white Compound 11. Compound 11 obtained was confirmed to be the target product by ¹H NMR.

### Synthesis of Raw Material Compound 12

65 ml of dimethylsulfoxide was added to 7.16 g (12.9 mmol) of Raw Material Compound 11, 3.61 g (14.2 mmol) of bispinacolatodiboron, 527 mg (0.645 mmol) of [1,1′-bis(diphenylphosphino)ferrocene]palladium(II) dichloride dichloromethane adduct and 3.80 g (38.7 mmol) of potassium acetate, and the mixture was stirred at an internal temperature of 90° C. for 5 hours in a nitrogen atmosphere. After allowing to cool to room temperature, the reaction solution was extracted with methylene chloride, concentrated in a rotary evaporator and then purified on a silica gel column (hexane:ethyl acetate=1:1) to obtain 4.85 g (yield: 63%) of white Compound 12. Compound 12 obtained was confirmed to be the target product by ¹H NMR.

### Synthesis of Compound D-29

20 ml of dimethoxyethane was added to 4.82 g (8.03 mmol) of Raw Material Compound 12, 1.25 g (2.68 mmol) of Raw Material Compound 1, 123 mg (0.134 mmol) of tris(dibenzylideneacetone)dipalladium, 220 mg (0.536 mmol) of 2-dicyclohexylphosphino-2′,6′-dimethoxybiphenyl and 1.71 g (8.04 mmol) of potassium phosphate, and the mixture was stirred at an internal temperature of 80° C. for 4 hours in a nitrogen atmosphere. After allowing to cool to room temperature, the reaction solution was extracted with methylene chloride and water, concentrated in a rotary evaporator and then purified on a silica gel column (ethyl acetate.methylene chloride) to obtain 2.0 g (yield: 65%) of white Compound D-29. Compound D-29 obtained was confirmed to be the target product by ¹H NMR.

¹H NMR (CDCl₃) 7.85 (d, 4H), 7.71 (d, 4H), 7.54 (d, H), 7.48 (d, 4H), 7.35 (dd, 2H), 7.25 (d, 2H), 6.97 (d, 2H), 4.27 (m, 16H), 3.95 (m, 14H), 3.83 (m, 8H), 2.10 (s, 12H).

### Synthesis Method of Compound D-1

Compound D-1 was synthesized by the method shown below.

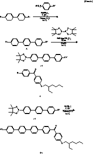

### Synthesis of Raw Material Compound 13

110 ml of toluene and 20 ml of water were added to 14.0 g (45.0 mmol) of 4,4′-dibromobiphenyl, 1.30 g (1.13 mmol) of tetrakistriphenylphosphine palladium and 9.33 g (67.5 mmol) of potassium carbonate, and 3.32 g (22.6 mmol) of 4-cyanophenylboronic acid was added in parts with stirring at an external temperature of 90° C. in a nitrogen atmosphere, followed by stirring for 5 hours. After allowing to cool to room temperature, the solid precipitated was separated by filtration and washed with ethyl acetate to obtain 5.02 g (yield: 67%) of white Compound 13. Compound 13 obtained was confirmed to be the target product by ¹H NMR.

### Synthesis of Raw Material Compound 14

75 ml of dimethylsulfoxide was added to 5.01 g (15.0 mmol) of Raw Material Compound 13, 4.20 g (16.5 mmol) of bispinacolatodiboron, 614 mg (0.75 mmol) of [1,1′-bis(diphenylphosphino)ferrocene]palladium(II) dichloride dichloromethane adduct and 4.41 g (44.9 mmol) of potassium acetate, and the mixture was stirred at an internal temperature of 90° C. for 60 hours in a nitrogen atmosphere. After allowing to cool to room temperature, the reaction solution was diluted with ethyl acetate and water, and the solid precipitated was separated by filtration and purified on a silica gel column (hexane:ethyl acetate=5:2) to obtain 4.40 g (yield: 77%) of white Compound 14. Compound 14 obtained was confirmed to be the target product by ¹H NMR.

### Synthesis of D-1

15 ml of toluene and 2.5 ml of water were added to 1.02 g (2.62 mmol) of Raw Material Compound 4, 1.00 g (2.62 mmol) of Raw Material Compound 14, 151 mg (0.13 mmol) of tetrakistriphenylphosphine palladium and 1.09 g (7.86 mmol) of potassium carbonate, and the mixture was stirred at an external temperature of 90° C. for 12 hours in a nitrogen atmosphere. After allowing to cool to room temperature, the reaction solution was diluted with ethyl acetate and water, and the solid precipitated was separated by filtration, purified on a silica gel column (ethyl acetate), solidified and then washed with ethyl acetate to obtain 1.1 g (yield: 74%) of white Compound D-1. Compound D-1 obtained was confirmed to be the target product by ¹H NMR.

¹H NMR (CDCl₃) 7.90-7.83 (m, 4H), 7.81-7.70 (m, 14H), 6.99 (d, 2H), 3.94 (d, 2H), 1.77 (m, 1H), 1.59-1.31 (m, 8H), 0.98-0.88 (m, 6H).

### Synthesis Method of Compound D-2

Compound D-2 was synthesized by the method shown below.

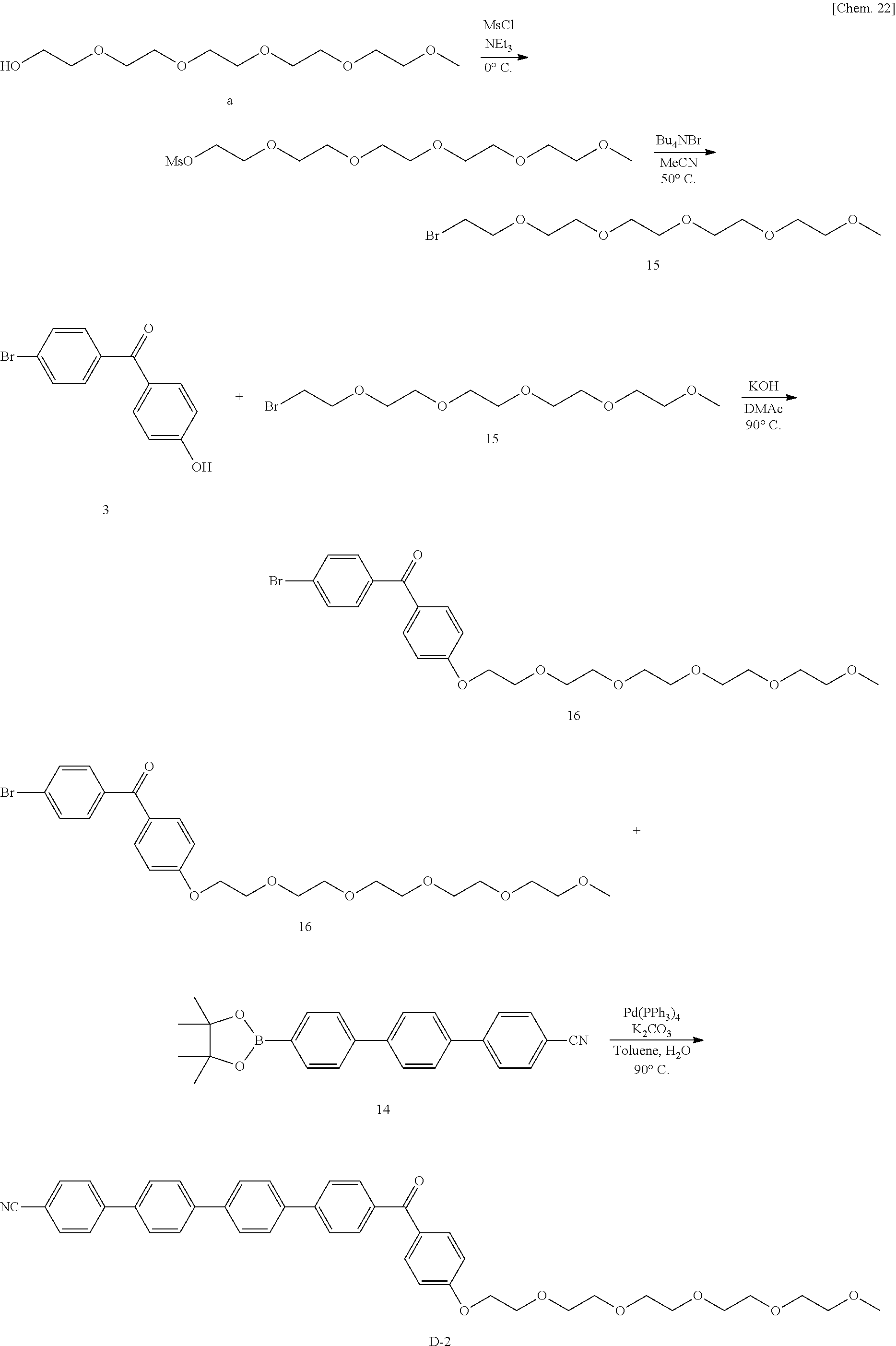

### Synthesis of Raw Material Compound 15

5.7 ml (40 mmol) of triethylamine was added to 5.00 g (19.8 mmol) of Raw Material Compound a, and the mixture was cooled to an external temperature of 0° C. in a nitrogen atmosphere and stirred for 12 hours while adding dropwise 2.5 ml (32 mmol) of methanesulfonic acid chloride over 30 minutes. The reaction solution was extracted with methylene chloride, washed with 0.1 N hydrochloric acid and dried over sodium sulfate. The filtrate separated by filtration was concentrated in a rotary evaporator and thereafter, 50 ml of acetonitrile and 12.8 g (39.7 mmol) of tetrabutylammonium bromide were added thereto, followed by stirring at an external temperature of 50° C. for 20 hours in a nitrogen atmosphere. After allowing to cool to room temperature, the reaction solution was extracted with ethyl acetate-water and dried over magnesium sulfate. The filtrate separated by filtration was concentrated in a rotary evaporator to obtain 3.00 g (yield: 48%) of red liquid 15. Compound 15 obtained was confirmed to be the target product by ¹H NMR.

### Synthesis of Raw Material Compound 16

36 ml of dimethylacetamide was added to 2.00 g (7.22 mmol) of Raw Material Compound 3 and 486 mg (8.66 mmol) of potassium hydroxide, and the mixture was stirred at an external temperature of 90° C. for 2 hours in a nitrogen atmosphere. Thereafter, 2.73 g (8.66 mmol) of Raw Material Compound 15 was added, and the mixture was further stirred for 6 hours. After allowing to cool to room temperature, the reaction solution was extracted with ethyl acetate-water and dried over magnesium sulfate. The filtrate separated by filtration was concentrated in a rotary evaporator and purified on a silica gel column (ethyl acetate) to quantitatively obtain yellow Compound 16. Compound 16 obtained was confirmed to be the target product by ¹H NMR.

### Synthesis of D-2

26 ml of toluene and 5 ml of water were added to 4.03 g (7.88 mmol) of Raw Material Compound 16, 2.00 g (5.25 mmol) of Raw Material Compound 14, 304 mg (0.26 mmol) of tetrakistriphenylphosphine palladium and 2.18 g (15.8 mmol) of potassium carbonate, and the mixture was stirred at an external temperature of 90° C. for 4 hours in a nitrogen atmosphere. After allowing to cool to room temperature, the reaction solution was diluted with ethyl acetate and water, and the solid precipitated was separated by filtration, purified on a silica gel column (chloroform), solidified and then washed with ethyl acetate to obtain 2.22 g (yield: 41%) of white Compound D-2. Compound D-2 obtained was confirmed to be the target product by ¹H NMR.

¹H NMR (CDCl₃) 7.88-7.83 (m, 4H), 7.81-7.70 (m, 14H), 7.01 (d, 2H), 4.23 (t, 2H), 3.91 (t, 2H), 3.74 (t, 2H), 3.70-3.61 (m, 12H), 3.55 (t, 2H), 3.38 (s, 3H).

### <Measuring Method of Two-Photon Absorption Cross-Sectional Area>

The measurement of the two-photon absorption cross-sectional area of the synthesized compound was performed by the Z scanning method described in MANSOOR SHEIK-BAHAE et al., IEEE. Journal of Quantum Electronics, 1990, 26, 760. The Z scanning method is a method widely used as the measuring method of a non-linear optical constant, where in the vicinity of the focus of converged laser beam, a measurement sample is moved along the beam and the change in the quantity of transmitted light is recorded. Since the power density of incident light changes depending upon the position of the sample, when non-linear absorption is present, the quantity of transmitted light attenuates in the vicinity of the focus. The two-photon absorption cross-sectional area was computed by fitting the change in the quantity of transmitted light to a theoretical curve predicted from the incident light intensity, the light converging spot size, the sample thickness and the sample concentration. As the light source for the measurement of two-photon absorption cross-sectional area, a Ti:sapphire pulsed laser (pulse width: 100 fs, repetition: 80 MHz, average output: 1 W, peak power: 100 kW) obtained by combining a readout amplifier and a light parametric amplifier was used. As the sample for the measurement of two-photon absorption cross-sectional area, a solution obtained by dissolving the compound in chloroform in a concentration of about 1×10⁻³ mol/l was used.

### <Evaluation of Two-Photon Absorption Cross-Sectional Area>

The two-photon absorption cross-sectional areas of Compounds D-1, D-2, D-6 and D-29 of the present invention and Comparative Compound R-1 [recited as Compound D-1 in Patent Document 5 (JP-A-2010-108588)] are shown in Table 1 below.

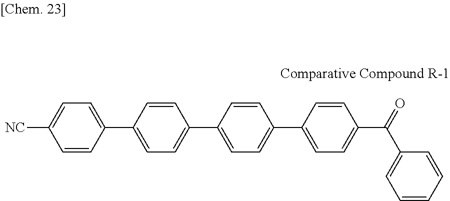 [SMILES: N#Cc1ccc(-c2ccc(-c3ccc(-c4ccc(C(=O)c5ccccc5)cc4)cc3)cc2)cc1]

TABLE 1
Two-Photon Absorption Cross-Sectional Area

| | Two-Photon | | |
|---|---|---|---|
| | Absorption | | |
| | Cross-Sectional | Measurement | |
| Compound | Area/GM | Wavelength/nm | |
| D-1 | 900 | 405 | Invention |
| D-2 | 860 | 405 | Invention |
| D-6 | 1140 | 405 | Invention |
| D-29 | 2000 | 405 | Invention |
| R-1 | 1700 | 405 | Comparative Example |
| | | | (Patent Document 5) |

1 GM = 1 × 10⁻⁵⁰ cm⁴ s molecule⁻¹ photon⁻¹

### <Evaluation of Solubility of Two-Photon Absorption Compound>

Compounds D-1, D-2, D-6 and D-29 of the present invention and Comparative Compound R-1 for dichloromethane were evaluated for the solubility (room temperature). The solubility of each of Compounds D-1, D-2, D-6 and D-29 is shown as a relative value to the solubility of Comparative Compound R-1 in Table 2 below.

TABLE 2
Evaluation of Solubility of Two-Photon Absorption Compound

| | Solubility | |
|---|---|---|
| Compound | (dichloromethane) | |
| D-1 | 26 | Invention |
| D-2 | 47 | Invention |
| D-6 | 144 | Invention |
| D-29 | 227 | Invention |
| R-1 | 1 | Comparative Example |
| | | (Patent Document 5) |

As seen in Table 2, Compounds D-1, D-2, D-6 and D-29 of the present invention has high solubility as compared with Comparative Compound R-1.

The amount of two-photon absorption of a two-photon absorption material is proportional to a value obtained by multiplying the addition amount (or addition concentration) of a two-photon absorption compound by the two-photon absorption cross-sectional area and when the two-photon absorption compound with high solubility of the present invention is used, the compound can be used in a large addition amount (or high addition concentration). Therefore, the amount of two-photon absorption could be increased.

### <Preparation of Two-Photon Recording Material>

### (Preparation of Two-Photon Recording Material 1)

Two-Photon Recording Material 1 was prepared according to the following formulation.

| | |
|---|---|
| Two-photon absorption compound: D-6 | 161 parts by mass |
| Polymer binder: polyvinyl acetate | 500 parts by mass |
| (Mw = 11,300) | |
| Coating solvent: dichloromethane | 14,400 parts by mass |

### (Preparation of Two-Photon Recording Material 2)

| | |
|---|---|
| Two-photon absorption compound: D-29 | 200 parts by mass |
| Polymer binder: polyvinyl acetate | 500 parts by mass |
| (Mw = 11,300) | |
| Coating solvent: dichloromethane | 14,400 parts by mass |

### (Preparation of Two-Photon Recording Material 3)

| | |
|---|---|
| Two-photon absorption compound: D-1 | 97 parts by mass |
| Polymer binder: polyvinyl acetate | 500 parts by mass |
| (Mw = 11,300) | |
| Coating solvent: dichloromethane | 14,400 parts by mass |

### (Preparation of Two-Photon Recording Material 4)

| | |
|---|---|
| Two-photon absorption compound: D-2 | 118 parts by mass |
| Polymer binder: polyvinyl acetate | 500 parts by mass |
| (Mw = 11,300) | |
| Coating solvent: dichloromethane | 14,400 parts by mass |

### (Preparation of Two-Photon Recording Material 1 for Comparison (Comparative Material 1))

| | |
|---|---|
| Two-photon absorption compound: | 8 parts by mass |
| Comparative Compound R-1 | |
| Polymer binder: polyvinyl acetate | 500 parts by mass |
| (Mw = 11,300) | |
| Coating solvent: dichloromethane | 14,400 parts by mass |

Comparative Compound R-1 was low in the solubility and therefore, the addition amount in the formulation above could not be increased any more.

### <Manufacture of Two-Photon Absorption Recording Medium>

Using a slide glass as the substrate, each of coating solutions of Two-Photon Absorption Recording Materials 1 to 4 prepared above was coated thereon by spin coating to form a recording layer. At this time, the rotation speed was adjusted in the range of 300 to 3,000 rpm such that the recording layer has a thickness of 1 μm. As the cover layer, a polycarbonate film (Teijin Pure-Ace, thickness: 80 μm) having a self-adhesive layer (glass transition temperature: −52° C.) on one surface was used, and the self-adhesive layer and the polycarbonate film were set to have a total thickness of 100 μm. The cover layer was placed on the recording layer through the self-adhesive layer, and these layers were laminated together by press-bonding the cover layer by means of a pressing member, whereby Two-Photon Absorption Recording Mediums 1 to 4 composed of one recording layer were manufactured.

Comparative Medium 1 was manufactured in the same manner as Two-Photon Absorption Recording Mediums 1 to 4 by using Two-Photon Recording Material 1 for Comparison.

### <Test/Evaluation Method of Two-Photon Recording/Reproduction>

The recording layer was irradiated with recording light (Ti:Sapphire laser, wavelength: 405 nm, repetition frequency: 76 MHz, pulse width: 2 psec, average power Pa=from 2 to 20 mW, peak power Pp=from 13 to 130 W) at a peak power of 20 W was used. Recording was performed by adjusting the recording time in the range of 0.02 to 1,000 μs in the state of focusing the recording light on the recording layer.

The recording time when the change in the quantity of reflected light on the recording layer between before and after recording (quantity of reflected light after recording÷quantity of reflected light before recording) exceeded 20% was measured, and the relative sensitivity was calculated based on the recording time of Comparative Medium 1.

### <Evaluation Results of Two-Photon Recording Sensitivity>

The evaluation results of the two-photon recording sensitivity are shown together in Table 3 below.

TABLE 3
<Relative Two-Photon Recording Sensitivity>

| | Relative Recording |
|---|---|
| Recording Medium | Sensitivity |
| Two-Photon Absorption Recording Medium 1 | 190 |
| Two-Photon Absorption Recording Medium 2 | 1830 |
| Two-Photon Absorption Recording Medium 3 | 85 |
| Two-Photon Absorption Recording Medium 4 | 110 |
| Comparative Medium 1 | 1 |

### INDUSTRIAL APPLICABILITY

According to the configuration of the two-photon absorption material of the present invention, light in the wavelength region shorter than 700 nm can be absorbed with high sensitivity.

Also, the two-photon absorption compound of the present invention shows non-resonant two-photon absorption properties with light in the wavelength region shorter than 700 nm, so that a high two-photon absorption cross-sectional area could be obtained. Furthermore, the two-photon absorption compound of the present invention has high solubility without impairing the two-photon absorption efficiency and when the compound is used, the compound can be incorporated into the two-photon absorption material in a high concentration, so that high two-photon absorption sensitivity can be obtained by the two-photon absorption material.

While the invention has been described in detail and with reference to specific embodiments thereof, it will be apparent to one skilled in the art that various changes and modifications can be made therein without departing from the spirit and scope of the invention.

This application is based on Japanese Patent Application (Patent Application No. 2011-108697) filed on May 13, 2011, Japanese Patent Application (Patent Application No. 2011-154898) filed on Jul. 13, 2011, and Japanese Patent Application (Patent Application No. 2012-108950) filed on May 10, 2012, the contents of which are incorporated herein by way of reference.

### DESCRIPTION OF REFERENCE NUMERALS AND SIGNS

1 Recording/reproducing apparatus
10 Optical information recording medium

1. A non-resonant two-photon absorption material containing a non-resonant two-photon absorption compound represented by the following formula (1): 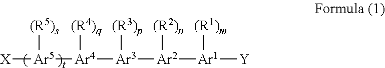
wherein each of Ar¹ to Ar⁵ independently represents an aromatic hydrocarbon ring or an aromatic heterocyclic ring and each may be independently the same as or different from every others; each of m, n, p, q and s independently represents an integer of 0 to 4; t represents an integer of 0 or 1; each of R¹, R², R³, R⁴ and R⁵ independently represents a substituent; when each of m, n, p, q and s is independently an integer of 2 or more, each R¹, R², R³, R⁴ or R⁵ may be independently the same as or different from every other R¹, R², R³, R⁴ or R⁵; and each of X and Y represents a substituent having a Hammett sigma-para value of 0 or more and one may be the same as or different from another.

2. The non-resonant two-photon absorption material as claimed in claim 1, containing a non-resonant two-photon absorption compound represented by the following formula (2): 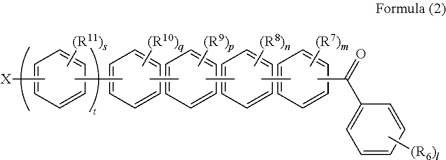
wherein 1 represents an integer of 1 to 4; each of in, n, p, q and s independently represents an integer of 0 to 4; t represents an integer of 0 or 1; R⁶ represents a substituent containing at least one member selected from an oxygen atom, a sulfur atom and a nitrogen atom and when 1 is 2 or more, each R⁶ may be the same as or different from every other R⁶; each of R⁷, R⁸, R⁹, R¹⁰ and R¹¹ independently represents a substituent and when each of m, n, p, q and s is independently an integer of 2 or more, each R⁷, R⁸, R⁹, R¹⁰ or R¹¹ may be independently same as or different from every other R⁷, R⁸, R⁹, R¹⁰ or R¹¹; and X represents a substituent having a Hammett sigma-para value of 0 or more.

3. The non-resonant two-photon absorption material as claimed in claim 2, containing a non-resonant two-photon absorption compound represented by the following formula (3): 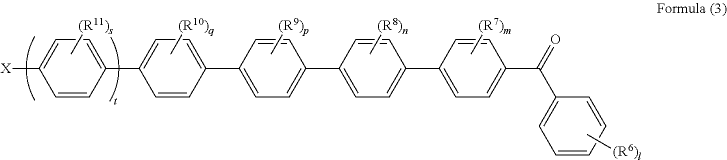
wherein l, m, n, p, q, s, t, R⁶, R⁷, R⁸, R⁹, R¹⁰, R¹¹ and X are the same as those in formula (2).

4. The non-resonant two-photon absorption material as claimed in claim 1,
wherein the substituent represented by X in formula (1) of the non-resonant two-photon absorption compound is a trifluoromethyl group, a cyano group or a group represented by the following formula (4): 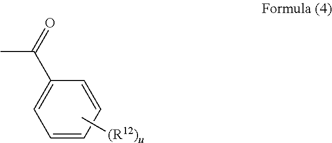
wherein R¹² represents a substituent containing at least one member selected from an oxygen atom, a sulfur atom and a nitrogen atom, u represents an integer of 0 to 4, and when u is 2 or more, each R¹² may be the same as or different from every other R¹².

5. The non-resonant two-photon absorption material as claimed in claim 2,
wherein the non-resonant two-photon absorption compound represented by formula (2) is a non-resonant two-photon absorption compound represented by the following formula (5): 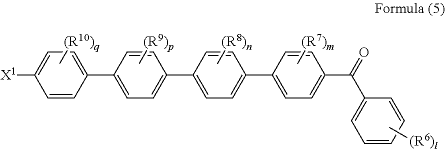
wherein l, m, n, p, q, R⁶, R⁷, R⁸, R⁹ and R¹⁰ are the same as those in formulae (2) and (3), and X¹ represents a trifluoromethyl group, a cyano group or a substituent represented by formula (4).

6. A non-resonant two-photon absorption recording material containing the non-resonant two-photon absorption material claimed in claim 1.

7. The non-resonant two-photon absorption recording material as claimed in claim 6, containing (b) a material capable of changing the fluorescence intensity between before and after two-photon recording.

8. The non-resonant two-photon absorption recording material as claimed in claim 6, containing (b′) a material capable of changing the reflected light intensity between before and after two-photon recording.

9. The non-resonant two-photon absorption recording material as claimed in claim 8,
wherein a polymer compound having no linear absorption at the two-photon recording wavelength is used as the (b′) material capable of changing the reflected light intensity between before and after two-photon recording.

10. An optical information recording medium having a recording layer containing the non-resonant two-photon absorption recording material claimed in claim 6.

11. A compound represented by the following formula (6):

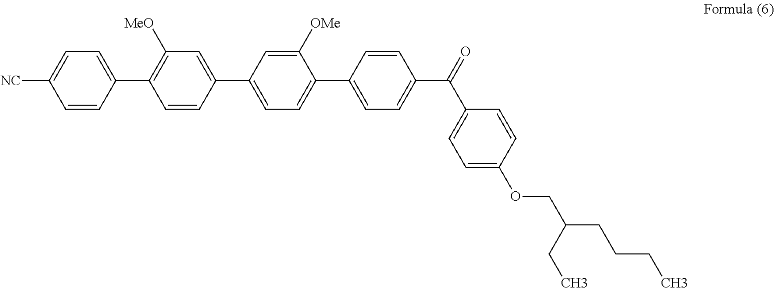 [SMILES: CCCCC(CC)COc1ccc(C(=O)c2ccc(-c3ccc(-c4ccc(-c5ccc(C#N)cc5)c(OC)c4)cc3OC)cc2)cc1]

12. A compound represented by the following formula (7):

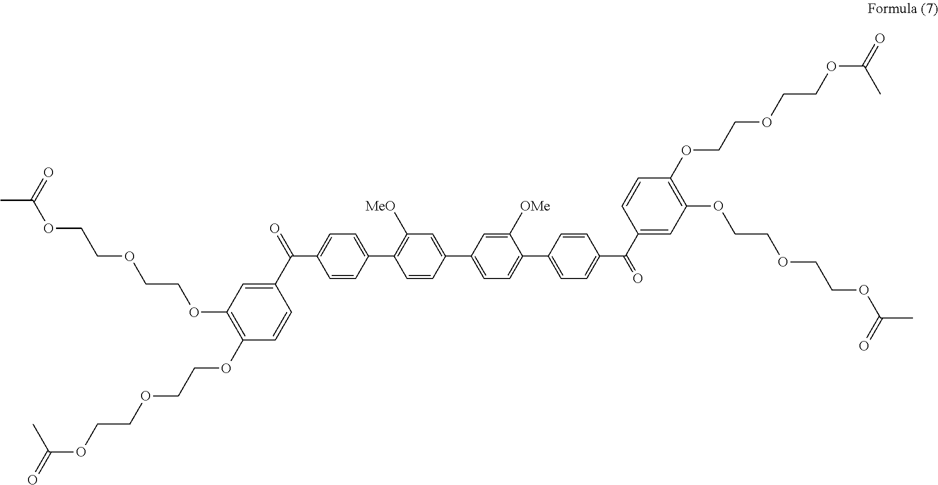 [SMILES: COc1cc(-c2ccc(-c3ccc(C(=O)c4ccc(OCCOCCOC(C)=O)c(OCCOCCOC(C)=O)c4)cc3)c(OC)c2)ccc1-c1ccc(C(=O)c2ccc(OCCOCCOC(C)=O)c(OCCOCCOC(C)=O)c2)cc1]

13. An optical information recording medium having a recording layer composed of a non-resonant two-photon absorption recording material containing a non-resonant two-photon absorption compound, and having a substrate, a guide layer, a reflecting layer, a spacer layer and a laminate structure of a recording layer sandwiched by intermediate layers, in order, from the back side relative to incident light and a cover layer and a hardcoat layer on the incident light surface side.

14. The optical information recording medium as claimed in claim 13,
wherein the thickness of the recording layer is from 50 nm to 2 μm.

15. The optical information recording medium as claimed in claim 13,
wherein the refractive index difference between the recording layer and the intermediate layer is from 0.01 to 0.5.

16. The optical information recording medium as claimed in claim 13,
wherein the thickness of the intermediate layer is from 2 μm to 20 μm.

17. The optical information recording medium as claimed in claim 13,
wherein the substrate thickness is from 0.02 mm to 2 mm.

18. The optical information recording medium as claimed in claim 13,
wherein the thickness of the cover layer is from 0.01 mm to 0.2 mm.

19. The optical information recording medium as claimed in claim 13,
wherein the thickness of the spacer layer is from 5 μm to 100 μm.

20. The optical information recording medium as claimed in claim 13,
wherein the optical information recording medium performs marking.

21. The optical information recording medium as claimed in claim 13,
wherein the optical information recording medium is housed in a cartridge.

22. The optical information recording medium as claimed in claim 10.

23. A non-resonant two-photon absorption recording method comprising,
irradiating the optical information recording medium claimed in claim 22 with laser light having a wavelength of 400 to 450 nm to three-dimensionally record information.

24. A recording/reproducing method on the optical information recording medium claimed in claim 22,
wherein the peak power of a recording laser is from 1 to 100 W on the surface of said optical information recording medium, the average power of the recording laser is 100 mW or less on the surface of the optical information recording medium, and the product of the pulse width and the oscillation cycle of the recording laser is from 0.001 to 0.1.

25. A recording/reproducing method on an optical information recording medium as claimed in claim 24, comprising using a confocal optical system at the time of reproducing the information.
